(19) United States
(12) Patent Application Publication
(10) Pub. No.: US 2026/0161141 A1
(43) Pub. Date: Jun. 11, 2026

(54) Artificial Intelligence (AI) System that uses a Vision-and-Language Model (VLM) to Improve Energy Conservation and to Increase Efficiency of Energy Consumption in Households

(71) Applicant: Maya Vidal, Jupiter, FL (US)

(72) Inventor: Maya Vidal, Jupiter, FL (US)

(21) Appl. No.: 18/972,905

(22) Filed: Dec. 7, 2024

(51) Int. Cl. G05B 13/02; F24F 11/46; F24F 11/63; G06Q 10/1093; G06Q 30/0601

(52) U.S. Cl. CPC G05B 13/027; F24F 11/46; F24F 11/63; G06Q 10/1093; G06Q 30/0611

(57) ABSTRACT

Artificial Intelligence (AI) system that uses a Vision-and-Language Model (VLM) or a Large Multi-Modalities Model (LMMM) to improve energy conservation and to increase efficiency of energy consumption in households. Video cameras capture live video from rooms in the household, and feed them into the VLM; which also monitors or receives copies of email messages and instant messages that were sent and received by household residents. The VLM generates unique insights and proposals on how to reduce energy consumption or how to improve energy efficiency in the household. The energy-saving insights, that were generated by the VLM, are transferred to a Home Automation Device or to a Smart Home hub unit, which is triggered by the VLM-generated outputs to remotely control devices and appliances in the household. Innovative capabilities of AI are harnessed, in combination with Computerized Vision and Natural Language Processing, to deduce energy-saving proposals and to automatically implement them.

### FIELD

Some embodiments are related to the field of energy consumption.

### BACKGROUND

Billions of people worldwide use electric devices and home appliances on a daily basis. Users carry with them smartphones, tablets, and other portable electronic devices. Homes and residences have electric fridges and freezers, electric ovens and stoves, electric toasters and microwave ovens, electric Heating, Ventilation, and Air Conditioning (HVAC) systems, electric laundry machines and dryer machines, and a variety of other electric devices and appliances that consume electric energy.

### SUMMARY

Some embodiments provide an Artificial Intelligence (AI) based system that uses a large Vision-and-Language Model (VLM) to improve efficiency of energy consumption in households.

Some embodiments provide an Artificial Intelligence (AI) system that uses a Vision-and-Language Model (VLM) or a Large Multi-Modalities Model (LMMM) to improve energy conservation and to increase efficiency of energy consumption in households. Video cameras capture live video from rooms in the household, and feed them into the VLM; which also monitors or receives copies of email messages and instant messages that were sent and received by household residents. The VLM generates unique insights and proposals on how to reduce energy consumption or how to improve energy efficiency in the household. The energy-saving insights, that were generated by the VLM, are transferred to a Home Automation Device or to a Smart Home hub unit, which is triggered by the VLM-generated outputs to remotely control devices and appliances in the household. Innovative capabilities of AI are harnessed, in combination with Computerized Vision and Natural Language Processing, to deduce energy-saving proposals and to automatically implement them.

Some embodiments may provide other and/or additional benefits or advantages.

### BRIEF DESCRIPTION OF THE DRAWINGS

FIG. 1A is an illustration demonstrating an image of a room in a household, featuring an activated Air Conditioner (AC) unit and a nearby partially-open window, that a Vision-and-Language Model (VLM) or a Large Multi-Modalities Model (LMMM) can analyze and can deduce therefrom one or more insights to improve the efficiency of electric energy usage or to enhance energy conservation, in accordance with some demonstrative embodiments.

FIG. 1B is an illustration showing the above-mentioned image of the room with the AC unit and the partially-open window, with the prompt and with the VLM/LMMM output; demonstrating how a VLM or an LMMM can be innovatively utilized to deduce energy conservation insights and to detect energy wasting scenarios from an image or from a video frame, in accordance with some demonstrative embodiments.

FIG. 2A is an illustration demonstrating an image of a room in a household, featuring an activated Air Conditioner (AC) unit having an air pathway that is partially obstructed or partially blocked by a nearby sofa or couch, that a Vision-and-Language Model (VLM) or a Large Multi-Modalities Model (LMMM) can analyze and can deduce therefrom one or more insights to improve the efficiency of electric energy usage or to enhance energy conservation, in accordance with some demonstrative embodiments.

FIG. 2B is an illustration showing the above-mentioned room with the sofa partially blocking the air outlet of the AC unit, with the prompt and with the VLM/LMMM output; demonstrating how a VLM or an LMMM can be innovatively utilized to deduce energy conservation insights and to detect energy wasting scenarios from an image or from a video frame, in accordance with some demonstrative embodiments.

FIG. 3 is a schematic block-diagram illustration of a system for AI-based energy conservation and for AI-based triggering of actions that can reduce wasting of energy in a household or that can improve the efficiency of energy consumption in a household, in accordance with some demonstrative embodiments.

### DETAILED DESCRIPTION OF SOME DEMONSTRATIVE EMBODIMENTS

Some embodiments introduce a computerized method and system configured to optimize household energy consumption by employing a large Vision-and-Language Model (VLM) or a Large Multi-Modalities Model (LMM or LMMM) or a Large Multi-Modal Model (LMM or LMMM) for data analysis and action generation. The system uses video cameras positioned throughout the home to capture live streams, from which video frames are extracted and analyzed. Simultaneously, it incorporates textual data, including email messages and instant messaging exchanges among household members. The VLM processes these inputs to create actionable proposals aimed at reducing energy usage. By combining visual and textual data, the system identifies inefficiencies and provides tailored recommendations.

The method includes the ability to detect specific scenarios, such as windows left open in one room while air conditioners operate in another. Through advanced VLM analysis, the system examines indicators such as control lights, mechanical switches, and air movement to determine whether an air conditioning unit is active. If inefficiencies are detected, the VLM suggests corrective actions, such as closing windows or turning off the air conditioner, and generates tailored messages for household members.

The system integrates with Home Automation Devices (HADs) to enact and perform its proposals automatically. If a window identified as open is registered as a smart window, the VLM communicates with the HAD to remotely close it. For non-smart windows, the VLM directs the HAD to turn off the air conditioner instead. This interaction between the VLM and HAD ensures that energy-saving measures are executed promptly without requiring manual intervention.

The invention also identifies recently purchased electrical appliances by analyzing email messages. It retrieves energy-saving tips from online resources and creates a detailed recommendation message for the household, emphasizing efficient use of the new appliance. The VLM draws on specific examples, such as cleaning dryer lint filters or minimizing oven preheating, to enhance the system's practical guidance.

Personalized climate control is another feature of the invention. The VLM evaluates historical communication among residents to ascertain temperature preferences and generates optimized heating and cooling schedules. For instance, if household members have overlapping preferred temperature ranges, the system proposes a target temperature that satisfies most, if not all, preferences. These proposals are sent to residents and HADs for automated implementation.

By analyzing past electricity bills and usage data, the VLM identifies cost-saving opportunities, such as shifting non-time-sensitive operations of appliances like washing machines or sprinklers to periods with lower electricity rates. This analysis is complemented by direct communication with HADs to adjust device operations accordingly. The system ensures energy usage aligns with optimal cost-efficiency strategies.

The invention also predicts periods when residents are likely to be absent by analyzing scheduling data, email content, and video footage. Based on these insights, the VLM determines which rooms can have lights or devices turned off during these times. It coordinates with the HAD to implement these changes automatically, reducing energy consumption without disrupting household routines.

Seasonal maintenance needs, such as weatherproofing or window insulation, are addressed by analyzing historical service records found in emails. The VLM notifies residents when such services are due and identifies local service providers. It automates the process of requesting quotes from these providers and compiles responses to recommend the most cost-effective options to the household.

Furniture and appliance placement optimization is another innovation. The VLM analyzes room layouts using video footage to recommend furniture rearrangements that improve airflow or energy efficiency. Additionally, it evaluates pet behavior to suggest safety measures, such as installing motion-activated lights along frequently traveled paths or deactivating appliances inadvertently turned on by pets.

The system also addresses the needs of plants and shrubs in the household. The VLM evaluates lighting conditions to propose relocating light-sensitive plants to maximize or minimize natural sunlight exposure based on their requirements. It suggests installing energy-efficient light fixtures or adjusting reflective surfaces to enhance or limit light availability. Seasonal variations are considered to maintain plant health throughout the year. These proposals, like others, are communicated to household members via email and implemented through HADs where applicable.

It is noted that in accordance with some embodiments, the term VLM and the term LMMM are not a text-only Large Language Model (LLM), such as ChatGPT version 3 or ChatGPT version 3.5, that could not process or analyze images of graphical information; rather, the VLM or LMMM should be able to process graphics/images/photographs/video frames/video segments/streaming video, as well as text and/or other types of fed data.

It is also noted that in accordance with some embodiments, the VLM or LMMM do not perform a set of deterministic rules and do not perform a deterministic algorithm, that enables an observer or a programmer to know in advance which output(s) would be generated; but rather, the VLM or LMMM are implemented using transformers that rely on Machine Learning (ML)/Deep Learning (DL)/Neural Network (NN)/Convolutional Neural Network (CNN)/Recurrent Neural Networks (RNN)/other non-deterministic AI model or Artificial NN, and/or utilize Optical Character Recognition (OCR) and/or Natural Language Processing (NLP) and/or Computerized Vision (CV) to “understand” images or graphical information or video-frames or video-segments, or to “recognize” or extract objects and information from images or videos or video-frames or video-segments, or other large multi-modal model that was trained on both textual items and graphical items.

It is noted that in some embodiments, the innovative utilization of the VLM can provide to the user and his electronic device never-before-seen capabilities, that the user cannot perform (at all, or efficiently) by himself, or that would be difficult or impossible or time-consuming or error-prone to human users or even to Deterministic processing units that operate based on pre-defined deterministic rules; unlike a VLM or an LMMM or other AI-based tools that some embodiments employ and that often operate as a “black box” using Neural Networks/CNN/RNN/transformers/encoders/decoders that generate predictions or estimations or outputs using non-deterministic models.

The Applicant has realized that installing various hardware-based sensors and detectors in a household is often a tedious and labor-intensive project, that most home-owners tend to avoid. For example, most home-owners do not install in every window in the house a Hardware Sensor/Detector, that can detect whether a window is currently open or partially-open.

The Applicant has also realized that many houses and homes and residences are more likely to include a variety of cameras, such as security cameras, closed-circuit television (CCTV) camera, Internet Protocol (IP) cameras such as “nanny cam/nanny camera”, baby monitoring cameras, various IP-connected cameras such as Google Nest, or the like; and those cameras can acquired high definition (HD) or full high definition (FHD) video, and even 4K or 8K video. The Applicant has realized that such video from one or more cameras in the household, can be analyzed by a VLM or an LMMM, by itself and/or in combination with other sources of information (e.g., email messages of the household residents; Instant Messaging messages; utility bill; information from the Internet; or the like), in order to generated VLM-based/LMMM-based insights and proposals with regard to reducing electricity consumption, decreasing electricity bills, and improving energy efficiency in the household.

Furthermore, the VLM-based/LMMM-based insights can be translated or converted, by the VLM or LMMM itself, or via a converter/translator unit or controller, into machine-readable commands/instructions/messages/signals, that a Home Automation Device (HAD) or a Home Automation Hub, or a “smart home” hub or controller, can receive wirelessly or over a wired connection; such that the HAD or similar “smart home” controller can trigger or launch particular actions in the household (e.g., to close a remotely-controlled smart window; to turn-off a kitchen appliance) to achieve the goal of reducing electricity consumption or increasing energy efficiency in the household.

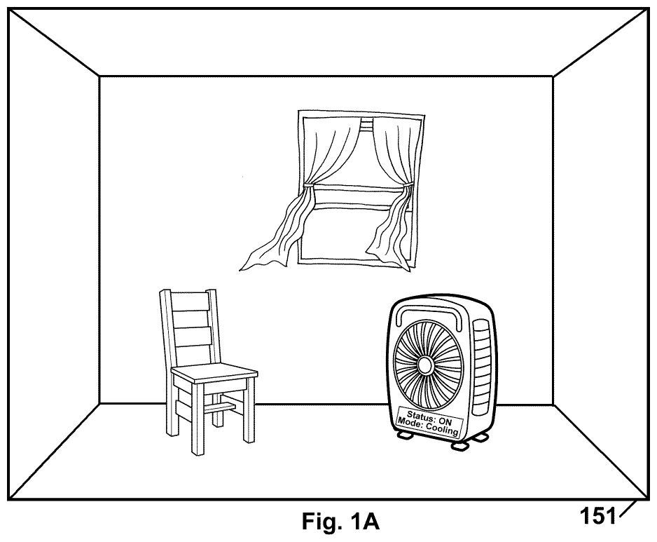

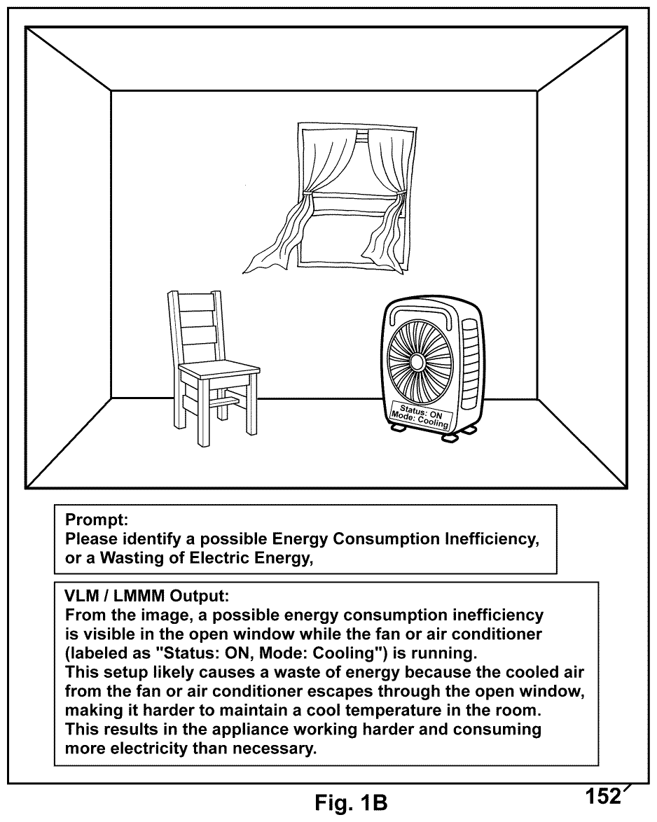

Reference is made to FIG. 1A, which is an illustration demonstrating an image 151 of a room in a household, featuring an activated Air Conditioner unit and a partially-open window, that a Vision-and-Language Model (VLM) or a Large Multi-Modalities Model (LMMM) can analyze and can deduce therefrom insight(s) to improve the efficiency of electric energy usage, in accordance with some demonstrative embodiments.

Image 151 of FIG. 1A can be fed into a VLM or an LMMM, such as OpenAI ChatGPT, together with the following prompt: “Please identify a possible Energy Consumption Inefficiency, or a Wasting of Electric Energy, that you can deduce from this image.”

In response, the VLM or LMMM can rapidly generate the following output: “From the image, a possible energy consumption inefficiency is visible in the open window while the fan or air conditioner (labeled as “Status: ON, Mode: Cooling”) is running. This setup likely causes a waste of energy because the cooled air from the fan or air conditioner escapes through the open window, making it harder to maintain a cool temperature in the room. This results in the appliance working harder and consuming more electricity than necessary.”

Reference is made to FIG. 1B, which is an illustration 152 showing the above-mentioned image of the room with AC unit and partially-open window, with the prompt and with the VLM/LMMM output; demonstrating how a VLM or an LMMM can be innovatively utilized to deduce energy conservation insights and to detect energy wasting scenarios from an image or from a video frame, in accordance with some demonstrative embodiments.

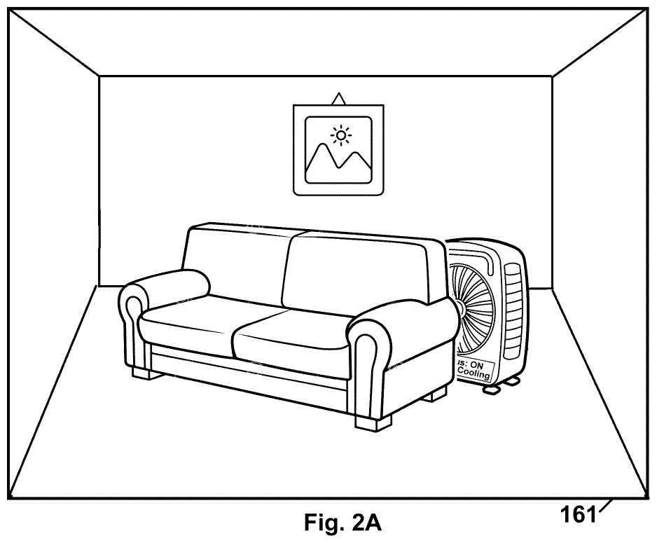

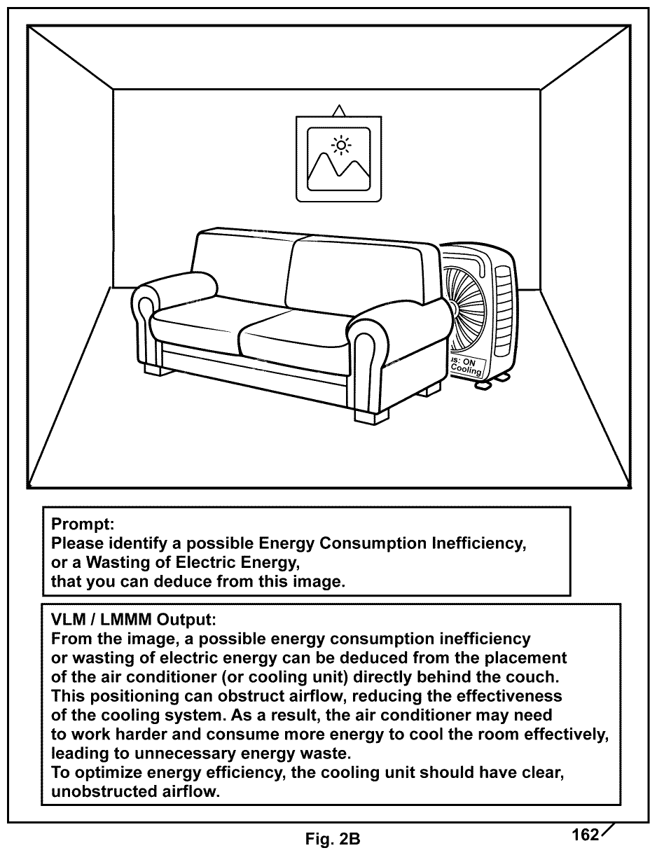

Reference is made to FIG. 2A, which is an illustration demonstrating an image 161 of a room in a household, featuring an activated Air Conditioner unit having an air pathway that is partially obstructed or partially blocked by a sofa or a couch, that a Vision-and-Language Model (VLM) or a Large Multi-Modalities Model (LMMM) can analyze and can deduce therefrom insight(s) to improve the efficiency of electric energy usage, in accordance with some demonstrative embodiments.

Image 161 of FIG. 2A can be fed into a VLM or an LMMM, together with the following prompt: “Please identify a possible Energy Consumption Inefficiency, or a Wasting of Electric Energy, that you can deduce from this image.”

In response, the VLM or the LMMM can generate the following output: “From the image, a possible energy consumption inefficiency or wasting of electric energy can be deduced from the placement of the air conditioner (or cooling unit) directly behind the couch. This positioning can obstruct airflow, reducing the effectiveness of the cooling system. As a result, the air conditioner may need to work harder and consume more energy to cool the room effectively, leading to unnecessary energy waste. To optimize energy efficiency, the cooling unit should have clear, unobstructed airflow.”

Reference is made to FIG. 2B, which is an illustration 162 showing the above-mentioned room with the sofa partially blocking the AC unit, with the prompt and with the VLM/LMMM output; demonstrating how a VLM or an LMMM can innovatively be utilized to deduce energy conservation insights and to detect energy wasting scenarios from an image or from a video frame, in accordance with some demonstrative embodiments.

These are only two non-limiting examples, that demonstrate how a VLM or an LMMM can be innovatively harnessed to analyze images, as well as video frames or video-segments, and to deduce from them insights or proposal regarding a possible wasting of electric energy that can be cured, or to generate tips or instructions that their performance would improve electricity usage efficiency and/or would reduce electricity costs in the household and/or would contributed to energy conservation.

For demonstrative purposes, some portions of the discussion above and/or herein may relate to a household; however, some embodiments may similarly be configured to operate in conjunction with conserving energy and/or improving energy efficiency in other structures or buildings or venues, for example, an office, a factory, a retail store, a supermarket, a grocery store, a warehouse, a shopping mall, an airport, a school or college or university or other educational institution or academic institution, a bank or other financial institution, or other facilities or venues.

Similarly, some embodiments may be configured to operate with regard to outdoor settings, such as in a yard, a back yard, a front yard, a porch or balcony, a sporting venue, an open space, or any other venue or space that is not necessarily associated with any building. For example, a security camera may be installed on a pole, next to an entirely-open soccer field where children are playing; and a large Fan may be located on another pole nearby, blowing air towards players in the field. Analysis by a VLM or an LMMM of the video feed from that security camera (or, of extracted video-frames from that feed or stream), enables the VLM or LMMM to generate an output conveying that it observes that part of the airflow from that large Fan is currently blocked by a large object, such as a car that a parent has parked next to the fan, or a bicycle that a child has parked next to the fan; and therefore, the full operational efficiency of the fan is not utilized due to such obstruction or blocking, and energy is consumed but is partially wasted, and the problem can be cured by moving that large obstructing item from the airflow path of the large Fan.

In some embodiments, optionally, video feeds and/or video streams and/or extracted video frames can be fed, continuously and/or periodically (e.g., a video frame per 1 or 2 minutes) into a local or a remote or a cloud-based VLM or LMMM, with a prompt as demonstrated above that commands the VLM or LMMM to deduce energy usage inefficiency or to generate energy-conserving tips or proposals. This can be implemented automatically, using an Application Programming Interface (API) for such VLM or LMMM; or using a Scheduler Application that is configured to grab or extract a video-frame every T seconds, and to feed it or send it or upload it into such VLM or LMMM together with said prompt, to generate such tips or insights in an automatic manner on a continuous or periodical basis.

The Applicant has realized that this can further leverage a situation in which an establishment, such as a bank or a supermarket or a school or a retail store, already has dozens of security cameras installed anyway in the premises; and the feed from such cameras, or extracted video frames from such cameras, can be used for feeding into such local or remote VLM or LMMM, with a prompt to command it to identify energy inefficiency and/or to generate proposals to improve energy utilization.

Some embodiments provide a computerized method for reducing energy consumption and increasing energy efficiency in a household. The computerized method comprises, for example: (A1) automatically acquiring a plurality of live video streams from a respective plurality of video cameras that are located in a plurality of rooms in said household; extracting video frames from said live video streams; feeding the extracted video frames into a large Vision-and-Language Model (VLM); and also, (A2) automatically obtaining copies of textual messages that were exchanged, among electronic devices of residents of said household, via electronic mail and Instant Messaging; feeding said copies of textual messages into said VLM; and also, (A3) automatically feeding into said VLM a prompt, that commands the VLM to analyze visual content of said video frames in combination with textual content of said textual messages, and that further commands the VLM to generate a proposal for one or more actions that are expected to reduce electric energy consumption in said household based on VLM analysis of visual content of said video frames in combination with textual content of said textual messages.

For example, each resident of the household may have, or may carry, or may be associated with, or may be pre-registered in a household database as being associated with, a particular electronic device, such as a smartphone or a tablet; and that device may have installed thereon, and running thereon, a program or application that Shares with the HAD of the household, and/or with the VLM or with an information collector that aggregates messages from residents' devices and then feeds them into the VLM (or the LMMM), messages from email accounts/applications and/or from Instant Messaging (IM) accounts or applications and/or from SMS communications. For example, each resident may actively Consent, or may Opt-In, to share his or her email/IM/SMS messages (and/or Calendar information, Scheduling Applications data, meetings data, contact list) with a central information collector unit, via such locally-running application on his or her phone or tablet; understanding that this may lead to energy consumption and energy conservation for the household. The information collector may periodically collect all such messages from each smartphone/tablet of the resident, and copy it to a central repository to which the VLM/LMMM has access; or, the information collector unit may periodically feed the collected information into the VLM/LMMM, as Context. It is noted that some Large Language Models (LLMs), on which the VLM/LMMM is built, may be able to receive a large-size context; for example, some versions of Google Gemini LLM can receive context having a size of one million tokens, or even five or ten million tokens; and such Context Size can be sufficient to contain copies of thousands of such residents' email messages and/or IM or SMS messages.

In some embodiments, the Prompting of the VLM (or LMMM) is performed via an Automated Prompting Engine and/or an Automated Prompt Generator & Feeder. For example, an assistive or secondary LLM, such as ChatGPT 4o or another LLM (e.g., Google Gemini; Microsoft Copilot; Claude Sonnet or Claude Opus; Meta Llama) can be configured to operate as the unit that generates the prompts and/or feeds them (and the relevant materials/messages/information) into the VLM/LMMM. Optionally, such assistive/secondary LLM an gather or collect the information from residents' messages, can parse them for insights and/or can deduce insights, and can generate the relevant prompt(s) that are then transferred from such LLM to the VLM/LMMM that would answer them by further taking into account videos/video-frames/images captured by the video cameras throughout the household.

The system is a sophisticated, computerized framework designed to reduce energy consumption and enhance energy efficiency in a household by leveraging advanced data collection, integration, and analysis capabilities of a Vision-and-Language Model (VLM). At its core, the system comprises several interconnected components that work in unison to monitor, analyze, and optimize household energy usage. The primary data collection mechanism is a network of video cameras strategically positioned across various rooms within the household. These cameras continuously capture live video streams, which are routed to a Video Processing Unit (VPU). The VPU is responsible for extracting individual video frames from these streams and formatting them into a structure compatible with the VLM for further analysis.

Complementing the visual data is a Textual Data Acquisition Module (TDAM), which interfaces with electronic communication devices within the household to retrieve textual messages exchanged via email and instant messaging platforms. The TDAM ensures that all relevant messages, reflecting household activities and resident behaviors, are collected and preprocessed for integration with visual data. This textual data is sanitized, anonymized, and segmented to maintain privacy and maximize analytical efficiency. The system also includes a Synchronization Manager (SM) that ensures video frames and textual messages are temporally aligned, enabling the VLM to analyze both data types in a cohesive manner.

At the analytical heart of the system lies the VLM, a sophisticated computational engine pre-trained on a vast corpus of multimodal data. The VLM operates within a dedicated Analytical Processing Unit (APU) equipped with high-performance GPUs and specialized hardware accelerators to handle the computational load. The VLM receives its inputs in three streams: (1) video frames from the VPU, (2) textual messages from the TDAM, and (3) a user-defined or system-generated prompt that instructs the VLM on the specific analysis task to be performed. This prompt explicitly commands the VLM to correlate visual data (e.g., the state of household appliances and environmental conditions) with textual data (e.g., behavioral patterns or energy usage discussions among residents). By processing these inputs in parallel, the VLM is capable of generating actionable insights based on its analysis.

The Action Proposal Generator (APG) is another key subsystem that interfaces with the VLM to interpret its output. The APG translates the VLM's analytical results into human-readable proposals or commands intended to optimize energy use. For example, the VLM may analyze video frames showing an unoccupied room with lights left on while simultaneously detecting in textual messages that residents have forgotten to turn off appliances. In such cases, the APG formulates a proposal to turn off the lights or specific appliances, clearly detailing the rationale behind the recommendation.

To ensure seamless communication of these proposals, the system includes a Notification Delivery Module (NDM). This module distributes the VLM-generated proposals to household members through multiple communication channels, such as email, SMS, or instant messaging platforms. For households with smart home devices, the system integrates with a Home Automation Controller (HAC), which directly receives machine-readable commands from the APG. The HAC is responsible for executing energy-saving actions, such as turning off lights, adjusting thermostat settings, or deactivating appliances, in response to the VLM's recommendations.

A critical aspect of this system is its iterative learning capability, facilitated by a Feedback Integration Unit (FIU). This unit collects feedback from residents regarding the effectiveness and acceptance of the VLM-generated proposals. This feedback is fed back into the VLM for continuous fine-tuning and improvement of its decision-making processes. Over time, the system becomes more adept at aligning its recommendations with the specific preferences and habits of the household.

The overall architecture is supported by a robust Data Security and Privacy Layer (DSPL) that ensures all captured data, including video frames and textual messages, is encrypted during transmission and storage. Access to the data and system functionality is strictly controlled through user authentication protocols, ensuring the privacy and security of household residents. Additionally, a Data Compliance Manager (DCM) monitors the system's operations to ensure adherence to local data protection regulations and ethical standards.

In operational terms, the system begins its process by activating the VPU and TDAM to collect data continuously or at predefined intervals. The Synchronization Manager ensures that this data is aligned and formatted for analysis. The VLM, guided by its prompts, processes the integrated data to identify energy inefficiencies or opportunities for optimization. Outputs from the VLM are processed by the APG, which formulates actionable insights. These insights are either sent to the residents via the NDM or executed directly through the HAC, depending on the nature of the action and the household's configuration.

The technical design of this system reflects its versatility and adaptability, capable of scaling to accommodate households of varying sizes and complexities. By integrating real-time video analytics, textual data processing, and automated action execution, this invention offers a comprehensive solution for reducing household energy consumption while respecting the unique preferences and behaviors of its residents. Its reliance on a multimodal approach, combining visual and textual data, enables a nuanced understanding of household dynamics, making it a pioneering step toward smarter, more sustainable living environments.

Some embodiments thus provide an automated method for reducing energy consumption and increasing energy efficiency within a household by leveraging visual and textual data analysis. At the core of the system is the Video Acquisition Unit, which continuously retrieves live video streams from multiple cameras installed across various rooms in the household. These video streams are fed into a Frame Extraction Module, which isolates and organizes individual video frames for further analysis. The extracted video frames are transferred to the Vision-and-Language Model for processing. This model is pre-trained to analyze visual content, allowing it to recognize and interpret objects, patterns, and behaviors within the household environment. For example, it can identify whether lights are left on in unoccupied rooms, detect operational status indicators on appliances, or observe obstructions to airflow caused by furniture placement.

In parallel, the system employs a Communication Data Integration Unit, which collects copies of textual messages exchanged among household residents through email and instant messaging platforms. This unit formats the collected messages and feeds them into the Vision-and-Language Model alongside the visual data. The Vision-and-Language Model processes these textual inputs to extract contextual information about household activities, preferences, and patterns. For instance, it may identify recurring discussions about energy-related topics, such as complaints about high utility bills, reminders to conserve electricity, or inquiries about appliance usage.

The system features a Prompting and Command Interface designed to issue specific instructions to the Vision-and-Language Model. This interface generates and applies tailored prompts that direct the model to perform an integrated analysis of the visual and textual data. These prompts command the Vision-and-Language Model to correlate observations from the video frames with the content of textual messages to uncover actionable insights. For instance, the system might correlate a textual reminder to reduce air conditioning usage with visual evidence of open windows in a room where an air conditioner is operating, highlighting an opportunity for energy optimization.

Once the Vision-and-Language Model completes its analysis, the Proposal Generation Module synthesizes the results into a set of recommended actions aimed at reducing energy consumption. These recommendations are tailored to the specific context and conditions of the household, taking into account the combined visual and textual data. For example, the system might propose turning off lights in unoccupied areas, adjusting thermostat settings based on resident preferences, or repositioning furniture to improve airflow and reduce reliance on HVAC systems. The recommendations are accompanied by detailed explanations that outline the rationale behind each proposed action.

The system includes a Notification Delivery Unit to communicate the recommendations to household residents. This unit formats the generated proposals into accessible and actionable messages, which are delivered via email, instant messaging, or other digital communication channels. Each message includes clear instructions on how to implement the recommendations, ensuring that residents can take immediate steps to optimize energy usage. For example, a notification might instruct residents to close a window detected to be open while the air conditioning system is active, providing both the observation and the suggested corrective action.

To validate the effectiveness of its recommendations, the system incorporates a Monitoring and Feedback Component. This component tracks the implementation of proposed actions and measures their impact on household energy consumption. Using data from smart meters, utility bills, and subsequent video or textual inputs, the system evaluates whether the recommended changes have resulted in measurable improvements. The findings are fed back into the Vision-and-Language Model to refine its analysis and enhance the accuracy of future proposals.

The modular architecture of the system allows it to be customized and scaled to suit various household configurations. For instance, in homes equipped with advanced smart devices, the system can interface directly with smart appliances, lighting controls, and HVAC systems to automate the execution of its recommendations. In less automated environments, the system focuses on providing detailed guidance to residents for manual implementation. This flexibility ensures that the system is effective across a wide range of user scenarios, from high-tech smart homes to traditional households.

In operation, the system seamlessly integrates data from visual and textual sources to provide a holistic view of energy usage and identify optimization opportunities. The Video Acquisition Unit collects live streams, the Frame Extraction Module prepares the data for analysis, and the Communication Data Integration Unit processes textual messages. The Prompting and Command Interface guides the Vision-and-Language Model to perform a combined analysis, while the Proposal Generation Module formulates actionable recommendations. The Notification Delivery Unit ensures that residents are informed, and the Monitoring and Feedback Component validates the system's impact and drives continuous improvement.

The system delivers a comprehensive and automated approach to enhancing energy efficiency within a household. By integrating components such as the Video Acquisition Unit, Communication Data Integration Unit, Vision-and-Language Model, Prompting and Command Interface, Proposal Generation Module, Notification Delivery Unit, and Monitoring and Feedback Component, it provides precise, actionable, and context-aware recommendations. Its ability to analyze and correlate data from multiple sources establishes it as an innovative tool for promoting sustainable energy practices and reducing utility costs in residential environments.

In some embodiments, functionalities or features of the system may be implemented by utilizing the following components:
Video Acquisition Unit: Captures live video streams from cameras positioned in various household rooms for real-time monitoring of the indoor environment.
Frame Extraction Module: Isolates individual frames from the video streams to prepare them for detailed visual analysis.
Vision-and-Language Model: Processes video frames and textual data to identify energy inefficiencies by correlating visual observations and contextual household information.
Communication Data Integration Unit: Collects and organizes email and instant messages exchanged by residents for analysis of textual patterns.
Prompting Interface: Issues tailored prompts to the Vision-and-Language Model to direct specific analytical tasks based on combined visual and textual inputs.
Proposal Generation Engine: Synthesizes analyzed data into actionable recommendations aimed at reducing energy consumption and improving efficiency.
Notification Delivery System: Formats and sends notifications to residents with recommendations and justifications for proposed actions.
Monitoring and Feedback Component: Tracks the outcomes of implemented actions to measure effectiveness and refine future recommendations.

In some embodiments, the method further comprises: (B1) automatically prompting said VLM to check whether VLM-based analysis of video frames from a first room in said household indicates that a window is said first room is open; (B2) automatically prompting the VLM to check whether VLM-based analysis of video frames from a second, different, room in said household indicates that an air conditioner unit is concurrently operating in said second room; (B3) exemplifying to the VLM that air conditioner units can be deduced to be operational (i) by visually inspecting control lights of air conditioner units, and (ii) by visually inspecting a mechanical position of mechanical switches of air conditioner units, and (iii) by visually detecting movements of plant leaves and papers and human hair due to air being blown out of an operational air conditioner unit; (B4) automatically prompting the VLM to generate a closure message, that reflects a VLM-generated proposal to close the open window or to close the air conditioning unit, if the VLM deduced that the window in said first room is open and that the air conditioner unit in said second room is concurrently operational.

The system is an advanced mechanism for detecting and addressing energy inefficiencies related to the concurrent operation of incompatible household conditions, such as an open window and an active air conditioning unit in separate rooms. The process begins with the Video Stream Acquisition Unit, which collects live video feeds from cameras installed in various rooms of the household. These video streams are processed by the Frame Analysis Component, which extracts individual frames and sends them to the Vision-and-Language Model for detailed examination. The Vision-and-Language Model is tasked with identifying and analyzing environmental elements within these frames, such as the status of windows (open or closed) and indicators of air conditioning unit operation.

The Vision-and-Language Model relies on a structured Prompting Interface to guide its analysis. This interface issues specific instructions to the model, such as identifying open windows in one room and simultaneously determining the operational state of air conditioning units in another. The operational status of air conditioning units is assessed using a combination of visual cues, including illuminated control lights, the mechanical position of switches, and secondary effects like the movement of nearby objects caused by air flow. For example, the system may detect papers or plant leaves being displaced by the air discharged from an active air conditioner, confirming its operation.

The data derived from the Vision-and-Language Model is integrated by the Condition Correlation Module, which cross-references findings from different rooms to identify situations where an open window and an operational air conditioning unit coexist. This module applies predefined logic rules to detect energy inefficiencies, such as cooling loss caused by air escaping through the open window. The Condition Correlation Module flags such occurrences for immediate corrective action, ensuring that inefficiencies are not overlooked.

The system incorporates a Proposal Generation Engine to create actionable recommendations based on the identified energy inefficiency. This engine synthesizes the findings of the Condition Correlation Module into a detailed closure message, which proposes specific actions to address the issue. For example, the closure message may suggest closing the open window to prevent air leakage or turning off the air conditioning unit in the affected room. The Proposal Generation Engine provides explanations for its recommendations, detailing how implementing the suggested actions will reduce energy wastage and improve overall efficiency.

The Notification Delivery System ensures that the closure message reaches household residents promptly and effectively. The message is formatted into a user-friendly notification that is sent via digital communication channels, such as email or instant messaging. Each notification includes a clear description of the detected inefficiency, the proposed corrective action, and the expected benefits of addressing the issue. For example, the notification may state that leaving a window open while an air conditioner operates in another room is estimated to increase energy consumption by a certain percentage, reinforcing the importance of the recommended action.

To enhance the accuracy of its recommendations, the system integrates an Exemplification Unit. This unit refines the Vision-and-Language Model's analysis by providing detailed examples of scenarios where air conditioning units are likely operational. These examples include specific visual patterns, such as the appearance of glowing control lights, the alignment of mechanical switches, and characteristic air flow effects. By incorporating these examples, the Exemplification Unit improves the model's ability to identify operational air conditioning units across diverse household environments.

The system's Feedback Integration Module tracks the outcomes of the recommendations implemented by residents. This module monitors subsequent video streams and compares them to baseline conditions to verify whether the detected inefficiency has been resolved. For instance, it checks whether the previously open window has been closed or if the air conditioning unit has been deactivated. The Feedback Integration Module uses this information to refine the system's detection algorithms and enhance its ability to identify similar inefficiencies in the future.

The modular architecture of the system allows for scalability and adaptability across different household configurations. For example, in homes equipped with smart automation systems, the Proposal Generation Engine can interface directly with home automation devices to implement corrective actions automatically. This may involve sending machine-readable commands to remotely close the detected open window or turn off the air conditioning unit, bypassing the need for manual intervention. In more traditional households, the system focuses on delivering actionable notifications for manual implementation by residents.

The operational workflow begins with the Video Stream Acquisition Unit capturing and processing live video feeds. The Frame Analysis Component extracts visual data, which is analyzed by the Vision-and-Language Model under the guidance of the Prompting Interface. The Condition Correlation Module identifies instances of energy inefficiency, and the Proposal Generation Engine formulates detailed recommendations. The Notification Delivery System communicates these recommendations to residents, while the Feedback Integration Module tracks their implementation and measures the system's impact.

The system provides an intelligent, automated approach to detecting and resolving energy inefficiencies caused by concurrent incompatible conditions, such as open windows and active air conditioning units. By integrating components such as the Video Stream Acquisition Unit, Frame Analysis Component, Vision-and-Language Model, Condition Correlation Module, Proposal Generation Engine, Notification Delivery System, Exemplification Unit, and Feedback Integration Module, it delivers precise, actionable, and context-aware solutions. Its modular and adaptive design ensures its applicability across a wide range of household environments, establishing it as a cutting-edge tool for enhancing energy efficiency and sustainability.

In some embodiments, functionalities or features of the system may be implemented by utilizing the following components:
Video Stream Analysis Module: Analyzes live video feeds to identify open windows and the operational status of air conditioning units in different rooms.
Window Status Detection Unit: Determines whether windows in the household are open or closed based on visual data from the Vision-and-Language Model.
Appliance Operational State Module: Detects the status of air conditioning units by analyzing control lights, switch positions, and secondary airflow effects.
Condition Correlation Module: Cross-references findings of open windows and active air conditioning units to identify energy inefficiencies.
Exemplification Unit: Enhances the accuracy of the Vision-and-Language Model by providing detailed examples of operational appliance conditions.
Proposal Generation Engine: Creates closure messages with recommendations to address detected inefficiencies, such as closing windows or turning off air conditioners.
Notification Delivery System: Communicates detailed closure messages to residents through digital channels.
Feedback Integration Module: Validates the effectiveness of implemented recommendations and refines the system's analysis algorithms.

In some embodiments, the computerized method further comprises: (C1) sending to a Home Automation Device (HAD) a query asking whether said window in the first room is registered with the HAD as a smart window that can be remotely opened and closed via a remotely-controlled electric motor; (C2) if the HAD responds to said query, that the window in the first room is indeed a smart window that can be remotely opened and closed, then: (C3) automatically transferring the closure message, that was generated by the VLM, from the VLM to that HAD; wherein the HAD is pre-configured to remotely close said window upon reception of a VLM-generated closure message if said window is a smart window that can be remotely closed.

The system builds upon its foundational capabilities to incorporate direct communication and operational interaction with Home Automation Devices to execute energy-saving actions effectively. A central component of this system is the Home Automation Query Module, which facilitates a seamless interface between the Vision-and-Language Model and the home automation infrastructure. Upon detecting inefficiencies such as an open window in one room of the household, the Vision-and-Language Model generates a closure message, which recommends corrective actions such as closing the window to optimize energy use. To determine whether the identified window can be controlled remotely, the Home Automation Query Module sends a query to the Home Automation Device. This query includes the location and identification of the window, as determined by the Vision-and-Language Model through video analysis.

If the Home Automation Device responds to the query by confirming that the window is a smart window equipped with a remotely-controlled electric motor, the system proceeds with automated execution of the corrective action. The system transfers the closure message generated by the Vision-and-Language Model to the Home Automation Device, which is pre-configured to process and execute such commands. This configuration enables the Home Automation Device to activate the motorized mechanism of the smart window, thereby closing the window without requiring manual intervention from household residents. The transfer of the closure message involves converting the human-readable recommendation from the Vision-and-Language Model into a machine-readable command format compatible with the Home Automation Device's communication protocols.

The system includes a Command Translation Unit, which ensures that the instructions generated by the Vision-and-Language Model are accurately interpreted by the Home Automation Device. This unit accounts for variations in communication protocols, command syntax, and device-specific requirements, ensuring seamless compatibility with diverse brands and models of home automation devices. For example, if the smart window operates on a Zigbee communication standard, the Command Translation Unit adapts the closure message into a Zigbee-compatible command. The transfer of this command to the Home Automation Device occurs over a secure local network, leveraging wired or wireless connectivity established between the system's central processing unit and the Home Automation Device.

In cases where the Home Automation Device responds to the query by indicating that the identified window is not equipped with a remote-control mechanism, the system adjusts its operational focus. Instead of commanding the closure of the window, the system redirects its efforts toward mitigating the inefficiency by controlling other relevant devices. The Vision-and-Language Model evaluates the operational status of the air conditioning unit detected in another room of the household and generates an alternative closure message. This message proposes turning off the air conditioning unit to reduce energy waste caused by the open window. The system transfers this new closure message to the Home Automation Device, which is pre-configured to manage the operation of air conditioning units in the household.

To execute this adjustment, the Home Automation Device processes the command to deactivate the air conditioning unit associated with the detected inefficiency. The device communicates with the air conditioning unit via its control interface, which may involve direct digital control or an intermediary relay mechanism. The system ensures precise execution by incorporating a Device State Validation Module, which verifies that the air conditioning unit has indeed been turned off following the transmission of the command. This validation involves real-time feedback from the air conditioning unit, confirming its updated operational state.

The integration of the Home Automation Query Module, the Command Translation Unit, and the Device State Validation Module creates a dynamic and adaptive system capable of managing energy inefficiencies in various household scenarios. By combining the analytical capabilities of the Vision-and-Language Model with the operational functionalities of home automation devices, the system provides a comprehensive solution for optimizing energy use. Additionally, the modular design of these components allows for scalability and compatibility with an expanding range of smart devices, ensuring the system remains versatile and future-proof.

The operational workflow of the system begins with the Vision-and-Language Model's detection of an open window and an active air conditioning unit. Upon generating the initial closure message, the system invokes the Home Automation Query Module to determine the capabilities of the identified window. Based on the response from the Home Automation Device, the system either proceeds to close the smart window or redirects its efforts toward deactivating the air conditioning unit. The Command Translation Unit ensures accurate and device-specific execution of these actions, while the Device State Validation Module provides confirmation of successful implementation. The entire process is designed to minimize delays, enabling real-time responses to energy inefficiencies.

The system also incorporates a Logging and Reporting Unit to document each action taken, including the details of the detected inefficiency, the generated closure message, the response from the Home Automation Device, and the final action executed. This documentation serves as a valuable record for system monitoring and further optimization. For instance, if the system repeatedly encounters scenarios where non-smart windows contribute to energy inefficiencies, the logged data could be used to recommend upgrading certain windows to smart-enabled versions. Similarly, the logs can provide insights into patterns of device usage and inefficiencies, informing broader energy management strategies.

The system enables a seamless and intelligent interaction between the Vision-and-Language Model and home automation devices to address energy inefficiencies effectively. By determining the controllability of windows and air conditioning units and executing corrective actions through pre-configured devices, the system offers a robust and automated solution for optimizing energy use in the household. Its modular architecture, advanced command translation capabilities, and validation mechanisms ensure precise and reliable operation, establishing it as a significant innovation in the field of energy-efficient home automation.

In some embodiments, functionalities or features of the system may be implemented by utilizing the following components:
Home Automation Query Unit: Sends queries to the home automation device to determine whether windows are equipped with remotely operable smart mechanisms.
Smart Window Detection Module: Identifies windows that can be remotely controlled and cross-references their status with data from the home automation system.
Closure Message Transfer System: Transmits Vision-and-Language Model-generated closure messages to the home automation device for execution.
Smart Window Control Module: Interfaces with smart windows to execute commands for remote opening or closing as needed.
Window Actuation Monitoring Unit: Tracks the status of smart windows after receiving closure messages to ensure successful execution.
Vision-and-Language Model: Validates the analysis of household conditions and generates actionable instructions based on observed inefficiencies.
Proposal Communication Interface: Delivers updates to residents about actions taken by the home automation device.
Energy Impact Tracking System: Monitors energy usage changes following window closure to validate efficiency improvements.

In some embodiments, the computerized method further comprises: (D1) if the HAD responds to said query, that the window in the first room is not a smart window, then: (D2) automatically transferring the closure message, that was generated by the VLM, from the VLM to that HAD; wherein the HAD is pre-configured to turn off the air conditioner unit upon reception of a VLM-generated closure message if said window is not a smart window.

The system extends its functionality by providing a specialized mechanism to address energy inefficiencies in households where certain components, such as windows, lack smart-enabled features. The process begins with the Vision-and-Language Model identifying a situation in which a window in one room is open while an air conditioning unit is operational in another room, thereby creating a scenario of energy waste. Once this inefficiency is detected, the Vision-and-Language Model generates a closure message, proposing corrective actions to mitigate the energy loss. To determine the appropriate course of action, the system queries the Home Automation Device regarding the controllability of the identified window. If the Home Automation Device confirms that the window cannot be remotely controlled, the system transitions its focus from attempting to close the window to deactivating the air conditioning unit.

Central to this functionality is the Control Decision Module, which evaluates the response from the Home Automation Device to determine the appropriate action pathway. When the Control Decision Module identifies that the window cannot be closed due to the lack of a remote-control mechanism, it instructs the Command Generation Unit to produce an alternative command targeting the air conditioning unit. This alternative command is derived from the closure message generated by the Vision-and-Language Model and adapted by the Command Generation Unit to be compatible with the specific control protocols of the air conditioning unit.

The system utilizes a Device Communication Interface to transmit the command to the Home Automation Device. This interface is designed to support a variety of communication protocols, including but not limited to wireless standards such as Wi-Fi, Zigbee, or Z-Wave, as well as wired connections where applicable. The Device Communication Interface ensures that the command is delivered to the Home Automation Device in a reliable and timely manner, facilitating the deactivation of the air conditioning unit to prevent further energy waste.

Once the Home Automation Device receives the command, it engages with the Operational Control Unit of the air conditioning system. The Operational Control Unit is responsible for executing the deactivation process, which may involve powering down the unit entirely or transitioning it to an idle or energy-saving state, depending on its configuration. The system includes a State Validation Module that monitors the status of the air conditioning unit following the execution of the command. The State Validation Module receives feedback signals from the air conditioning unit's sensors or control interface, confirming whether the unit has been successfully deactivated. In cases where the deactivation is not confirmed, the State Validation Module triggers a reattempt or alerts the system to investigate potential issues with the command execution.

A key feature of this system is its adaptability to various types of air conditioning units, including central air systems, split units, and portable devices. The Command Generation Unit is equipped with a Protocol Adaptation Layer that allows it to translate the Vision-and-Language Model's closure message into specific commands that match the operational characteristics of the targeted air conditioning unit. For example, if the air conditioning unit requires a sequence of instructions to power down, such as reducing fan speed before shutting off the compressor, the Protocol Adaptation Layer ensures these instructions are included in the command.

To further enhance its operational efficiency, the system incorporates a Context Analysis Engine that evaluates additional environmental and operational parameters before finalizing the command. For instance, the Context Analysis Engine may assess the current indoor and outdoor temperatures, the duration for which the window has been open, and the energy consumption trends of the air conditioning unit. This contextual analysis allows the system to refine its decision-making process and prioritize actions that yield the highest energy savings with minimal disruption to household comfort.

The system also includes a Notification Delivery Component that informs household residents of the action taken. Once the air conditioning unit has been successfully deactivated, the Notification Delivery Component generates a message detailing the identified inefficiency, the corrective action implemented, and the expected impact on energy consumption. This message is sent to the residents via communication channels such as email or instant messaging. The Notification Delivery Component ensures that residents are kept informed and can provide feedback on the system's actions, enabling continuous improvement and alignment with user preferences.

The modular architecture of the system allows it to be integrated seamlessly into a variety of household configurations, from fully automated smart homes to partially automated setups with limited smart-enabled devices. The ability to adapt to non-smart windows by shifting focus to controllable devices like air conditioning units demonstrates the system's versatility and practicality in addressing real-world energy inefficiencies. Moreover, the system's reliance on the Vision-and-Language Model for analyzing visual and contextual data ensures that it can identify inefficiencies accurately and generate actionable insights even in complex household environments.

In operation, the system follows a structured workflow to ensure efficient execution of its functions. Upon detecting an open window and an active air conditioning unit, the Vision-and-Language Model generates a closure message. The Control Decision Module queries the Home Automation Device to determine the controllability of the window. If the window is non-smart, the Command Generation Unit creates a tailored command for deactivating the air conditioning unit, which is then transmitted via the Device Communication Interface. The State Validation Module confirms the execution of the command, while the Notification Delivery Component communicates the action to the residents. Each component plays a critical role in ensuring the system operates with precision and reliability.

The system thus provides a robust solution for addressing energy inefficiencies in households with non-smart windows. By dynamically redirecting its actions toward controllable devices like air conditioning units, the system maximizes its impact on energy savings while maintaining operational flexibility. Its integration of advanced modules, including the Control Decision Module, Command Generation Unit, Device Communication Interface, and State Validation Module, ensures seamless execution of corrective actions, establishing the system as an innovative and practical tool for energy-efficient home management.

In some embodiments, functionalities or features of the system may be implemented by utilizing the following components:
Non-Smart Window Detection Module: Identifies windows that cannot be remotely controlled and triggers alternate energy-saving actions for non-smart setups.
Air Conditioning Control Interface: Interacts with the home automation system to turn off air conditioners when a non-smart open window is detected.
Vision-and-Language Model: Confirms energy inefficiencies and generates recommendations for alternate actions when smart window controls are unavailable.
Condition Correlation Module: Matches open non-smart windows with concurrent active air conditioning units to pinpoint inefficiencies.
Alternate Action Execution System: Directs the home automation device to deactivate air conditioning units as a compensatory measure.
Notification Delivery System: Sends detailed updates to residents about actions taken in response to inefficiencies involving non-smart windows.
Energy Optimization Analysis Module: Calculates the energy savings achieved by turning off air conditioning units due to open non-smart windows.
Monitoring and Feedback Component: Tracks and validates the effectiveness of alternate actions taken for non-smart window scenarios.

In some embodiments, the computerized method comprises: (E1) automatically prompting the VLM, (a) to analyze email messages that are incoming into email boxes of residents of said household, and (b) to detect an email message that was received in the past T days that indicates that a new electrical appliance was ordered, wherein T is a pre-defined value in a range of 3 to 14; and (E2) automatically prompting the VLM to obtain, from the Internet and from a general body-of-knowledge on which the VLM was trained, energy-saving tips for utilizing said new electrical appliance; and (E3) automatically prompting the VLM to generate a Tips Proposal Message that conveys to residents of said household how to implement said energy-saving tips when utilizing said new electrical appliance; and (E4) exemplifying to the VLM, (a) that utilization of a clothes dryer machine should be performed only after cleaning of a lint filter of the clothes dryer machine to increase efficiency and to reduce energy consumption, and (b) that an oven should be pre-heated only when cooking instruction require pre-heating, and (c) that fridge door and freezer door should be closed within 10 seconds of their opening; and (E5) automatically sending to all residents of the household, via electronic mail or SMS or Instant Messaging, a new message that congratulates them on purchasing said new electrical appliance and that further conveys the VLM-generated Tips Proposal Message on how to implement energy-saving tips when utilizing said new electrical appliance.

The system introduces an advanced mechanism for identifying newly purchased electrical appliances and providing household residents with tailored energy-saving recommendations for their efficient use. This functionality begins with an Email Analysis Module that continuously monitors email accounts associated with the household. The module scans incoming emails for indications of recent purchases, specifically looking for confirmation messages from online retailers or receipts that specify the acquisition of a new electrical appliance. To determine the relevance of these messages, the Email Analysis Module uses the Vision-and-Language Model to extract and analyze contextual details, such as the name, model, and specifications of the appliance. The module operates within a pre-defined time window, scanning emails received within a configurable range of days, such as the past three to fourteen days.

Once a new appliance is identified, the system activates the Appliance Profile Builder, which compiles detailed information about the appliance. This information includes technical specifications, typical energy consumption patterns, and operational features. The Appliance Profile Builder retrieves additional data from external sources, such as manufacturer websites and the general body of knowledge available on the internet. The Vision-and-Language Model plays a critical role in synthesizing this data, ensuring that the appliance's characteristics are accurately documented. For instance, if the identified appliance is a refrigerator, the Appliance Profile Builder gathers information on its energy rating, average power usage, and features like adaptive defrost or temperature control.

Following the creation of the appliance profile, the system engages the Energy Optimization Knowledge Base, which houses a repository of best practices and energy-saving tips for a wide range of electrical appliances. The Vision-and-Language Model accesses this knowledge base and integrates its contents with the appliance profile to generate actionable energy-saving recommendations tailored to the identified appliance. These recommendations may include general practices, such as minimizing standby power consumption or specific actions based on the appliance's features. For example, for a clothes dryer, the system might recommend regular cleaning of the lint filter to enhance airflow and reduce drying times, while for an oven, it could advise preheating only when specified in cooking instructions.

The system's Recommendations Generation Engine refines these insights into a coherent and user-friendly format. This engine structures the recommendations as a Tips Proposal Message, which combines congratulatory language on the recent purchase with clear, concise guidance on energy-efficient usage. The message also includes practical examples to help residents understand the proposed actions. For instance, if the appliance is a refrigerator, the Tips Proposal Message might emphasize closing the fridge door promptly and organizing items for quicker access to minimize energy loss.

The system then utilizes the Notification Delivery Module to distribute the Tips Proposal Message to all residents of the household. This module supports multiple communication channels, such as email, instant messaging, and SMS, ensuring that the recommendations are delivered promptly and are easily accessible to household members. Additionally, the Notification Delivery Module formats the messages for compatibility with various devices, such as smartphones, tablets, and desktop computers, to enhance user engagement.

To ensure that the recommendations are actionable and relevant, the system includes an Exemplification Component, which uses examples to clarify the significance of each recommendation. For example, the Exemplification Component might illustrate that failing to clean a dryer's lint filter can increase drying times and energy costs by a specific percentage, or that keeping a refrigerator door open for longer than ten seconds can result in measurable temperature fluctuations that strain the appliance's compressor. By grounding its recommendations in real-world scenarios, the system enhances their credibility and encourages compliance.

Another important feature of this system is its Feedback Collection Interface, which allows household residents to provide input on the relevance and usability of the recommendations. This interface collects responses through embedded links in the Tips Proposal Message, enabling residents to indicate whether they have implemented the suggestions and, if so, whether they observed improvements in energy efficiency. The Feedback Collection Interface routes this data back to the Vision-and-Language Model, which uses it to refine future recommendations and improve the system's overall effectiveness.

The system also supports dynamic updates to the Energy Optimization Knowledge Base, ensuring that its recommendations remain current and reflect the latest advancements in appliance technology and energy-saving practices. The Knowledge Base Integration Unit coordinates this process by periodically sourcing new information from reputable online resources and integrating it into the repository. This ensures that even long-term users of the system continue to receive valuable and up-to-date insights.

The modular design of the system allows for scalability and adaptability to diverse household environments. For instance, in households with smart appliances, the system can interface directly with the appliances through a Home Automation Controller, enabling it to implement certain energy-saving actions automatically. In such cases, the Recommendations Generation Engine adjusts its output to include instructions for configuring the appliance's settings remotely, such as activating energy-saving modes or scheduling operational times during off-peak electricity rates.

In operational workflow, the system begins with the Email Analysis Module identifying a new appliance purchase. The Appliance Profile Builder then compiles a detailed profile, which is enriched by data from the Energy Optimization Knowledge Base. The Recommendations Generation Engine formulates these insights into a Tips Proposal Message, which is delivered through the Notification Delivery Module. The Exemplification Component and Feedback Collection Interface ensure that the recommendations are both actionable and continuously refined based on user input.

The system thus offers a comprehensive solution for enhancing the energy efficiency of newly acquired electrical appliances. By combining advanced data analysis, tailored recommendations, and real-world examples, it empowers household residents to adopt energy-saving practices effectively. Its integration of modular components, such as the Email Analysis Module, Appliance Profile Builder, Energy Optimization Knowledge Base, and Recommendations Generation Engine, ensures precision and adaptability, making it a valuable tool for sustainable home management.

In some embodiments, functionalities or features of the system may be implemented by utilizing the following components:
Email Analysis Unit: Analyzes email messages for indications of newly purchased electrical appliances based on receipts, confirmations, or delivery notices.
Energy Tips Retrieval Module: Gathers energy-saving tips for the newly detected appliances from the internet and pre-trained Vision-and-Language Model knowledge bases.
Appliance Tip Integration System: Combines retrieved energy-saving tips with detailed appliance usage instructions for actionable guidance.
Exemplification Engine: Provides examples of best practices for appliance usage to maximize energy efficiency, such as cleaning filters or timely pre-heating.
Tips Proposal Generation Unit: Creates a comprehensive energy-saving proposal for the new appliance, tailored to household usage patterns.
Notification Delivery System: Delivers congratulatory messages with energy-saving tips to residents via email or instant messaging.
Vision-and-Language Model: Validates and contextualizes energy-saving tips, ensuring relevance to the specific appliance and household.
Feedback Monitoring Component: Tracks the implementation of energy-saving measures and evaluates their impact on energy consumption.

In some embodiments, the computerized method comprises: (F1) automatically prompting the VLM, (a) to analyze email messages and Instant Messages that were exchanged among residents of said household in the past 30 days, and (b) to extract information regarding personal preference of each resident regarding desired temperature; (F2) automatically prompting the VLM to generate a Cooling and Heating Proposal for turning-on and turning-off cooling units and heating units in said household, and for operational settings of said cooling units and heating units at particular time-slots, to maximize a match to personal preferences of at least most of the residents of the household; (F3) exemplifying to the VLM that if a first resident has expressed a preference that temperature in the household would be in a range of 70 to 75 degrees Fahrenheit, and a second resident has expressed a preference that temperature in the household would be in a range of 73 to 77 degrees Fahrenheit, and a third resident has expressed a preference that temperature in the household would be in a range of 75 to 79 degrees Fahrenheit, then an air conditioner unit should be set to a target temperature of 75 degrees as said target temperature satisfies all preferences of all residents; (F4) transferring the VLM-generated Cooling and Heating Proposal, (a) via electronic mail to all residents of the household, and also (b) via a set of machine-readable commands to the HAD of the household which is pre-configured to control heating units and cooling units of the household based on VLM-generated Cooling and Heating Proposal.

The system introduces an advanced framework for analyzing and optimizing household temperature settings to align with the personal preferences of its residents. This system employs a Vision-and-Language Model to synthesize information from various data sources and generate actionable proposals for energy-efficient heating and cooling operations. The process begins with a Message Analysis Unit, which examines email messages and instant messages exchanged among household residents over a specified time period, such as the past 30 days. The Message Analysis Unit extracts relevant data regarding individual temperature preferences, including specific ranges or qualitative descriptors like “cooler evenings” or “warmer mornings.” This extracted information forms the foundation for tailoring the system's temperature control strategies.

Once the Message Analysis Unit has compiled the temperature preferences of individual residents, the data is transmitted to a Preference Integration Module. This module uses the Vision-and-Language Model to analyze overlapping and conflicting preferences. It generates a unified temperature range that accommodates the majority of residents. For example, if one resident prefers temperatures between 70 to 75 degrees Fahrenheit, another prefers 73 to 77 degrees, and a third prefers 75 to 79 degrees, the Preference Integration Module identifies a target temperature, such as 75 degrees, that satisfies all three ranges.

The system then employs a Schedule Optimization Engine to develop a time-based heating and cooling plan. This engine cross-references the unified temperature range with the typical daily schedules of residents, identifying time slots where adjustments can maximize comfort while minimizing energy use. For instance, during periods when all residents are away from home, the Schedule Optimization Engine lowers or raises the temperature to conserve energy, returning it to the target range before residents return. The engine ensures that energy-saving measures do not compromise comfort during high-occupancy hours.

The generated schedule is further refined by the Contextual Adjustment Component, which incorporates external environmental data such as current weather conditions and seasonal variations. This component uses real-time temperature and humidity readings from external sensors or online weather services to adjust the heating and cooling plan dynamically. For example, if the outdoor temperature drops significantly in the evening, the Contextual Adjustment Component may recommend pre-heating the home to maintain the target temperature range with reduced energy consumption.

Once the optimized schedule is finalized, the system transmits it to two output pathways: a Human Notification Interface and a Device Control Module. The Human Notification Interface formats the schedule into an easy-to-understand Cooling and Heating Proposal, which is sent to residents via email or instant messaging. This proposal includes a detailed explanation of the temperature settings, time slots, and expected energy savings, allowing residents to review and approve the plan. For households with smart devices, the Device Control Module directly communicates the schedule to the Home Automation Controller. The controller executes the heating and cooling adjustments by sending specific commands to thermostats, HVAC systems, and other temperature-regulating devices.

The Device Control Module includes a Command Execution Validator to ensure that all commands are implemented correctly. This validator monitors feedback from the connected devices, such as confirmation signals from a thermostat that the temperature has been adjusted. If any discrepancies are detected, the validator initiates a reattempt or notifies the system of the failure for further troubleshooting.

To enhance the accuracy and relevance of its proposals, the system incorporates an Exemplification Engine that supplies the Vision-and-Language Model with illustrative scenarios and guidelines. For example, it might demonstrate that a cooling unit should be set to a mid-range temperature when preferences overlap broadly or that minor adjustments can significantly improve energy efficiency. These examples guide the Vision-and-Language Model in generating proposals that balance comfort and sustainability.

The system also includes a Feedback Collection Module, which allows residents to provide input on the effectiveness of the Cooling and Heating Proposal. Feedback is collected through embedded links or forms in the notification messages. This feedback is used to refine the Preference Integration Module's algorithms and improve future scheduling recommendations. Over time, the system adapts to the evolving preferences and schedules of household residents, ensuring continuous alignment with their needs.

In operation, the system performs its functions in a structured sequence. The Message Analysis Unit gathers temperature preference data, which is processed by the Preference Integration Module to generate a unified range. The Schedule Optimization Engine creates a time-based plan, which is dynamically adjusted by the Contextual Adjustment Component. The finalized plan is disseminated through the Human Notification Interface and executed via the Device Control Module. Each component operates in real-time or at scheduled intervals to ensure responsiveness and accuracy.

This system is designed to integrate seamlessly into a wide range of household configurations, from fully automated smart homes to partially automated setups. Its modular architecture allows for customization and scalability, enabling it to accommodate additional residents, devices, or environmental factors. For instance, the system can be expanded to include advanced HVAC features such as zone-based heating and cooling or integration with renewable energy sources like solar panels.

The system provides a comprehensive and intelligent solution for optimizing household temperature settings. By combining the analytical capabilities of the Vision-and-Language Model with robust data processing and control mechanisms, it delivers personalized and energy-efficient heating and cooling plans. The integration of components such as the Message Analysis Unit, Preference Integration Module, Schedule Optimization Engine, and Device Control Module ensures precise and adaptable operation, making this system a significant advancement in sustainable home automation technology.

In some embodiments, functionalities or features of the system may be implemented by utilizing the following components:
Temperature Preference Analysis Unit: Extracts and analyzes email and message content to identify the desired temperature ranges of individual household residents based on explicit and implicit preferences.
Cooling and Heating Proposal Engine: Generates tailored recommendations for turning on or off cooling and heating units, aligning with the temperature preferences of most residents in specific time slots.
Occupancy Detection Module: Monitors room usage to prioritize cooling and heating adjustments for occupied spaces while reducing energy consumption in unoccupied areas.
Temperature Compatibility Calculator: Determines the optimal temperature setting that satisfies overlapping preferences of multiple residents, ensuring energy efficiency without compromising comfort.
Proposal Delivery Interface: Sends recommendations for temperature settings to both residents and connected climate control systems for implementation.
Usage Pattern Learning Module: Identifies recurring temperature adjustment needs based on historical data to predict and recommend settings for future scenarios.
Energy Savings Estimation Unit: Calculates potential energy savings from proposed temperature adjustments and includes these estimates in reports to residents.
Feedback Monitoring Component: Tracks the implementation and impact of proposed temperature settings, refining future recommendations based on observed outcomes.

In some embodiments, the computerized method comprises: (G1) automatically prompting the VLM, (a) to analyze email messages that were received by one or more residents of said household in the past 365 days, and (b) to extract from them electricity bills and electricity usage statements that were sent via email to one or more residents of said household; (G2) automatically prompting the VLM to generate a Usage Modification Proposal, for modifying a manner or a timing in which one or more electrical devices are operated in the household, based on VLM analysis of said electricity bills and electricity usage statements; (G3) exemplifying to the VLM that if an electricity bill indicates a first monetary rate for consuming electricity in morning time and a second, lower, monetary rate for consuming electricity at night time, then electric devices that perform operations that are not time-sensitive should be operated at night time and not in morning time; and further exemplifying to the LLM that a suitable type of such electric devices is a clothes dryer machine, a clothes washing machine, and a yard water sprinkler system; (G4) automatically transferring the VLM-generated Usage Modification Proposal, (a) via electronic mail to all residents of the household, and also (b) via a set of machine-readable commands to the HAD of the household which is pre-configured to control electric devices of the household based on VLM-generated Usage Modification Proposals.

The system extends its capabilities by incorporating a mechanism to analyze historical electricity usage and billing data to identify patterns and generate actionable recommendations for modifying household energy consumption. At the core of this system is the Electricity Data Analysis Module, which interfaces with household residents' email accounts to retrieve electricity bills and usage statements sent by utility providers over a specified time period, such as the past year. These documents are processed using the Vision-and-Language Model, which extracts relevant details such as total energy consumption, billing cycles, peak and off-peak usage patterns, and associated costs. The Vision-and-Language Model also interprets usage trends and compares them with known efficiency benchmarks to identify opportunities for improvement.

The Electricity Data Analysis Module collaborates with the Rate Optimization Engine to evaluate the financial impact of current energy consumption patterns. The Rate Optimization Engine analyzes the cost structure outlined in the electricity bills, focusing on variations in monetary rates for energy consumed during different times of the day. For example, it identifies whether the household's utility provider charges higher rates during morning hours and lower rates during nighttime. Using this information, the Rate Optimization Engine establishes guidelines for optimizing the timing of specific energy-intensive operations, such as running washing machines, clothes dryers, or sprinkler systems.

The Timing Adjustment Component plays a critical role in translating these guidelines into practical, actionable recommendations. This component uses the Vision-and-Language Model to identify household appliances that can operate at flexible times without compromising user convenience. For instance, it evaluates non-time-sensitive devices like dishwashers or pool pumps and suggests rescheduling their usage to align with off-peak electricity rates. To ensure relevance, the Timing Adjustment Component incorporates operational characteristics of these devices, such as cycle durations, average energy consumption per use, and user-defined preferences for scheduling.

The Proposal Generation Module consolidates the insights from the Electricity Data Analysis Module, the Rate Optimization Engine, and the Timing Adjustment Component to create a Usage Modification Proposal. This proposal provides household residents with a detailed plan for adjusting the operation and scheduling of appliances to reduce electricity costs. The Usage Modification Proposal includes a breakdown of current usage patterns, identified inefficiencies, recommended modifications, and their expected impact on energy consumption and costs. For example, the proposal might specify that running the washing machine between 10 PM and 6 AM could save a specific percentage on monthly energy bills.

To ensure the proposal is accessible and actionable, the system incorporates a Human Communication Interface. This interface formats the Usage Modification Proposal into a visually clear and easily understandable report. The report is sent to household residents via email or instant messaging platforms, providing them with immediate access to the recommendations. The Human Communication Interface also supports interactive features, such as links to external resources or tutorials on how to implement the recommendations effectively.

The system further integrates with the Home Automation Controller to enable automated execution of the Usage Modification Proposal. The Home Automation Controller receives a machine-readable version of the proposal, which includes commands for rescheduling or adjusting the operation of specific appliances. For example, if the proposal suggests running the dishwasher at midnight, the Home Automation Controller sends a command to the appliance at the designated time to initiate its cycle. This functionality eliminates the need for manual intervention, ensuring that energy-saving measures are consistently applied.

To validate the effectiveness of the implemented recommendations, the system includes a Feedback Monitoring Unit. This unit tracks energy consumption and cost data over subsequent billing cycles to determine whether the adjustments have achieved the projected savings. The Feedback Monitoring Unit interfaces with the Vision-and-Language Model to analyze updated electricity bills and usage statements, comparing them with baseline data to quantify improvements. If the projected savings are not realized, the system recalibrates its recommendations to address potential discrepancies.

The Contextual Analysis Engine enhances the accuracy and relevance of the Usage Modification Proposal by incorporating additional factors such as seasonal variations, household occupancy patterns, and appliance maintenance schedules. For instance, during summer months when air conditioning usage increases, the Contextual Analysis Engine adjusts its recommendations to focus on optimizing cooling-related devices. Similarly, if the system detects that certain appliances have not been serviced recently, it includes reminders to perform maintenance tasks that could improve efficiency, such as cleaning filters or inspecting seals.

The modular architecture of the system ensures scalability and adaptability to different household configurations and energy consumption patterns. It can accommodate households with varying numbers of appliances, diverse utility rate structures, and differing levels of automation. For example, in homes with smart appliances, the system can interface directly with device control modules to implement modifications automatically. In homes with conventional appliances, the system provides detailed guidance for manual adjustments.

The operational workflow of the system begins with the Electricity Data Analysis Module retrieving and processing historical electricity bills and usage statements. The Rate Optimization Engine identifies cost-saving opportunities based on rate structures, while the Timing Adjustment Component evaluates the operational flexibility of household appliances. The Proposal Generation Module creates a detailed Usage Modification Proposal, which is delivered to residents via the Human Communication Interface and executed through the Home Automation Controller. The Feedback Monitoring Unit tracks and validates the outcomes, enabling continuous refinement of the system's recommendations.

The system offers a comprehensive solution for optimizing household energy consumption based on detailed analysis of electricity usage and billing data. By integrating components such as the Electricity Data Analysis Module, Rate Optimization Engine, Timing Adjustment Component, Proposal Generation Module, and Feedback Monitoring Unit, the system provides actionable insights and automates their implementation. Its ability to adapt to diverse household environments and energy usage patterns establishes it as a valuable tool for enhancing energy efficiency and reducing costs.

In some embodiments, functionalities or features of the system may be implemented by utilizing the following components:
Electricity Usage Analysis Unit: Extracts and analyzes past electricity bills and usage statements to identify high-consumption patterns and inefficiencies.
Cost Differentiation Module: Detects time-of-use electricity rates, comparing peak and off-peak prices to recommend shifting non-urgent operations to cheaper time slots.
Appliance Scheduling Engine: Creates optimized schedules for time-insensitive appliances like washing machines, dryers, or sprinkler systems to operate during off-peak hours.
Energy Usage Comparison Tool: Evaluates potential cost and energy savings by shifting usage patterns based on past billing data and expected future rates.
Proposal Generation Module: Develops a Usage Modification Proposal, detailing recommended operational changes for specific appliances and the benefits of implementing these changes.
Notification Delivery System: Sends the Usage Modification Proposal to residents through digital channels for action and review.
Automated Command Interface: Interfaces with smart home systems to directly execute operational changes for compatible appliances.
Impact Validation Unit: Monitors energy usage after implementation, comparing actual savings to projected outcomes and refining recommendations based on discrepancies.

In some embodiments, the computerized method comprises: (H1) automatically analyzing, by the VLM, copies of email messages and instant messages that were exchanged among residents of the household in the past 30 days; and detecting, by the VLM, a future time-slot in which a particular resident plans to be away from the household; (H2) automatically analyzing, by the VLM, said live video streams and also previously-recorded video streams from rooms of the household; and matching between said particular resident and a particular room that said particular resident occupies by himself without other residents; (H3) automatically generating, by the VLM, a Resident-Is-Away control message that instructs the HAD of the household, to turn off lights in said particular room of said particular resident, during said future time-slot in which the VLM deduced that said particular resident planned to be away; (H4) transferring from the VLM to said HAD the Resident-Is-Away control message, wherein the HAD of the household is pre-configured to selectively turn off lights in one or rooms of the household in response to VLM-generated messages that indicate that the VLM deduced that a particular resident plans to be away.

The system is a highly advanced and automated solution designed to identify and act upon future periods of resident absence to optimize household energy consumption. The process begins with the implementation of a Message and Calendar Analysis Unit, which gathers and analyzes textual data from email messages and instant messages exchanged among residents over a defined timeframe, such as the past 30 days. This unit also integrates with calendar applications running on resident devices, extracting scheduling data that includes appointments, travel plans, or other activities indicative of residents being away from the household. The data is processed using the Vision-and-Language Model, which is tasked with identifying specific time slots during which individual residents plan to be absent.

Once the Vision-and-Language Model identifies a planned absence, it cross-references this temporal information with video data processed by the Resident Activity Analysis Module. This module utilizes video streams from household cameras to establish the habitual patterns and spatial preferences of each resident within the household. By correlating the textual and video data, the module determines which room or rooms are primarily occupied by the resident who plans to be absent. For example, if a particular resident consistently occupies a specific bedroom or study, the system identifies these spaces as candidates for energy-saving adjustments during the resident's absence.

The Proposal Generation Engine then synthesizes these insights to produce a Resident-Is-Away control message. This message includes detailed instructions for modifying the operational state of energy-consuming devices in the identified rooms. For instance, the control message may specify turning off lights, ceiling fans, or other appliances during the specified absence period. The Proposal Generation Engine ensures that the control message is structured in a format compatible with the Home Automation Controller for seamless execution.

The Home Automation Controller receives the Resident-Is-Away control message and communicates directly with the relevant devices in the household. For example, if the identified room contains smart lighting fixtures, the controller sends a command to deactivate the lights during the resident's absence. Similarly, for appliances or devices not in use, the controller ensures they are placed in a standby or powered-off state to conserve energy. The Home Automation Controller operates in real-time, ensuring the energy-saving measures are implemented precisely at the beginning of the planned absence and reverted once the resident returns.

The system also incorporates a Lighting and Appliance Validation Module, which verifies the successful execution of the control message. This module monitors the operational status of devices targeted for deactivation and provides feedback to the system. For example, it checks whether the lights in a specific room have been turned off as instructed or whether an appliance remains active due to an error or manual override. If discrepancies are detected, the module triggers a reattempt to implement the control message or flags the issue for further review.

A unique aspect of this system is its ability to refine its proposals based on real-time conditions. The Temporal Adjustment Engine dynamically adjusts the implementation of the control message based on factors such as unexpected changes in the resident's schedule or shifts in household occupancy patterns. For instance, if the resident's absence is canceled or delayed, the Temporal Adjustment Engine updates the control message and ensures that no unnecessary energy-saving actions are executed.

To inform residents of the actions being taken, the system includes a Notification Delivery Unit. This unit sends messages to the household members detailing the planned energy-saving adjustments, the rationale behind them, and the expected benefits. These notifications are designed to ensure transparency and allow residents to provide feedback or make manual adjustments if desired. For example, a resident may choose to override the control message for specific appliances they wish to remain operational during their absence.

The Feedback Integration Component is another critical element of the system, collecting user responses to the notifications and analyzing them to refine future control messages. This component also gathers data on the actual energy savings achieved during past implementations of Resident-Is-Away control messages, enabling continuous improvement of the system's recommendations and execution strategies.

In operation, the system follows a structured workflow. The Message and Calendar Analysis Unit identifies planned absences and the Resident Activity Analysis Module maps these absences to specific rooms. The Proposal Generation Engine creates a control message that is executed by the Home Automation Controller, with real-time adjustments handled by the Temporal Adjustment Engine. The Lighting and Appliance Validation Module ensures the successful application of the energy-saving measures, while the Notification Delivery Unit and Feedback Integration Component maintain user engagement and iterative optimization.

The modular architecture of this system allows for scalability and adaptability across diverse household configurations. It can accommodate various combinations of smart and non-smart devices, tailoring its control messages to the capabilities of the household's infrastructure. For instance, in homes equipped with advanced smart home systems, the Home Automation Controller can manage intricate scenarios such as adjusting thermostat settings, disabling power outlets, or modifying security camera configurations based on absence periods.

The system provides a comprehensive and automated approach to optimizing energy consumption during periods of resident absence. By integrating the capabilities of the Message and Calendar Analysis Unit, Resident Activity Analysis Module, Proposal Generation Engine, Home Automation Controller, Lighting and Appliance Validation Module, and Temporal Adjustment Engine, the system ensures precise and efficient execution of energy-saving measures. Its dynamic adaptability and user-centric design establish it as an innovative solution for sustainable energy management in modern households.

In some embodiments, functionalities or features of the system may be implemented by utilizing the following components:
Schedule Extraction Module: Gathers and analyzes email messages and instant messages to detect planned absences of residents from the household.
Room Occupancy Mapping Unit: Matches each resident to specific rooms they predominantly occupy based on historical and real-time data analysis.
Resident Activity Predictor: Anticipates future absences and their durations by analyzing historical patterns and personal schedules.
Light Control Command Generator: Creates and transmits room-specific commands to turn off lights in areas associated with absent residents during predicted time slots.
Occupancy Verification Module: Uses video analysis to confirm the absence of residents in rooms before deactivating lighting or other appliances.
Light Status Monitoring Unit: Tracks the status of lights in affected rooms to ensure they are turned off as recommended.
Energy Efficiency Reporting Tool: Provides residents with detailed reports on energy savings achieved through light management based on their absence patterns.
Adaptation Learning Module: Refines absence prediction algorithms based on feedback from unanticipated schedule changes or overridden system actions.

In some embodiments, the computerized method comprises: (I1) automatically extracting copies of all scheduling data, from scheduling applications and calendar applications that run on electronic devices of residents of said household; (I2) automatically feeding into the VLM said copies of scheduling data, and prompting the VLM to estimate which resident of the household will be away from the household in a future time-slot that is within 7 days forward; (I3) automatically generating by the VLM a prediction, based on said copies of scheduling data, indicating that a specific resident of the household will be away from the household in said future time-slot; (I4) automatically analyzing, by the VLM, said live video streams and also previously-recorded video streams from rooms of the household; and matching between said particular resident and a particular room that said particular resident occupies by himself without other residents; (I5) automatically generating, by the VLM, a Calendar-Based Resident-Is-Away control message that instructs the HAD of the household, to turn off lights in said particular room of said particular resident, during said future time-slot in which the VLM deduced that said particular resident planned to be away; (I6) transferring from the VLM to said HAD the Calendar-Based Resident-Is-Away control message, wherein the HAD of the household is pre-configured to selectively turn off lights in one or rooms of the household in response to VLM-generated messages that indicate that the VLM deduced that a particular resident plans to be away.

The system enhances its energy optimization capabilities by incorporating advanced calendar and scheduling data analysis to predict and act upon future absences of household residents. At its core, the system employs a Scheduling Data Extraction Module, which interfaces with calendar applications and scheduling tools on resident devices to retrieve detailed information about upcoming events, appointments, or commitments. This module extracts key data points, including event times, durations, and locations, which are then processed by the Vision-and-Language Model. The Vision-and-Language Model analyzes this data to estimate when specific residents are likely to be away from the household during a forward-looking window of up to seven days.

Once the Vision-and-Language Model identifies potential absence periods, it cross-references this information with video data analyzed by the Resident Mapping Unit. This unit processes live and previously recorded video streams from household cameras to establish a comprehensive map of resident activity patterns. Using these patterns, the system determines which rooms are predominantly occupied by the residents scheduled to be absent. For example, the Resident Mapping Unit may identify that a particular resident frequently uses a home office or a specific bedroom, designating these spaces as targets for energy-saving actions during the predicted absence period.

The Proposal Generation Engine synthesizes the outputs of the Scheduling Data Extraction Module and the Resident Mapping Unit to produce a Calendar-Based Resident-Is-Away control message. This control message includes detailed instructions for modifying the operational states of energy-consuming devices in the identified rooms. For instance, the control message may specify turning off lights, deactivating ceiling fans, or placing certain appliances in energy-saving modes during the forecasted absence period. The Proposal Generation Engine ensures that the instructions are tailored to the specific timing and duration of the absence, minimizing unnecessary energy use while maintaining readiness for when the resident returns.

The system relies on the Home Automation Controller to execute the control message. This controller interfaces directly with smart devices in the household, such as lighting systems, HVAC units, and smart plugs. Upon receiving the control message, the Home Automation Controller transmits the necessary commands to the targeted devices. For example, if the absence period begins at 10 AM, the controller ensures that all devices in the designated rooms are deactivated or adjusted accordingly at that time. The Home Automation Controller also manages the reactivation of these devices at the end of the absence period to ensure the household returns to its normal operational state without resident intervention.

To validate the successful implementation of the control message, the system incorporates a Device State Verification Module. This module monitors feedback from the targeted devices to confirm their updated states. For example, it checks whether lights in a specific room have been turned off as instructed or whether appliances have transitioned to energy-saving modes. If discrepancies are detected, the Device State Verification Module triggers corrective actions, such as re-sending the commands or alerting the system to investigate potential execution failures.

An innovative feature of the system is its Temporal Adjustment Engine, which dynamically modifies the control message based on real-time changes to resident schedules. For instance, if a calendar update indicates that an absence has been canceled or rescheduled, the Temporal Adjustment Engine updates the control message to reflect the revised timing. This real-time adaptability ensures that energy-saving measures are applied only when necessary, preventing disruptions to resident comfort or convenience.

The system also includes a Notification Interface Module to keep residents informed about the planned energy-saving actions. Once the control message is generated, the Notification Interface Module formats it into a user-friendly message that is sent to household residents via email or instant messaging. This message details the scheduled energy adjustments, the rationale behind them, and their expected impact on energy savings. Residents are given the option to review and approve the plan, providing an additional layer of control and customization.

To enhance its predictive accuracy, the system employs a Behavioral Analysis Component that refines the Vision-and-Language Model's understanding of resident activity patterns. This component uses historical data on resident schedules and energy usage trends to improve the mapping of specific rooms to individual residents. For example, it might learn that a particular resident frequently transitions between two rooms during specific times of the day, ensuring that energy-saving measures account for this behavior.

The Feedback Integration Module allows residents to provide input on the effectiveness and convenience of the implemented energy-saving measures. This feedback is analyzed to refine the system's algorithms, ensuring continuous improvement in its recommendations and execution strategies. Additionally, the module tracks the energy savings achieved during past implementations of Calendar-Based Resident-Is-Away control messages, enabling the system to quantify its impact and identify areas for optimization.

The modular architecture of the system ensures that it can be seamlessly integrated into diverse household configurations, regardless of the type and number of smart devices present. For example, in homes with limited automation, the system can provide detailed recommendations for manual implementation, while in fully automated homes, it directly executes all energy-saving measures. This flexibility makes the system suitable for a wide range of users, enhancing its practicality and accessibility.

The system provides a robust and automated solution for predicting resident absences and implementing tailored energy-saving measures. By leveraging the Scheduling Data Extraction Module, Resident Mapping Unit, Proposal Generation Engine, Home Automation Controller, Device State Verification Module, and Temporal Adjustment Engine, it delivers precise and adaptable energy optimization strategies. Its dynamic adaptability and user-centric design establish it as an innovative tool for reducing household energy consumption while ensuring resident comfort and convenience.

In some embodiments, functionalities or features of the system may be implemented by utilizing the following components:
Calendar Data Integration Unit: Extracts and analyzes scheduling data from residents' calendar and scheduling applications to predict future absences from the household.
Room-Resident Association Module: Identifies and maintains a mapping of each resident to their primary room of activity within the household.
Absence Prediction Engine: Estimates the likelihood of future resident absences and their durations based on integrated scheduling and historical behavior data.
Lighting Adjustment Command Generator: Produces commands to selectively deactivate lighting in rooms associated with absent residents during predicted time slots.
Occupancy Validation Module: Confirms the predicted absence of residents through real-time video analysis before executing lighting adjustments.
Room-Specific Energy Optimizer: Calculates the potential energy savings achievable by deactivating lights and other devices during resident absences.
Proactive Notification System: Alerts residents of predicted lighting adjustments and provides an option to override or confirm the actions.
Post-Action Analysis Component: Evaluates the outcomes of lighting adjustments and integrates findings to enhance future absence predictions and system actions.

In some embodiments, the computerized method comprises: (J1) automatically analyzing, by the VLM, copies of email messages that were sent and received by residents of the household in the past 730 days; and detecting, by the VLM, that a most-recent window insulation service or a most-recent home weatherproofing service was conducted between 365 days ago and 730 days ago (between 1 and 2 years ago); and (J2) automatically generating by the VLM a Service Required Message, indicating to residents of the household that according to VLM-based analysis of information obtained from email inboxes, a window-insulation service or a home weatherproofing service is due to be performed and should be scheduled; (J3) automatically sending from the VLM said Service Required Message, via electronic mail, to all residents of the household; (J4) automatically obtaining by the VLM, from the Internet, contact details of service providers that are located within 25 miles of said household and that provide window-insulation services or home weatherproofing services; (J5) automatically creating by the VLM a plurality of email messages, each email message requesting a price quote from one of said service providers for providing a window-insulation service or a home weatherproofing service to said household; (J6) automatically sending out said plurality of email messages to said service providers, with a digital carbon copy (CC) to all residents of the household, to obtain price quotes for window-insulation services or home weatherproofing services for said household from said service providers.

The system incorporates a sophisticated mechanism for identifying the need for household maintenance services, such as window insulation or home weatherproofing, based on historical data and automated communication processes. The foundation of this functionality is the Service History Analysis Unit, which utilizes the Vision-and-Language Model to examine email messages sent to and received by household residents within a designated period, such as the past two years. This unit scans for service-related messages, including receipts, confirmations, or invoices, that indicate prior insulation or weatherproofing services. By analyzing these records, the system identifies the timing of the most recent service and determines whether the typical service interval, such as one to two years, has elapsed.

Once the Vision-and-Language Model determines that maintenance is due, it activates the Service Proposal Generator. This component formulates a Service Required Message, which notifies household residents of the need to schedule a new insulation or weatherproofing service. The message includes details of the previous service date and its scope, ensuring that residents are informed of the basis for the recommendation. The Service Proposal Generator ensures that the message is concise, actionable, and tailored to the household's specific needs.

To facilitate the scheduling of the recommended service, the system integrates an Automated Provider Search Module. This module accesses online databases and directories to locate service providers within a configurable radius, such as 25 miles, of the household. The Automated Provider Search Module identifies providers specializing in window insulation or weatherproofing and compiles their contact details, including email addresses and phone numbers. It verifies the suitability of each provider by cross-referencing reviews, certifications, or other quality indicators available online.

The system then employs the Communication Preparation Engine to draft email messages requesting price quotes from the identified service providers. These emails are customized to include relevant details about the household, such as the size of the property or the scope of work required, as inferred from previous service records. The Communication Preparation Engine ensures that each email is appropriately formatted and includes all necessary information to facilitate accurate and timely responses from the providers.

The system's Automated Communication Module sends the prepared emails to the selected service providers. Each email is digitally carbon copied to all household residents, ensuring transparency and enabling residents to track the status of the requests. The Automated Communication Module is designed to manage communication protocols and ensure the successful delivery of all messages. If any emails fail to reach their intended recipients, the module re-sends them or alerts the system to investigate potential delivery issues.

Upon receiving responses from service providers, the system activates the Quote Analysis Component. This component uses the Vision-and-Language Model to analyze the incoming emails, extracting key details such as quoted prices, estimated timelines, and service terms. The Quote Analysis Component compares these details across all received quotes, identifying the most cost-effective and suitable provider based on predefined criteria, such as price, proximity, and quality indicators.

The Recommendation Engine synthesizes the findings of the Quote Analysis Component to generate a Provider Recommendation Message. This message includes a summary of the analyzed quotes, highlighting the selected provider and the rationale for the recommendation. The Recommendation Engine ensures that the message is clear and actionable, enabling household residents to proceed with scheduling the service confidently.

To enhance its functionality, the system incorporates a Scheduling Facilitation Module. This module enables residents to schedule the recommended service directly from the Provider Recommendation Message by integrating links or contact options for the selected provider. For instance, residents may be provided with a pre-filled form or a one-click call option to streamline the booking process. The Scheduling Facilitation Module ensures that the transition from recommendation to action is as seamless as possible.

In addition to addressing the immediate service need, the system includes a Maintenance Tracking Component. This component logs the details of the current service request, including the selected provider, the quoted price, and the scheduled date. The Maintenance Tracking Component updates the household's service history records, ensuring that the system remains informed of the latest maintenance activities. This information is used to refine future recommendations and ensure timely follow-ups.

The modular design of the system allows it to adapt to various household configurations and service requirements. For example, it can be expanded to include additional types of maintenance, such as HVAC servicing or pest control, by updating the Service History Analysis Unit and Automated Provider Search Module with relevant data sets and algorithms. This scalability ensures that the system remains versatile and responsive to the evolving needs of the household.

In operational workflow, the system begins by identifying overdue maintenance services through the Service History Analysis Unit. The Service Proposal Generator notifies residents, and the Automated Provider Search Module locates suitable providers. The Communication Preparation Engine drafts request emails, which are sent by the Automated Communication Module. The Quote Analysis Component evaluates responses, and the Recommendation Engine generates a final provider recommendation. The Scheduling Facilitation Module ensures that residents can act on the recommendation efficiently, while the Maintenance Tracking Component updates the system's records.

The system provides a comprehensive and automated approach to managing household maintenance services. By leveraging components such as the Service History Analysis Unit, Service Proposal Generator, Automated Provider Search Module, Communication Preparation Engine, Quote Analysis Component, and Scheduling Facilitation Module, it streamlines the process of identifying, requesting, and scheduling essential services. Its robust and adaptable design establishes it as a valuable tool for maintaining household efficiency and sustainability.

In some embodiments, functionalities or features of the system may be implemented by utilizing the following components:
Service History Analysis Unit: Analyzes past email communications to identify the dates of prior window insulation or home weatherproofing services conducted for the household.
Service Due Detector: Determines when a new service is needed based on the time elapsed since the last documented insulation or weatherproofing service.
Local Service Locator Module: Searches for nearby service providers within a predefined radius and collects their contact details for inclusion in proposals.
Service Quote Request Generator: Automatically drafts and sends price quote requests to selected service providers, ensuring clear communication of household requirements.
Proposal Compilation Engine: Consolidates received quotes into a Service Required Proposal, comparing options for residents' review and decision-making.
Notification Delivery System: Sends the compiled proposal to residents, including recommendations for selecting a service provider based on cost, proximity, or reviews.
Cost-Benefit Analysis Unit: Calculates the potential energy savings and benefits of performing insulation or weatherproofing services, integrating findings into the proposal.
Service Scheduling Component: Assists residents in scheduling the chosen service provider by integrating with online booking systems or providing contact links.

In some embodiments, the computerized method comprises: (K1) automatically analyzing, by the VLM, copies of email messages that were sent and received by residents of the household in the past 12 months; (K2) detecting by the VLM at least one email message that includes a copy of an electricity bill of said household; (K3) feeding into the VLM, as context, (a) a five-digit zip code in which said household is located, and (b) a list of electricity providers that server each zip code in the United States; (K4) analyzing by the VLM said electricity bill of said household; and determining by the VLM (a) which current electricity provider is currently serving the household, and (b) the electricity rates of that said current electricity provider applies to said household; (K5) further determining by the VLM, which other electricity providers are candidates to replace said electricity provider; (K6) automatically obtaining by the VLM, from the Internet, contact details of said candidate electricity providers; (K7) automatically creating by the VLM a plurality of email messages, each email message requesting an up-to-date price quote from one of said candidate electricity providers for providing electricity to said household; (K8) automatically sending out said plurality of email messages to said candidate electricity providers, with a digital carbon copy (CC) to all residents of the household, to obtain price quotes from said candidate electricity providers for providing electricity to said household; (K9) automatically analyzing by the VLM one or more responses that are received from the candidate electricity providers; automatically comparing by the VLM proposed electricity rates quoted in said one or more responses; detecting by the VLM a particular candidate electricity provider that quoted electricity rates that are lower than rates that are charged currently to said household; generating a Provider Replacement Proposal Message that indicates to residents of the household an identity and contact details of said particular candidate electricity provider and a VLM-generated recommendation to switch electricity service for said household to said particular candidate electricity provider; transmitting said Provider Replacement Proposal Message via electronic mail to email addresses of residents of said household.

The system introduces a highly detailed and automated framework for evaluating household electricity providers and identifying opportunities to switch to a more cost-effective service. Central to this system is the Electricity Bill Analysis Unit, which utilizes the Vision-and-Language Model to extract and process critical information from electricity bills received by household residents over the past year. This includes data points such as the current provider's name, electricity rates, billing cycles, and consumption patterns. The Electricity Bill Analysis Unit uses this information to establish a baseline for the household's energy costs and consumption trends.

To identify potential alternative providers, the system incorporates a Geographic Utility Mapping Module. This module cross-references the household's zip code with a preloaded database containing a comprehensive list of electricity providers serving each region in the United States. By correlating the household's location with the database, the Geographic Utility Mapping Module generates a list of alternative providers that are eligible to serve the household. Each provider's contact details and general rate information are retrieved to facilitate the subsequent comparison and communication processes.

The Vision-and-Language Model plays a critical role in analyzing the household's current electricity rates in relation to the available options. The system examines the rate structure outlined in the electricity bill, including any tiered pricing, peak and off-peak charges, or flat rates. It then compares these rates with those offered by the alternative providers identified by the Geographic Utility Mapping Module. This comparison is conducted by the Rate Comparison Engine, which evaluates potential savings and ranks the providers based on their suitability for the household's energy consumption profile.

To ensure accuracy, the Rate Comparison Engine incorporates a Usage Adjustment Component. This component analyzes the household's historical consumption patterns and adjusts the comparison to reflect anticipated changes, such as seasonal fluctuations or the addition of new energy-consuming devices. For example, if the household's usage spikes in summer due to air conditioning, the Usage Adjustment Component ensures that the comparison accounts for these higher demands when evaluating alternative providers.

Once the Rate Comparison Engine identifies the most promising candidates, the system activates the Communication Preparation Unit. This unit generates a series of customized email messages requesting up-to-date price quotes from the selected providers. Each email includes specific details about the household's energy needs, such as average monthly consumption and any preferences regarding renewable energy options or fixed-rate plans. The Communication Preparation Unit ensures that the messages are tailored to elicit comprehensive responses from the providers, facilitating an accurate and detailed comparison.

The system's Automated Communication Module sends the prepared emails to the identified providers and tracks their responses. Upon receiving replies, the Quote Analysis Component processes the incoming messages using the Vision-and-Language Model. This component extracts key details, such as quoted rates, contract terms, and any additional fees or discounts. It evaluates the providers' offers against the household's baseline costs, identifying the most advantageous option in terms of both pricing and service features.

The findings of the Quote Analysis Component are synthesized by the Recommendation Generation Engine, which produces a Provider Replacement Proposal Message. This message outlines the recommended provider, highlights the anticipated cost savings, and includes a summary of the offer details, such as rate structure, contract duration, and any incentives. The Provider Replacement Proposal Message is designed to be actionable, providing household residents with the information needed to make an informed decision about switching providers.

To streamline the switching process, the system integrates a Transition Facilitation Module. This module provides residents with direct links or contact options to initiate service with the recommended provider. For instance, it may include a pre-filled application form or a one-click call option to expedite enrollment. The Transition Facilitation Module also provides guidance on any steps required to terminate the current service, such as notifying the existing provider or completing final billing arrangements.

The system incorporates a Verification and Monitoring Component to ensure a smooth transition between providers. This component tracks the progress of the switch, verifying that the new provider has successfully activated the household's service and that the previous provider has closed the account without errors. The Verification and Monitoring Component also monitors the first few billing cycles under the new provider to confirm that the anticipated savings are realized and that the service meets the household's expectations.

To maintain its relevance and accuracy, the system includes a Rate Database Update Module. This module periodically refreshes the database of electricity providers and their rate structures to reflect market changes, ensuring that the system's recommendations remain up-to-date. For example, if a new provider enters the market or an existing provider adjusts its rates, the Rate Database Update Module incorporates these changes into the Geographic Utility Mapping Module and Rate Comparison Engine.

In operation, the system begins with the Electricity Bill Analysis Unit extracting data from historical bills. The Geographic Utility Mapping Module identifies alternative providers, and the Rate Comparison Engine evaluates their offerings. The Communication Preparation Unit drafts inquiry emails, which are sent by the Automated Communication Module. The Quote Analysis Component processes responses, and the Recommendation Generation Engine produces a detailed proposal. The Transition Facilitation Module assists with switching providers, while the Verification and Monitoring Component ensures the success of the transition.

This modular and automated approach ensures that the system can handle diverse household configurations and energy needs. It is capable of analyzing complex rate structures, accounting for usage variability, and facilitating seamless transitions between providers. By integrating components such as the Electricity Bill Analysis Unit, Rate Comparison Engine, and Transition Facilitation Module, the system provides a comprehensive solution for reducing household energy costs and improving the efficiency of electricity service management. Its dynamic adaptability and robust functionality establish it as an innovative tool for optimizing household energy procurement.

In some embodiments, functionalities or features of the system may be implemented by utilizing the following components:
Electricity Provider Identification Unit: Analyzes past electricity bills to determine the current electricity provider serving the household and its associated rate structures.
Rate Comparison Module: Compares electricity rates from the current provider with those of alternative providers, identifying cost-saving opportunities based on rate structures and usage patterns.
Alternative Provider Locator: Searches for alternative electricity providers in the household's region, using location data and an integrated database of service coverage by zip code.
Quote Request Generator: Drafts and sends electronic requests to alternative electricity providers to obtain updated pricing information for residential electricity services.
Response Analysis Unit: Processes received quotes from providers, comparing rates, service terms, and additional fees to identify the most cost-effective option.
Provider Switch Proposal Engine: Generates a detailed Provider Replacement Proposal, recommending a switch to the most advantageous electricity provider based on cost and terms.
Proposal Notification System: Communicates the Provider Replacement Proposal to residents, including detailed comparisons and recommendations for action.
Post-Switch Monitoring Module: Tracks electricity usage and billing after switching providers to validate projected savings and refine future recommendations.

In some embodiments, the computerized method comprises: (L1) automatically feeding into the VLM a current zip code of said household; and commanding the VLM to generate a list of all towns that are located within D miles radios of said current zip code of said household, wherein D is in a range of 25 to 100; and (L2) every N minutes, wherein N is in a range of 5 to 10, automatically performing a search of social media platforms, and obtaining copies of fresh posts that comply with the following cumulative search criteria: (a) each post mentions therein by name at least one of said towns that are located within D miles of said household, and also, (b) each post was posted no more than 10 minutes ago, and also, (c) each post mentions therein a pre-defined set of keywords that correspond to electricity power-out and electricity blackout; (L3) continuously feeding into the VLM said copies of fresh posts, and commanding the VLM, once per minute, to evaluate or re-evaluate a VLM-predicted chance that said household will experience an electricity power-out or electricity blackout within 30 minutes; and (L4) if the VLM-predicted that a chance that said household will experience an electricity power-out or electricity blackout within 30 minutes, is greater than 50 percent, then: (a) automatically sending a signal to the HAD of the household to trigger a warm-up session of a gas-based or fuel-based power generator of said household, and also, (b) automatically disconnecting power to smart power-outlets in said household that the VLM determines to be connected to a computing device that can suffer an electrical surge.

The system introduces an advanced framework for real-time monitoring and prediction of electricity outages based on data extracted from social media and other dynamic online sources. At the core of this functionality is the Social Media Monitoring Module, which performs continuous searches across social media platforms to gather fresh posts meeting specific criteria. These criteria include mentions of geographical locations within a configurable radius of the household, recent timestamps (such as posts created within the last ten minutes), and keywords associated with power outages or blackouts. The Social Media Monitoring Module retrieves and formats this data into a structured input that can be processed by the Vision-and-Language Model.

The Vision-and-Language Model analyzes these social media posts to assess the likelihood of an impending power outage at the household. This analysis is managed by the Outage Prediction Engine, which combines textual data from social media with additional context, such as the household's zip code and proximity to referenced areas. The Outage Prediction Engine uses natural language processing capabilities of the Vision-and-Language Model to identify patterns, such as clusters of outage reports in nearby towns, that increase the probability of the household being affected. By aggregating and weighing these patterns, the Outage Prediction Engine generates a real-time probability score indicating the likelihood of an outage within a predefined timeframe, such as the next 30 minutes.

When the probability score exceeds a threshold value, such as 50 percent, the system activates the Preventative Action Module. This module initiates preemptive measures to minimize disruption and protect household devices from potential power surges. One such measure involves the Generator Activation Component, which sends a command to the household's gas- or fuel-based power generator to perform a warm-up session. This ensures that the generator is operational and ready to supply electricity immediately if an outage occurs. The Preventative Action Module also interfaces with the Smart Outlet Control Unit to deactivate specific power outlets connected to sensitive computing devices. By proactively disconnecting these devices, the system mitigates the risk of damage caused by electrical surges during an outage or restoration of power.

The Outage Notification Unit communicates these preemptive actions to household residents. It generates detailed messages outlining the predicted likelihood of an outage, the actions being taken, and any additional steps residents should consider, such as conserving battery power or avoiding unnecessary use of electronic devices. These notifications are distributed via email, instant messaging, or other digital communication channels, ensuring that residents are informed in real-time about the situation and the measures being implemented.

The system includes a Feedback Integration Component that monitors the outcomes of its predictions and actions. If a predicted outage does not materialize, the Feedback Integration Component uses this information to adjust the prediction algorithms and refine the threshold for triggering preemptive measures. This iterative learning process, powered by the Vision-and-Language Model, enhances the system's accuracy over time, reducing the occurrence of false alarms while maintaining a high level of preparedness for actual outages.

The modular design of the system allows for scalability and adaptability across different household configurations. For instance, in households with advanced smart home infrastructure, the Preventative Action Module can interface directly with additional devices, such as smart thermostats or solar power systems, to implement more comprehensive energy management strategies during outage predictions. Similarly, in regions with frequent power disruptions, the Social Media Monitoring Module can be configured to prioritize data sources and keywords most relevant to local outage patterns, enhancing its responsiveness and reliability.

The operational workflow of the system begins with the Social Media Monitoring Module continuously gathering and filtering posts. These posts are analyzed by the Vision-and-Language Model within the Outage Prediction Engine, which calculates the likelihood of a nearby outage. If the probability exceeds the defined threshold, the Preventative Action Module executes preemptive measures, such as activating the generator and deactivating vulnerable devices. Simultaneously, the Outage Notification Unit informs residents, and the Feedback Integration Component tracks the outcomes to refine future predictions and actions.

The system also integrates an External Data Aggregation Module that supplements social media data with additional real-time information, such as reports from utility companies, weather alerts, and updates from local news outlets. By incorporating these additional data streams, the External Data Aggregation Module enhances the robustness of the Outage Prediction Engine, ensuring that predictions are based on a comprehensive understanding of the surrounding environment. For example, if utility company reports indicate ongoing maintenance in nearby neighborhoods, this information can corroborate social media posts and strengthen the prediction of an outage.

To ensure compatibility with various household power configurations, the Generator Activation Component is designed to interface with a wide range of generator models and control systems. This includes both manually operated and fully automated generators. The Smart Outlet Control Unit is similarly adaptable, capable of managing outlets connected to diverse devices, from desktop computers to home entertainment systems. These features ensure that the system remains versatile and effective across a variety of household setups.

The system provides a comprehensive and proactive approach to managing the risks and impacts of electricity outages. By integrating components such as the Social Media Monitoring Module, Outage Prediction Engine, Preventative Action Module, Outage Notification Unit, Feedback Integration Component, and External Data Aggregation Module, it offers a robust solution for predicting outages and implementing preventative measures. Its ability to dynamically adapt to local conditions and continuously improve through feedback establishes it as an innovative tool for enhancing household resilience and energy management.

In some embodiments, functionalities or features of the system may be implemented by utilizing the following components:
Geographic Region Analysis Unit: Determines towns and locations within a specified radius of the household for monitoring local electricity outage events.
Social Media Search Module: Continuously searches social media platforms for posts related to electricity outages in the identified geographic region.
Outage Prediction Engine: Analyzes the likelihood of a local electricity outage based on patterns and frequency of recent reports in the region.
Power Backup Activation Unit: Automatically sends signals to initiate the warm-up of backup power generators when an outage is predicted.
Surge Protection Interface: Deactivates connected smart power outlets to protect sensitive electronics from potential power surges during outages.
Regional Alert Integration System: Incorporates regional utility outage notifications into the outage prediction process for enhanced accuracy.
Emergency Lighting Management Module: Activates energy-efficient lighting systems in critical household areas during outage events to maintain visibility and safety.
Post-Outage Analysis Unit: Evaluates the performance of predictive actions and refines outage detection algorithms based on event outcomes.

In some embodiments, the computerized method comprises: (M1) automatically feeding into the VLM video frames extracted from video cameras that capture live video from rooms in the household; (M2) automatically commanding the VLM to generate a Light-Fixture Replacement Proposal to replace a particular non-LED light bulb in a particular room with an energy-efficient LED-based light bulb, based on VLM analysis that analyzes in combination: (a) lighting conditions in various regions of each room, and (b) occupation or non-occupation of various regions of each room by one or more residents; (M3) exemplifying to the VLM that (a) a corner region in a pantry room that is occupied by a human less than 5 minutes per day is not a good candidate for replacing non-LED light bulbs with energy-efficient LED-based light bulb, and that (b) a central region in a kitchen that has human presence for at least 120 minutes between noon and midnight is a good candidate for replacing non-LED light bulbs with energy-efficient LED-based light bulb; (M4) automatically transferring the VLM-generated Light-Fixture Replacement Proposal to the residents of the household via electronic mail.

The system introduces a specialized framework for identifying and addressing energy inefficiencies related to outdated or non-energy-efficient lighting fixtures within a household. At the core of this functionality is the Visual Data Processing Unit, which continuously receives live video streams from cameras installed in various rooms of the household. The Visual Data Processing Unit utilizes the Vision-and-Language Model to analyze these video streams, extracting key details about the lighting conditions, the types of light fixtures in use, and their locations within the rooms. This analysis includes recognizing specific types of bulbs, such as incandescent or compact fluorescent bulbs, and distinguishing them from energy-efficient LED bulbs based on their visual characteristics, including shape, color temperature, and emitted light patterns.

The Vision-and-Language Model integrates these visual insights with contextual data provided by the Room Usage Analysis Module. This module evaluates the occupancy patterns and activity levels in different areas of each room to determine the practical importance of lighting in those spaces. For example, a pantry corner with minimal human activity may not warrant an immediate upgrade to energy-efficient lighting, while the central area of a kitchen that is occupied for extended periods during peak hours would be prioritized for such improvements. The Room Usage Analysis Module provides a comprehensive map of energy consumption associated with lighting, highlighting areas with the highest potential for efficiency gains.

The Lighting Efficiency Assessment Engine synthesizes the outputs of the Visual Data Processing Unit and the Room Usage Analysis Module to evaluate the energy-saving potential of replacing specific light fixtures. This engine considers factors such as the daily usage duration of each fixture, the current energy consumption of the installed bulb, and the expected savings from switching to an LED bulb. The engine applies established efficiency metrics, such as lumens per watt, to calculate the anticipated reduction in energy usage for each proposed replacement. It also incorporates long-term cost-benefit analyses, estimating the financial savings over the lifespan of the replacement bulb compared to the existing one.

To ensure the recommendations are actionable, the system employs a Proposal Generation Module to create a detailed Light-Fixture Replacement Proposal. This proposal includes a prioritized list of lighting fixtures identified for replacement, the specific types of LED bulbs recommended for each fixture, and the rationale for their selection. The proposal also provides an estimate of the overall energy savings and cost reductions that can be achieved by implementing the suggested changes. For example, it may specify that replacing a high-wattage incandescent bulb in a frequently used living room fixture with an equivalent LED bulb could reduce energy consumption by 80 percent while providing the same level of brightness.

The system leverages a Communication Interface Module to deliver the Light-Fixture Replacement Proposal to household residents. The Communication Interface Module formats the proposal into a visually intuitive report, complete with charts and diagrams illustrating the energy and cost savings associated with each recommendation. This report is sent to residents via email or instant messaging, ensuring that it is easily accessible and actionable. The Communication Interface Module also includes interactive features, such as direct links to online retailers or local stores where the recommended LED bulbs can be purchased, simplifying the implementation process.

The system incorporates an Exemplification Engine to enhance the clarity and effectiveness of its recommendations. This engine provides illustrative examples to demonstrate the practical benefits of replacing inefficient light fixtures. For instance, it might highlight that upgrading a kitchen's overhead lighting to LED bulbs not only reduces energy costs but also improves illumination quality, thereby enhancing the functionality and comfort of the space. These examples are tailored to the household's specific conditions and are included in the Light-Fixture Replacement Proposal.

To track and validate the outcomes of its recommendations, the system integrates a Feedback Monitoring Unit. This unit monitors the household's overall energy consumption after the implementation of the proposed replacements, comparing it to baseline data collected before the changes were made. The Feedback Monitoring Unit also gathers input from residents regarding their satisfaction with the new lighting fixtures, providing valuable insights for refining future proposals.

The system's modular architecture allows it to adapt to a wide range of household configurations and lighting scenarios. For example, in households with advanced smart home systems, the Lighting Efficiency Assessment Engine can interface with smart lighting controllers to automate the transition to energy-efficient settings. In simpler setups, the system focuses on providing clear and actionable guidance for manual replacements. This flexibility ensures that the system remains effective and relevant across diverse user environments.

The operational workflow of the system begins with the Visual Data Processing Unit identifying non-energy-efficient lighting fixtures through video analysis. The Room Usage Analysis Module maps these fixtures to specific occupancy patterns and activity levels, while the Lighting Efficiency Assessment Engine calculates the potential benefits of replacing them. The Proposal Generation Module creates a detailed replacement plan, which is delivered to residents through the Communication Interface Module. The Exemplification Engine enhances the recommendations with practical examples, and the Feedback Monitoring Unit tracks the results to inform future optimizations.

The system provides a robust and automated approach to optimizing household lighting efficiency. By integrating components such as the Visual Data Processing Unit, Room Usage Analysis Module, Lighting Efficiency Assessment Engine, Proposal Generation Module, Communication Interface Module, and Feedback Monitoring Unit, it delivers precise and actionable recommendations for replacing outdated light fixtures. Its ability to adapt to varying household configurations and provide clear, data-driven insights establishes it as an innovative tool for reducing energy consumption and promoting sustainability in residential environments.

In some embodiments, functionalities or features of the system may be implemented by utilizing the following components:
Lighting Fixture Analysis Unit: Analyzes the household's current lighting setup to identify non-LED light bulbs that can be replaced with energy-efficient LED alternatives.
Room Usage Mapping Module: Maps each room's lighting needs based on occupancy patterns and activity levels to prioritize replacements.
Energy Efficiency Calculator: Estimates energy savings and cost reductions achievable through replacing inefficient light bulbs with LED alternatives.
Illumination Simulation Engine: Simulates lighting conditions for proposed replacements, ensuring sufficient coverage and brightness in high-usage areas.
Replacement Proposal Generator: Creates a detailed Light-Fixture Replacement Proposal, specifying bulbs to be replaced, suggested replacements, and expected benefits.
Notification Delivery System: Sends the replacement proposal to household residents via digital channels, including clear visual diagrams for implementation.
Lighting Feedback Monitoring Module: Tracks changes in energy usage after replacements to validate the effectiveness of proposed lighting adjustments.
Learning and Adaptation Component: Refines lighting recommendations by incorporating feedback on implemented changes and observed improvements.

In some embodiments, the computerized method comprises: (N1) automatically analyzing, by the VLM, copies of email messages and instant messages that were sent and received by residents of the household in the past 30 days; (N2) automatically detecting, by the VLM, at least one message in which a resident of the household conveys a plan to purchase a particular electric appliance of a particular make-and-model; (N3) obtaining by the VLM, from the Internet and from a general body-of-knowledge on which the VLM was trained, data about an Equivalent Appliance that is functionally equivalent to said particular electric appliance; wherein the VLM is prompted to select said Equivalent Appliance that has an energy efficiency level that is greater than an energy efficiency level of said particular electric appliance; and wherein the VLM is further prompted to select said Equivalent Appliance that has a price that is not more than 25 percent greater than a price of said particular electric appliance; (N4) automatically generating by the VLM an Alternate Purchase Proposal in which the VLM proposes to purchase said Equivalent Appliance instead of purchasing the particular electric appliance that said resident of the household plans to purchase; (N5) automatically transferring the VLM-generated Alternate Purchase Proposal via electronic mail to residents of said household.

The system focuses on identifying opportunities to recommend more energy-efficient alternatives for appliances that household residents are considering purchasing. This process begins with the implementation of a Communication Analysis Module, which continuously monitors email messages and instant messages exchanged by residents. The module uses the Vision-and-Language Model to identify references to planned appliance purchases, such as confirmations of online searches, retailer promotions, or exchanges discussing specific makes and models of appliances. The Communication Analysis Module extracts details of the appliance under consideration, including its brand, model number, and technical specifications.

Once the system identifies a planned purchase, it activates the Equivalent Appliance Evaluation Engine. This engine retrieves data about the specified appliance and searches for functionally equivalent alternatives with superior energy efficiency. Using the Vision-and-Language Model, the Equivalent Appliance Evaluation Engine analyzes extensive online databases, including manufacturer specifications, energy rating labels, and customer reviews. The engine ensures that the recommended alternative matches the original appliance in key functional aspects, such as capacity, performance, and features, while also having an energy efficiency rating that exceeds that of the original. Additionally, the Equivalent Appliance Evaluation Engine imposes a price constraint, ensuring that the recommended alternative costs no more than 25 percent above the price of the original appliance to maintain affordability.

The Energy Efficiency Analysis Unit plays a critical role in assessing the energy performance of both the original and alternative appliances. This unit applies standardized metrics, such as kilowatt-hour consumption per operational cycle or year, to calculate the comparative energy savings of the alternative appliance. The Energy Efficiency Analysis Unit also incorporates usage scenarios based on household patterns to estimate real-world energy savings. For example, if the appliance in question is a washing machine, the unit evaluates its energy consumption under typical household load conditions, factoring in expected usage frequency.

The Proposal Generation Module consolidates the findings from the Equivalent Appliance Evaluation Engine and the Energy Efficiency Analysis Unit to create an Alternate Purchase Proposal. This proposal provides household residents with a detailed comparison of the original appliance and the recommended alternative, highlighting the superior energy efficiency and the potential cost savings over the alternative's lifespan. The proposal also includes a breakdown of functional similarities and any minor differences, ensuring that residents are fully informed about the trade-offs involved.

To deliver the proposal, the system employs the Communication Interface Module, which formats the Alternate Purchase Proposal into a user-friendly document. This document is sent to residents via email or instant messaging, ensuring accessibility and ease of review. The Communication Interface Module also includes actionable links to online retailers or local stores where the alternative appliance can be purchased. These links provide options for residents to compare prices, check availability, or place orders directly, streamlining the decision-making process.

The Exemplification Engine enhances the proposal by including illustrative scenarios that demonstrate the practical benefits of the recommended alternative. For instance, it may present a case study showing how switching to an energy-efficient refrigerator reduces electricity bills while maintaining optimal cooling performance. These examples are tailored to the specific appliance type and the household's energy consumption context, making the proposal more relatable and convincing.

To validate its recommendations, the system incorporates a Feedback Integration Component. This component tracks the outcomes of previous Alternate Purchase Proposals, collecting data on whether residents followed the recommendations and, if so, the resulting energy savings. This feedback is analyzed to refine the Equivalent Appliance Evaluation Engine and the Energy Efficiency Analysis Unit, improving the accuracy and relevance of future recommendations.

The system's modular architecture allows it to adapt to a wide range of household purchasing scenarios. For example, in households with smart home systems, the system can integrate with shopping assistant tools or virtual assistants to identify planned purchases more efficiently. In simpler setups, the Communication Analysis Module relies solely on textual data to detect potential purchases. This flexibility ensures that the system remains effective in diverse user environments.

In operation, the system begins with the Communication Analysis Module identifying a planned appliance purchase. The Equivalent Appliance Evaluation Engine identifies suitable alternatives, while the Energy Efficiency Analysis Unit calculates the potential savings. The Proposal Generation Module creates a detailed Alternate Purchase Proposal, which is delivered to residents through the Communication Interface Module. The Exemplification Engine enhances the proposal with practical examples, and the Feedback Integration Component tracks the outcomes to inform future optimizations.

The system also integrates a Price Monitoring Unit to ensure that the recommended alternative remains within the defined affordability constraints. This unit continuously tracks market prices for the recommended appliance and updates the proposal if a more cost-effective alternative becomes available. The Price Monitoring Unit ensures that residents always receive the most competitive and viable options.

The system provides a comprehensive and automated solution for guiding household residents toward energy-efficient appliance purchases. By integrating components such as the Communication Analysis Module, Equivalent Appliance Evaluation Engine, Energy Efficiency Analysis Unit, Proposal Generation Module, Communication Interface Module, and Feedback Integration Component, it delivers precise and actionable recommendations. Its ability to adapt to diverse household configurations and purchasing behaviors establishes it as an innovative tool for promoting energy efficiency and sustainability in consumer choices.

In some embodiments, functionalities or features of the system may be implemented by utilizing the following components:
Purchase Monitoring Unit: Analyzes household email and messaging platforms to detect planned appliance purchases and extract details about the make and model.
Energy Efficiency Comparison Module: Compares the energy performance of the planned appliance with functionally equivalent models that are more efficient.
Alternative Appliance Locator: Searches for and identifies equivalent appliances with better energy efficiency and within a specified price range.
Energy Saving Analysis Unit: Calculates the potential energy and cost savings of using a recommended alternative appliance over the originally planned one.
Proposal Generation System: Develops an Alternate Purchase Proposal with detailed comparisons, including energy savings and cost differences.
Notification Delivery Interface: Sends the proposal to residents with links to purchase recommended alternatives or additional information on the suggested appliance.
Feedback Integration Module: Tracks whether recommended alternatives were purchased and evaluates the energy savings achieved compared to the planned appliance.
Database Updating Component: Updates the system's knowledge base with performance data for new appliances to improve future recommendations.

In some embodiments, the computerized method comprises: (P1) automatically f5eeding into the VLM video frames extracted from video cameras that capture live video from rooms in the household; (P2) automatically commanding the VLM to analyze furniture locations and to generate a Furniture Rearrangement Proposal that the VLM predicts would increase energy efficiency in the household and improve airflow in the household; (P3) exemplifying to the VLM that (a) a sofa that is located such that it partially blocks an outlet of an air conditioner unit is a good candidate for furniture rearrangement by proposing to move the sofa to another location in which the sofa would not block at all the outlet of the air conditioner unit, and that (b) a portable air heating device that generates hot air and that is facing towards a wall is a good candidate for furniture rearrangement by turning the portable air heating device to face away from the wall and to face towards an open region of a room; (P4) automatically transferring the Furniture Rearrangement Proposal that was generated by the VLM to residents of the household via electronic mail.

The system is a sophisticated solution designed to evaluate the spatial arrangement of furniture within a household and generate proposals for rearrangement to optimize energy efficiency and airflow. Central to this system is the Video Stream Analysis Module, which processes continuous live video feeds from cameras positioned in various rooms of the household. This module uses the Vision-and-Language Model to extract and analyze visual data about the placement, orientation, and types of furniture present in each room. The analysis includes identifying furniture that interacts directly with air circulation patterns, such as sofas, tables, and portable heating devices, and detecting features that may obstruct or enhance airflow from HVAC systems or other climate control devices.

The Vision-and-Language Model collaborates with the Airflow Mapping Component to assess the interaction between furniture placement and the household's climate control systems. This component performs modeling or emulating or simulating of airflow patterns within each room, considering the positioning of vents, windows, and portable air circulation devices. For example, the Airflow Mapping Component evaluates whether a sofa partially blocks the outlet of an air conditioner or whether a portable heater faces a wall, limiting the effective distribution of warm air. These airflow analyses are supplemented with environmental data from room sensors, such as temperature and humidity readings, to provide a comprehensive understanding of the room's climate dynamics.

The Energy Optimization Analysis Unit integrates the outputs of the Video Stream Analysis Module and the Airflow Mapping Component to identify furniture arrangements that contribute to energy inefficiencies. This unit calculates the impact of current arrangements on heating, cooling, and air circulation and predicts the potential energy savings achievable through proposed rearrangements. For instance, if a piece of furniture obstructs the airflow from an air conditioning vent, the system determines how relocating the furniture to a more open position could enhance airflow efficiency and reduce the workload on the climate control system.

To formulate actionable recommendations, the Proposal Generation Module synthesizes the findings into a Furniture Rearrangement Proposal. This proposal details specific adjustments to the furniture layout, including the precise repositioning of items, the rationale behind each recommendation, and the expected benefits in terms of energy efficiency and improved comfort. For example, the proposal might suggest moving a sofa away from an air conditioning vent and repositioning a table to allow unrestricted airflow, explaining how these changes optimize cooling performance during peak summer months.

The Communication Interface Module delivers the Furniture Rearrangement Proposal to household residents in an accessible and actionable format. The proposal is presented as a detailed report, including diagrams or visual representations of the current and proposed furniture layouts. This visual aid helps residents understand the recommendations and visualize the changes within their living spaces. The Communication Interface Module also includes links to additional resources, such as guides or tutorials, to assist residents in implementing the proposed adjustments.

The system incorporates an Exemplification Engine to enhance the clarity and relevance of its recommendations. This engine provides illustrative examples that demonstrate the tangible benefits of rearranging furniture for energy efficiency. For instance, it may include scenarios showing how removing obstructions from HVAC vents reduces energy consumption and improves overall air quality in a room. These examples are tailored to the specific layout and conditions of the household, making the proposals more compelling and actionable.

To validate the effectiveness of its recommendations, the system integrates a Feedback Monitoring Unit. This unit tracks the household's energy consumption and climate control performance after implementing the proposed rearrangements, comparing these metrics to baseline data collected before the changes. The Feedback Monitoring Unit also gathers resident input on the comfort and functionality of the new layout, providing qualitative and quantitative data to refine future recommendations.

The system's modular architecture allows for scalability and adaptability across diverse household configurations. For example, in homes equipped with smart furniture or sensors, the system can interface directly with these devices to gather real-time data on usage patterns and environmental conditions. In more traditional setups, the system relies solely on visual data from the Video Stream Analysis Module and static environmental data. This flexibility ensures that the system remains effective and relevant across a wide range of user environments.

The operational workflow of the system begins with the Video Stream Analysis Module identifying furniture placement and the Airflow Mapping Component evaluating its interaction with air circulation. The Energy Optimization Analysis Unit integrates these findings to assess inefficiencies and calculate potential improvements. The Proposal Generation Module creates a detailed Furniture Rearrangement Proposal, which is delivered to residents through the Communication Interface Module. The Exemplification Engine enhances the proposal with practical examples, and the Feedback Monitoring Unit tracks outcomes to inform future optimizations.

The system also includes an Adjustment Validation Component, which ensures that the proposed rearrangements are practical and feasible within the constraints of the household. This component considers factors such as the dimensions of the room, the mobility of furniture, and the functional requirements of the space to ensure that the recommendations are both effective and realistic. For example, it avoids proposing adjustments that would significantly disrupt the usability of the room or create clutter.

The system provides a comprehensive and automated approach to optimizing furniture arrangements for improved energy efficiency and airflow. By integrating components such as the Video Stream Analysis Module, Airflow Mapping Component, Energy Optimization Analysis Unit, Proposal Generation Module, Communication Interface Module, and Feedback Monitoring Unit, it delivers precise and actionable recommendations. Its ability to adapt to varying household configurations and provide data-driven insights establishes it as an innovative tool for enhancing residential energy efficiency and comfort.

In some embodiments, functionalities or features of the system may be implemented by utilizing the following components:
Furniture Layout Analysis Unit: Evaluates the current arrangement of furniture within the household and its impact on energy efficiency and airflow.
Airflow Mapping Module: Analyzes air circulation patterns, identifying furniture obstructions that hinder efficient heating or cooling.
Rearrangement Optimization Engine: Recommends furniture rearrangements to enhance airflow and improve the performance of climate control systems.
Simulation and Validation Tool: Simulates the impact of proposed rearrangements on airflow and energy consumption to validate effectiveness before implementation.
Proposal Delivery Interface: Generates a detailed Furniture Rearrangement Proposal, including diagrams and expected energy savings, for communication to residents.
Implementation Assistance System: Provides step-by-step guidance for residents to execute the recommended rearrangements, ensuring ease of implementation.
Post-Rearrangement Monitoring Unit: Tracks changes in airflow and energy efficiency after rearrangements to assess improvements and refine future recommendations.
Continuous Learning Module: Updates the system's algorithms with data from rearrangement outcomes, improving the accuracy and practicality of future proposals.

In some embodiments, the computerized method comprises: (Q1) automatically feeding into the VLM video frames extracted from video cameras that capture live video from rooms in the household; (Q2) automatically commanding the VLM to analyze behavior of household pets that exhibit interactions with electric appliances; (Q3) automatically commanding the VLM to generate a Pet Interaction Alert if the VLM detects, from analysis of said video frames, that a household pet pushes a button or turns a knob or touches a touch-button of an electric appliance in the household and thus causes said electric appliance to activate and operate when no human is present in a same room of said electric appliance; (Q4) automatically transferring the Pet Interaction Alert from the VLM to residents of the household, via electronic mail or instant messaging, to alert residents of the household that the VLM detected that the household pet interacted with said electric appliance; (Q5) if said electric appliance is a smart appliance that can be remotely deactivated by a HAD of the household, then: sending from the VLM to the HAD a message indicating to the HAD to remotely deactivate said electric appliance, upon detection by the VLM that the household pet interacted with said electric appliance; wherein the step of commanding the VLM further comprises: exemplifying to the VLM to specifically search, in said video frames, for jumps of a dog or a cat towards knobs of an oven; and exemplifying to the VLM to specifically search, in said video frames, for stepping by a dog or a cat on one or more mechanical buttons or keyboard keys of a computer and thus causing the computer to activate.

The system introduces a specialized framework for monitoring and managing the interactions between household pets and electronic appliances to prevent unintended activations that could lead to energy inefficiencies or safety hazards. At the core of the system is the Video Analysis Module, which continuously processes video streams captured by cameras in various rooms of the household. This module uses the Vision-and-Language Model to analyze the behavior of pets, specifically identifying instances where they come into contact with electronic appliances. The analysis includes detecting physical actions such as jumping, stepping, or pushing that may trigger an appliance to turn on or operate without human intervention.

The Vision-and-Language Model collaborates with the Pet Behavior Recognition Component to identify patterns of interaction between pets and appliances. This component is pre-trained to recognize common pet behaviors that can influence electronic devices, such as a cat stepping on a keyboard, a dog nudging an oven knob, or a pet inadvertently pressing touch-sensitive controls on a smart appliance. The Pet Behavior Recognition Component integrates this behavioral analysis with spatial data, mapping the pet's movements relative to the locations of appliances. For instance, it identifies when a pet is repeatedly near an appliance's control panel, indicating a high likelihood of interaction.

When the Vision-and-Language Model detects an interaction between a pet and an appliance, the system activates the Appliance Interaction Analysis Module. This module evaluates the specific appliance involved and determines whether the interaction has caused it to turn on or alter its settings. For example, the module inspects visual indicators such as control lights, knob positions, or digital display changes to verify the appliance's operational state. It also considers secondary effects, such as detecting airflow from a heater or the sound of a running motor, to confirm activation.

If an unintended activation is confirmed, the system triggers the Pet Interaction Alert Generator. This component formulates a detailed alert message for the household residents, specifying the appliance involved, the nature of the pet's interaction, and the action taken by the system. For example, the alert might state that a dog stepped on the button of a washing machine, turning it on, and that the system has initiated a corrective measure. The alert is sent to residents through multiple communication channels, such as email or instant messaging, ensuring timely notification.

The system includes a Smart Appliance Control Unit to implement immediate corrective actions for appliances that support remote deactivation. When the Appliance Interaction Analysis Module confirms an unintended activation, the Smart Appliance Control Unit sends a deactivation command to the appliance via the home automation network. This ensures that the appliance returns to its inactive state, preventing unnecessary energy consumption or potential safety risks. For appliances without smart capabilities, the system logs the incident and includes it in the alert message to prompt manual intervention by the residents.

An Exemplification Engine is integrated into the system to guide the Vision-and-Language Model in detecting specific scenarios with higher accuracy. This engine provides examples of common situations, such as a dog jumping towards an oven knob or a cat climbing onto a counter with touch-sensitive appliances. By refining the model's detection capabilities, the Exemplification Engine ensures that the system can distinguish between harmless proximity and actual interactions that require intervention.

The system incorporates a Feedback Integration Component to learn from its operations and improve its effectiveness over time. This component tracks the outcomes of each detected interaction, analyzing whether the system's response successfully prevented further unintended activations. For instance, if a pet is found repeatedly interacting with the same appliance, the Feedback Integration Component prompts the Vision-and-Language Model to prioritize similar scenarios in future analyses. The component also gathers input from residents, allowing them to provide feedback on the system's alerts and actions.

To enhance its adaptability, the system includes a Behavioral Prediction Module that anticipates potential interactions based on historical data. This module analyzes patterns in the pet's movements and the timing of previous interactions, identifying periods or locations where interactions are most likely to occur. For example, it might predict that a dog is more likely to approach the oven during meal preparation times, prompting the system to increase its monitoring focus on that area during those periods.

The system's modular architecture allows it to integrate seamlessly with diverse household configurations and appliance types. In households with advanced smart home systems, the Smart Appliance Control Unit can interface directly with appliances to implement corrective actions. In homes without such infrastructure, the system provides detailed alerts and recommendations for manual resolution. This flexibility ensures that the system remains effective across a wide range of environments and user needs.

The operational workflow of the system begins with the Video Analysis Module detecting pet movements and identifying interactions with appliances. The Appliance Interaction Analysis Module evaluates the effects of these interactions, while the Pet Interaction Alert Generator notifies residents and the Smart Appliance Control Unit implements corrective actions as needed. The Exemplification Engine refines detection capabilities, and the Feedback Integration Component tracks outcomes to improve future operations. The Behavioral Prediction Module enhances monitoring by anticipating likely interactions based on historical patterns.

The system provides a robust and automated solution for managing unintended interactions between household pets and electronic appliances. By integrating components such as the Video Analysis Module, Pet Behavior Recognition Component, Appliance Interaction Analysis Module, Pet Interaction Alert Generator, Smart Appliance Control Unit, Exemplification Engine, Feedback Integration Component, and Behavioral Prediction Module, it delivers precise and actionable responses to prevent energy inefficiencies and safety risks. Its ability to adapt to diverse household configurations and learn from user feedback establishes it as a cutting-edge tool for enhancing residential energy management and safety.

In some embodiments, functionalities or features of the system may be implemented by utilizing the following components:
Pet Behavior Recognition Unit: Detects and analyzes interactions between pets and electronic appliances, identifying actions such as pressing buttons or turning knobs that activate devices unintentionally.
Appliance Interaction Detection Module: Confirms whether a pet's interaction has altered an appliance's state, such as turning it on or adjusting its settings, using visual and operational indicators.
Interaction Alert Generator: Creates and sends alerts to household residents, notifying them of detected interactions and the appliances involved, along with suggested preventive actions.
Remote Appliance Control System: Sends commands to deactivate appliances remotely if a pet-triggered interaction is detected, preventing energy waste or potential safety hazards.
Pet Interaction Exemplification Engine: Enhances detection by providing examples of common pet interactions with appliances, such as jumping on oven knobs or stepping on buttons.
Outcome Validation Component: Tracks appliances after corrective actions to ensure the interaction was addressed successfully and no further energy waste occurs.
Resident Notification Module: Provides household members with detailed updates about pet interactions, actions taken, and recommendations for reducing recurrence.
Behavior Prediction Engine: Analyzes historical data to anticipate future pet interactions with appliances and prioritizes monitoring of specific devices.

In some embodiments, the computerized method comprises: (R1) automatically feeding into the VLM video segments or video frames from video cameras that capture live video from rooms in the household; (R2) automatically commanding the VLM to analyze behavior of household pets that exhibit a pet repeatedly and frequently walking at night-time along a non-lit path in the household; (R3) automatically commanding the VLM to generate a Pet Pathway Lighting Proposal, that proposes to place motion-activated energy-efficient LED lights along said non-lit path that the VLM detected as being walked by said pet repeatedly and frequently at nigh-time, to reduce risk of pet injury and to improve wellbeing of the pet; (R4) further commanding the VLM to detect, from analysis of said video segments or video frames, a particular fixed time-slot at night-time in which said pet typically walks along said non-lit path in the household; (R5) sending a lights activation message from said VLM, immediately prior to commencement of said particular fixed time-slot at night-time, to the HAD of the household, wherein the lights activation message instructs the HAD to activate at least one remotely-controlled light fixture in the household that can illuminate at least part of said non-lit path in the household, to reduce risk of pet injury and to improve wellbeing of the pet.

The system introduces a detailed framework for monitoring the habitual movements of household pets at nighttime and implementing lighting solutions to enhance their safety and well-being. At the core of this system is the Video Stream Analysis Module, which continuously processes live video feeds from household cameras positioned in various rooms and corridors. This module employs the Vision-and-Language Model to analyze patterns in pet movements, identifying specific paths frequently traveled by pets during nighttime hours. The analysis includes recognizing repeated behaviors such as walking through dimly lit areas or navigating narrow spaces where visibility may be compromised.

The Vision-and-Language Model collaborates with the Pathway Identification Component to map the pet's nighttime routes. This component tracks the frequency and timing of movements along these paths, generating a detailed spatial and temporal profile of the pet's activities. For example, the Pathway Identification Component may determine that a dog consistently walks from the bedroom to the kitchen between 2 AM and 3 AM. This data is then used to classify sections of the household where improved lighting would reduce the risk of tripping, bumping into obstacles, or experiencing other forms of discomfort.

The Lighting Optimization Engine integrates the outputs of the Video Stream Analysis Module and the Pathway Identification Component to identify specific areas within the household that would benefit from motion-activated lighting. This engine evaluates factors such as the length of the pathway, the existing ambient light levels, and the proximity of furniture or other obstacles. Based on this analysis, it determines the optimal locations for installing energy-efficient LED lighting fixtures, such as along corridor walls, near sharp corners, or above doorways.

To ensure precise recommendations, the system incorporates an Illumination Simulation Module, which models the effects of proposed lighting placements on the pathway. This module simulates various lighting configurations, calculating parameters such as light coverage, intensity, and angle to optimize visibility for the pet without causing unnecessary energy consumption. For instance, the Illumination Simulation Module may determine that a single LED fixture positioned above a staircase provides sufficient lighting for safe navigation while minimizing glare.

The system generates a Pet Pathway Lighting Proposal using its Proposal Generation Module. This proposal includes detailed specifications for the recommended lighting fixtures, their optimal placement, and the expected benefits in terms of safety and energy efficiency. The proposal also specifies the activation mechanism for each fixture, recommending motion sensors that activate the lights when the pet enters the pathway and deactivate them after the pet exits. This ensures that the lighting solution is both effective and energy-efficient, avoiding unnecessary illumination during periods of inactivity.

The Communication Interface Module delivers the Pet Pathway Lighting Proposal to household residents in a clear and actionable format. The proposal is presented as a visual report that includes diagrams of the identified pathways, the recommended lighting placements, and the simulated illumination effects. This visual aid helps residents understand the rationale behind the recommendations and provides guidance on implementing the suggested changes. The Communication Interface Module also includes direct links to purchase the recommended fixtures or hire professional installation services.

The system incorporates a Temporal Prediction Engine to enhance the effectiveness of the lighting recommendations. This engine analyzes the timing of the pet's movements, identifying fixed time slots during which the pathways are most frequently used. For example, if a pet consistently uses the pathway at 3 AM, the Temporal Prediction Engine suggests preemptively activating the lights a few minutes before this time to ensure the pathway is illuminated upon the pet's arrival. This predictive capability adds an additional layer of safety and convenience.

To validate the effectiveness of the implemented lighting solutions, the system includes a Feedback Monitoring Unit. This unit tracks the pet's movements after the installation of the lighting fixtures, monitoring whether the pet avoids previously risky areas or demonstrates increased comfort along the pathways. The Feedback Monitoring Unit also collects input from residents regarding their observations of the pet's behavior and the functionality of the lighting fixtures. This feedback is used to refine the system's recommendations and ensure continuous improvement.

The modular architecture of the system allows for scalability and adaptability across diverse household configurations. In households with advanced smart lighting systems, the Lighting Optimization Engine can interface directly with existing fixtures to implement motion-activated functionality without requiring new installations. In simpler setups, the system provides detailed recommendations for manual installation, ensuring accessibility to a wide range of users. This flexibility makes the system suitable for various household environments and pet types.

The operational workflow begins with the Video Stream Analysis Module identifying frequently traveled pathways and the Pathway Identification Component mapping these routes. The Lighting Optimization Engine integrates this data with the Illumination Simulation Module to develop precise lighting recommendations. The Proposal Generation Module creates a detailed Pet Pathway Lighting Proposal, which is delivered to residents through the Communication Interface Module. The Temporal Prediction Engine enhances the recommendations with timing insights, while the Feedback Monitoring Unit tracks outcomes to inform future improvements.

The system provides a comprehensive and automated approach to improving the nighttime safety and well-being of household pets through optimized lighting solutions. By integrating components such as the Video Stream Analysis Module, Pathway Identification Component, Lighting Optimization Engine, Illumination Simulation Module, Proposal Generation Module, Communication Interface Module, Temporal Prediction Engine, and Feedback Monitoring Unit, it delivers precise and actionable recommendations. Its ability to adapt to varying household configurations and continuously improve through feedback establishes it as an innovative tool for enhancing residential safety and energy efficiency.

In some embodiments, functionalities or features of the system may be implemented by utilizing the following components:
Nighttime Pathway Mapping Unit: Identifies frequently traveled pathways of household pets during nighttime hours using video analysis of repeated movements.
Illumination Need Assessment Module: Evaluates light conditions along identified pathways to determine where motion-activated lighting would improve safety for pets.
Lighting Proposal Generator: Creates a Pet Pathway Lighting Proposal with recommendations for installing energy-efficient lights along frequently traveled paths.
Motion Sensor Integration System: Recommends motion sensors for lighting systems to activate lights when pets approach the pathway and conserve energy when not in use.
Temporal Pattern Analyzer: Identifies fixed time slots for pet movements and recommends preemptive light activation to ensure illumination during these periods.
Light Placement Simulation Engine: Simulates the impact of proposed light placements to optimize coverage and minimize energy usage.
Feedback Monitoring Component: Tracks pet behavior and pathway use after lighting installation to validate the effectiveness of the proposed solution.
Resident Communication Interface: Delivers the lighting proposal and implementation guidance to residents through diagrams and detailed instructions.

In some embodiments, the computerized method comprises: (S1) feeding into the VLM video segments or video frames from video cameras that capture live video from rooms in the household; (S2) commanding the VLM to estimate, based on VLM analysis of LED status lights of electric devices, whether any electric device has been on standby mode for at least 30 minutes; (S3) commanding the VLM to estimate, based on information that the VLM collects from the Internet and based on a body-of-knowledge on which the VLM was trained, whether a particular electric device that has been on standby mode for at least 30 minutes is typically required by users to have instant turn-on or in contrast is typically utilized by users only after a start-up period; (S4) if the VLM estimates that a particular electric device, that has been on standby mode for at least 30 minutes, is typically not required by users to have instant turn-on but rather is typically utilized by users only after a start-up period, then: sending a VLM-generated Mode Switch message from the VLM to the HAD of the household, to trigger the HAD to switch said electric device from stand-by mode to power-off mode in order to conserve electricity in the household without a negative impact to user experience.

The system provides a framework for monitoring electronic devices in standby mode and implementing strategies to conserve energy by transitioning such devices to power-off mode when appropriate. At its core is the Video Stream Analysis Module, which processes live video feeds from cameras positioned in various rooms of the household. This module employs the Vision-and-Language Model to identify and analyze electronic devices within the field of view, detecting specific indicators such as LED status lights, display screens, and power indicators that signify the device is in standby mode. For example, the system can recognize a glowing standby light on a television or the idle screen of a desktop computer.

The Vision-and-Language Model collaborates with the Device State Assessment Unit to determine the duration for which each identified device has remained in standby mode. This unit tracks the operational state of devices over time, recording whether they are actively in use, powered off, or in standby mode. Using thresholds preconfigured in the system, such as a minimum of 30 minutes in standby mode, the Device State Assessment Unit flags devices that are suitable candidates for transitioning to power-off mode to conserve energy.

The system includes an Appliance Usage Analysis Module, which supplements the state assessment by considering typical usage patterns for each device. This module gathers contextual data from the Vision-and-Language Model's training corpus and external knowledge sources, evaluating whether a device in standby mode is likely to be required imminently. For instance, it considers whether a desktop computer is typically used for long sessions at regular intervals or whether a television is frequently turned on for short bursts. Based on this analysis, the module distinguishes between devices that benefit from instant turn-on functionality and those that can be powered off without disrupting user convenience.

The Energy Optimization Decision Engine synthesizes the data from the Device State Assessment Unit and the Appliance Usage Analysis Module to generate a Mode Switch Proposal. This proposal outlines specific devices that should transition from standby to power-off mode, detailing the expected energy savings and the negligible impact on user experience. For example, the system might recommend powering off a printer that has been idle for hours but suggest leaving a television in standby mode if it is regularly used throughout the day. The Mode Switch Proposal is tailored to the household's specific usage patterns, ensuring relevance and practicality.

The system's Execution Interface Module facilitates the implementation of the Mode Switch Proposal. For devices connected to the household's smart home network, the Execution Interface Module sends machine-readable commands to initiate the power-off transition. For instance, it communicates directly with smart power strips, outlet controllers, or integrated device management systems to deactivate the flagged devices. For non-smart devices, the system provides recommendations to household residents through detailed notifications.

These notifications are generated by the Communication Interface Module, which translates the Mode Switch Proposal into a user-friendly report. The report includes a list of devices recommended for power-off, the rationale behind each recommendation, and step-by-step guidance for manually powering off non-smart devices. This ensures that all residents can participate in the energy-saving process, even if the household infrastructure lacks full automation. The notifications are delivered via email, instant messaging, or mobile applications for accessibility.

The system incorporates a Feedback Integration Component to validate the effectiveness of its recommendations. This component tracks the operational state of devices after implementing the Mode Switch Proposal, ensuring that the recommended actions were executed successfully. It also monitors energy consumption data collected from smart meters or device-specific monitors, comparing post-implementation metrics with baseline data to quantify energy savings. If the anticipated savings are not realized, the Feedback Integration Component refines the Energy Optimization Decision Engine's algorithms to improve future proposals.

To enhance its adaptability, the system includes a Device Learning Module that updates its knowledge base with real-time information about newly identified devices or changing usage patterns. For example, if a new appliance is introduced into the household, the Device Learning Module integrates its specifications, operational states, and usage trends into the system. This ensures that the recommendations remain current and effective as the household evolves.

The modular architecture of the system enables seamless integration with diverse household configurations and electronic device types. For instance, in smart homes with advanced automation, the Execution Interface Module can directly manage a wide array of devices, from televisions to kitchen appliances. In households with limited automation, the system focuses on providing actionable guidance for manual implementation. This flexibility ensures that the system remains effective and accessible across a broad spectrum of users.

The operational workflow begins with the Video Stream Analysis Module detecting devices in standby mode. The Device State Assessment Unit tracks their duration in this state, while the Appliance Usage Analysis Module evaluates the likelihood of their immediate use. The Energy Optimization Decision Engine generates a tailored Mode Switch Proposal, which is implemented via the Execution Interface Module for smart devices and communicated to residents for manual action on non-smart devices. The Feedback Integration Component monitors outcomes to validate and refine the system's effectiveness.

The system offers an advanced and automated approach to reducing household energy consumption by transitioning electronic devices from standby to power-off mode when appropriate. By integrating components such as the Video Stream Analysis Module, Device State Assessment Unit, Appliance Usage Analysis Module, Energy Optimization Decision Engine, Execution Interface Module, Communication Interface Module, Feedback Integration Component, and Device Learning Module, it delivers precise and actionable recommendations. Its ability to adapt to varying household configurations and continuously improve through feedback establishes it as a cutting-edge tool for promoting energy efficiency and sustainable living.

In some embodiments, functionalities or features of the system may be implemented by utilizing the following components:
Standby Device Monitoring Unit: Identifies electronic devices in standby mode using visual indicators such as LED lights or screen activity.
Device Usage Pattern Analyzer: Evaluates historical usage data to determine whether devices in standby mode require immediate accessibility or can be safely powered off.
Mode Switch Proposal Engine: Generates recommendations to switch devices from standby to power-off mode when extended inactivity is detected.
Energy Savings Calculator: Estimates potential energy savings from transitioning devices to power-off mode, enhancing the clarity of recommendations.
Command Transmission System: Sends power-off commands to compatible devices or smart power strips, automating energy-saving actions where possible.
Resident Alert Delivery Module: Notifies residents of detected inefficiencies and provides guidance for manually powering off non-smart devices.
Post-Action Impact Assessment Unit: Monitors energy consumption after recommendations are implemented to validate savings and improve future proposals.
Continuous Learning Component: Refines detection and analysis algorithms by incorporating outcomes from implemented power-off recommendations.

In some embodiments, the computerized method comprises: (T1) automatically feeding into the VLM video segments or video frames from video cameras that capture live video from rooms in the household; (T2) automatically commanding the VLM to detect, based on computerized vision analysis and based on information from the Internet and based on a body-of-knowledge on which the VLM was trained, a particular plant in the household that is a Light-Requiring Plant; (T3) automatically commanding the VLM to analyze natural sunlight patterns in a room where the Light-Requiring Plant is located, using live video streams; and commanding the VLM to generate a proposal to move the Light-Requiring Plant closer to a window or away from a window in order to increase sunlight exposure of said Light-Requiring Plant; (T4) automatically commanding the VLM to estimate whether installation of an energy-efficient light fixture, in the room where the Light-Requiring Plant is located, is expected to contribute to growth and wellbeing of the Light-Requiring Plant or in contrast is expected to be redundant; (T5) automatically commanding the VLM to propose a furniture article in said room where the Light-Requiring Plant is located, that the VLM estimates as a furniture article that can accommodate a light-reflecting surface and as a furniture article that is positioned at an orientation that enables said furniture article to reflect light towards said Light-Requiring Plant in order to amplify light available to said Light-Requiring Plant; (T6) automatically commanding the VLM to detect seasonal shifts in sunlight angles based on analysis of video streams from said household, and to propose relocation of said Light-Requiring Plant to maximize exposure to natural light as seasons change; (T7) automatically transferring one or more VLM-generated proposals, with regard to said Light-Requiring Plant or with regard to said furniture article, from the VLM to residents of the household via electronic mail.

The system has an advanced framework designed to optimize the placement and care of light-requiring plants within a household by analyzing their environmental conditions and making recommendations for their positioning relative to natural and artificial light sources. Central to this system is the Video Stream Analysis Module, which processes continuous video feeds from cameras monitoring various rooms of the household. This module uses the Vision-and-Language Model to identify and classify plants based on visual characteristics such as leaf shape, size, and coloration. The Video Stream Analysis Module determines whether a plant is categorized as a light-requiring plant by referencing its internal taxonomy database, which contains detailed information on the light needs of various plant species.

The Vision-and-Language Model collaborates with the Light Environment Mapping Unit to evaluate the lighting conditions in the room where the plant is located. This unit uses live video feeds to track natural sunlight patterns throughout the day, analyzing variables such as the intensity, angle, and duration of sunlight reaching specific areas of the room. It also assesses the contribution of artificial lighting, examining the placement, brightness, and light type emitted by fixtures such as LED or incandescent bulbs. By combining these data points, the Light Environment Mapping Unit generates a comprehensive map of the room's light distribution.

The system incorporates a Seasonal Adjustment Component to account for variations in sunlight availability due to seasonal changes. This component analyzes historical data from video streams to detect shifts in sunlight angles and intensity over time. For example, it identifies that sunlight entering a room through a south-facing window during winter months may reach different areas compared to summer months. The Seasonal Adjustment Component uses these insights to recommend dynamic adjustments to the plant's placement to ensure consistent light exposure throughout the year.

The Plant Care Analysis Module integrates the outputs of the Video Stream Analysis Module, Light Environment Mapping Unit, and Seasonal Adjustment Component to evaluate the plant's current location and its suitability for healthy growth. This module examines visual cues from the plant itself, such as discoloration, wilting, or uneven growth, to assess whether its light needs are being met. For example, if a light-requiring plant exhibits pale leaves or reduced growth, the Plant Care Analysis Module correlates these symptoms with the mapped light environment to determine if insufficient light exposure is the cause.

Based on this analysis, the Proposal Generation Module formulates a Plant Placement Optimization Proposal. This proposal specifies recommended adjustments to the plant's position within the room, detailing whether it should be moved closer to a window to increase sunlight exposure or placed under a specific artificial light source to supplement natural light. The proposal also includes recommendations for installing additional energy-efficient lighting fixtures, such as LED grow lights, if the existing light environment cannot meet the plant's needs. For example, the system might suggest placing a reflective surface near the plant to amplify available light or using a targeted grow light during specific hours to support photosynthesis.

To ensure practical implementation, the Communication Interface Module delivers the Plant Placement Optimization Proposal to household residents. The proposal is presented in a detailed report format, complete with visual diagrams illustrating the plant's current position, the recommended adjustments, and the expected benefits of the changes. The report also includes a summary of the plant's specific light requirements and an estimated timeline for achieving noticeable improvements in growth and health.

The system includes a Light Fixture Analysis Unit that evaluates the suitability of existing artificial lighting for supporting the plant's growth. This unit compares the spectral output of the current fixtures to the optimal light spectrum needed by the plant. If a mismatch is detected, the system recommends specific types of grow lights that can bridge the gap, specifying wattage, light spectrum, and placement to maximize efficiency and effectiveness.

The Feedback Integration Component ensures continuous improvement and validation of the recommendations provided by the system. This component monitors the plant's condition after implementing the recommended adjustments, using video feeds to track changes in growth patterns, leaf coloration, and overall health. It also gathers input from household residents regarding their observations of the plant's response to the changes. This feedback is used to refine the Vision-and-Language Model's understanding of plant care and enhance the accuracy of future recommendations.

To optimize the plant's care further, the system incorporates a Reflective Surface Evaluation Unit. This unit analyzes furniture or objects in the room that can be repositioned to reflect additional light onto the plant. For example, it may recommend moving a mirror or metallic surface to a location that redirects sunlight toward the plant during peak daylight hours. The Reflective Surface Evaluation Unit ensures that these recommendations are practical and do not disrupt the functionality or aesthetics of the room.

The operational workflow of the system begins with the Video Stream Analysis Module identifying and classifying light-requiring plants. The Light Environment Mapping Unit evaluates the lighting conditions in the room, while the Seasonal Adjustment Component ensures recommendations account for temporal variations. The Plant Care Analysis Module assesses the plant's health and light needs, and the Proposal Generation Module creates a detailed optimization plan. The Communication Interface Module delivers this plan to residents, while the Feedback Integration Component tracks outcomes to validate and improve the system's functionality.

The system provides a comprehensive and automated approach to ensuring optimal light conditions for light-requiring plants in a household. By integrating components such as the Video Stream Analysis Module, Light Environment Mapping Unit, Seasonal Adjustment Component, Plant Care Analysis Module, Proposal Generation Module, Communication Interface Module, Light Fixture Analysis Unit, and Feedback Integration Component, it delivers precise and actionable recommendations. Its ability to adapt to seasonal changes, incorporate user feedback, and leverage advanced data analysis establishes it as an innovative tool for promoting plant health and sustainable indoor gardening practices.

In some embodiments, functionalities or features of the system may be implemented by utilizing the following components:
Light-Requiring Plant Identification Unit: Identifies and classifies plants within the household that require high levels of natural or artificial light for optimal growth.
Light Pattern Mapping Module: Tracks sunlight and artificial light patterns in each room to evaluate current and potential light exposure for identified plants.
Seasonal Adjustment Engine: Predicts changes in sunlight availability due to seasonal shifts and recommends dynamic plant placements to maintain consistent exposure.
Light Amplification Proposal Generator: Suggests adding reflective surfaces or supplementary lighting to maximize light exposure for plants in low-light environments.
Growth Condition Monitoring Unit: Tracks plant health indicators such as leaf color and growth patterns to assess the effectiveness of current placement and lighting conditions.
Lighting Fixture Evaluation System: Analyzes the suitability of existing artificial lighting and recommends energy-efficient upgrades if needed.
Placement Optimization Interface: Generates a Plant Placement Optimization Proposal with detailed instructions for achieving optimal lighting conditions.
Feedback Analysis Module: Monitors plant health after implementing recommendations and adjusts future proposals based on observed outcomes.

In some embodiments, the computerized method comprises: (U1) automatically feeding into the VLM video segments or video frames from video cameras that capture live video from rooms in the household; (U2) automatically commanding the VLM to detect, based on computerized vision analysis and based on information from the Internet and based on a body-of-knowledge on which the VLM was trained, a particular shrub in the household that is a Shade-Requiring Shrub; (U3) automatically commanding the VLM to analyze natural sunlight patterns in a room where the Shade-Requiring Shrub is located, using live video streams; (U4) automatically commanding the VLM to generate a proposal to move the Shade-Requiring Shrub closer to a wall or away from a window in order to reduce sunlight exposure of said Shade-Requiring Shrub; (U5) automatically commanding the VLM to estimate whether changing of light fixture, in the room where the Shade-Requiring Shrub is located, from a high-wattage light fixture that produces over 1,000 lumens, to a low-wattage light fixture that produces less than 500 lumens, is expected to contribute to growth and wellbeing of the Shade-Requiring Shrub or in contrast is expected to be redundant; (U6) automatically commanding the VLM to detect mirrors and light-reflecting objects, in said room where the Shade-Requiring Shrub is located, that the VLM estimates as mirrors and light-reflecting objects that are positioned at orientations that enable said mirrors and light-reflecting objects to reflect light towards said Shade-Requiring Shrub; and further commanding the VLM to generate a proposal to move or rotate said mirrors and light-reflecting objects in order to reduce their reflection of light towards the Shade-Requiring Shrub; (U7) automatically commanding the VLM to detect seasonal shifts in sunlight angles based on analysis of video streams from said household, and to propose relocation of said Shade-Requiring Shrub to minimize exposure to natural light as seasons change; (U8) automatically transferring one or more VLM-generated proposals, with regard to said Shade-Requiring Shrub or with regard to said mirrors and light-reflecting objects, from the VLM to residents of the household via electronic mail.

The system extends its capabilities to include the care and optimization of shade-requiring shrubs within a household by monitoring their environmental conditions and recommending strategic changes to their placement and surrounding light conditions. At its core is the Video Stream Analysis Module, which continuously processes video feeds from household cameras to identify and classify shrubs based on their visual characteristics, including leaf density, color, and structure. The Vision-and-Language Model is employed to determine whether a plant is categorized as a shade-requiring shrub by cross-referencing its appearance with a detailed taxonomy database that outlines the specific light tolerances and needs of various plant species.

The Vision-and-Language Model integrates with the Light Environment Mapping Unit to assess the light exposure in the area where the shade-requiring shrub is currently placed. This unit evaluates natural and artificial light levels, analyzing factors such as light intensity, duration, and angles throughout the day. It identifies areas within the room that receive excessive sunlight or are subject to prolonged exposure from high-intensity artificial lighting, which may adversely affect the shrub. The Light Environment Mapping Unit generates a detailed illumination map of the room, highlighting zones with optimal and suboptimal light levels for shade-requiring plants.

The system incorporates a Seasonal Light Adjustment Component to address changes in sunlight patterns caused by seasonal variations. This component uses historical video data to model how sunlight angles and intensity shift over time and predicts their impact on the shrub's current location. For example, it might determine that a window receiving direct sunlight during summer months will expose the shrub to light levels that exceed its tolerance, necessitating a relocation to a shaded area or the use of light-blocking measures during specific times of the year.

To refine its recommendations, the system employs a Plant Health Analysis Module that evaluates the shrub's condition based on visual indicators captured by the Video Stream Analysis Module. This module analyzes factors such as leaf discoloration, curling, or shedding, which may indicate excessive light exposure. It correlates these signs with the mapped light environment to determine whether the shrub's health issues are caused by unsuitable lighting conditions. For instance, if a shade-requiring shrub exhibits wilting leaves while placed near a window with high light intensity, the system attributes this to overexposure and prioritizes corrective action.

The Proposal Generation Module synthesizes the data from the Light Environment Mapping Unit, Seasonal Light Adjustment Component, and Plant Health Analysis Module to create a Shade Optimization Proposal. This proposal provides specific recommendations for adjusting the shrub's placement to align with its light requirements. For example, the system may suggest relocating the shrub to a corner of the room that receives minimal direct sunlight or positioning it near a wall to reduce reflective light exposure. Additionally, the proposal includes recommendations for replacing high-wattage light fixtures in the room with low-wattage alternatives to create a more suitable lighting environment.

The system further incorporates a Reflective Object Analysis Unit to identify mirrors, metallic surfaces, or other reflective objects in the shrub's vicinity. This unit evaluates the orientation and position of these objects to determine whether they amplify light exposure on the shrub. If reflections are found to contribute to excessive lighting, the system recommends adjustments such as repositioning or rotating these objects to minimize their impact on the shrub's environment.

To facilitate effective implementation, the Communication Interface Module delivers the Shade Optimization Proposal to household residents in a visually intuitive format. The proposal includes diagrams and annotated images illustrating the shrub's current position, the identified light sources contributing to overexposure, and the recommended changes. It also specifies the expected benefits of these adjustments, such as improved health, reduced stress on the plant, and enhanced aesthetic appeal. For added convenience, the Communication Interface Module provides links to resources for purchasing low-wattage light fixtures or accessories like light-blocking curtains.

The Feedback Integration Component ensures continuous refinement and validation of the system's recommendations. This component monitors the shrub's condition after implementing the proposed adjustments, using video data to track improvements in leaf health, growth patterns, and overall appearance. It also gathers feedback from residents regarding the ease of implementation and the observed effectiveness of the changes. This feedback is analyzed to enhance the Vision-and-Language Model's predictive capabilities and improve the accuracy of future recommendations.

The system also incorporates a Seasonal Relocation Planning Module, which anticipates the need for periodic adjustments to the shrub's placement based on expected seasonal changes. This module ensures that the shrub receives consistent care throughout the year by recommending proactive relocations or adjustments to lighting conditions before adverse effects occur. For instance, it might suggest moving the shrub further from a window in spring when sunlight becomes more intense or reintroducing it to a brighter area during winter months when natural light levels decrease.

The modular architecture of the system allows it to adapt to a variety of household configurations and plant care needs. In smart home setups, the system can directly control lighting fixtures and automated window shades to implement recommended changes without requiring manual intervention. In traditional setups, the system focuses on delivering clear and actionable guidance for manual adjustments, ensuring accessibility for all users.

The operational workflow begins with the Video Stream Analysis Module identifying and classifying the shrub, followed by the Light Environment Mapping Unit evaluating its current light exposure. The Seasonal Light Adjustment Component and Plant Health Analysis Module refine the analysis, while the Proposal Generation Module formulates a detailed Shade Optimization Proposal. The Reflective Object Analysis Unit identifies and mitigates secondary light sources, and the Communication Interface Module delivers the proposal to residents. The Feedback Integration Component and Seasonal Relocation Planning Module ensure the system's effectiveness and adaptability over time.

The system provides a comprehensive and automated solution for optimizing the care of shade-requiring shrubs in a household. By integrating components such as the Video Stream Analysis Module, Light Environment Mapping Unit, Seasonal Light Adjustment Component, Plant Health Analysis Module, Proposal Generation Module, Reflective Object Analysis Unit, Communication Interface Module, Feedback Integration Component, and Seasonal Relocation Planning Module, it delivers precise and actionable recommendations. Its ability to adapt to seasonal variations and incorporate user feedback establishes it as an innovative tool for promoting plant health and sustainable indoor gardening practices.

In some embodiments, functionalities or features of the system may be implemented by utilizing the following components:
Shade-Requiring Plant Identification Unit: Identifies and classifies household plants that thrive in shaded or low-light environments, differentiating them from light-intensive species.
Shade Pattern Mapping Module: Analyzes light intensity and distribution in rooms to locate areas suitable for shade-requiring plants.
Reflective Object Adjustment Engine: Identifies and recommends repositioning reflective surfaces to reduce light exposure on shade-sensitive plants.
Artificial Lighting Optimization Module: Recommends switching to low-intensity, energy-efficient light fixtures for areas housing shade-requiring plants.
Seasonal Light Adaptation Unit: Adjusts plant placement recommendations based on seasonal changes in sunlight patterns to maintain appropriate light exposure.
Placement Adjustment Proposal Generator: Develops a Shade Optimization Proposal, specifying plant relocations and light fixture changes to create optimal conditions.
Resident Communication Interface: Delivers proposals to household residents with clear diagrams and step-by-step implementation instructions.
Post-Implementation Monitoring Component: Tracks plant health and environmental conditions after adjustments, ensuring long-term sustainability and refining future recommendations.

Some embodiments may solve, prevent, cure, and/or mitigate one or more of the following problems:
Problem 1: Energy wastage due to residents forgetting to turn off lights or appliances in unoccupied areas of the household. Problem 2: Inability to correlate textual conversations and video data for identifying inefficiencies like misaligned resident behavior and energy usage. Problem 3: Lack of tailored, actionable recommendations for optimizing energy usage, leaving residents unaware of potential energy-saving actions. Problem 4: Absence of real-time monitoring and feedback mechanisms to validate the impact of implemented energy-saving measures.
Problem 5: Energy loss caused by simultaneous operation of air conditioners and open windows in different rooms, leading to unnecessary cooling or heating. Problem 6: Limited ability to detect conditions like airflow disruptions caused by operational appliances and open windows. Problem 7: Difficulty in automatically identifying conflicting household states that result in energy inefficiency. Problem 8: Lack of an automated system to notify residents or recommend corrective actions when incompatible conditions are detected.
Problem 9: Missed opportunities to leverage smart window controls for immediate resolution of energy inefficiencies related to open windows. Problem 10: Increased manual effort to identify and resolve inefficiencies, resulting in delayed corrective actions and continued energy loss. Problem 11: Uncertainty regarding the compatibility of home automation systems with specific energy-saving actions, such as remote window closure. Problem 12: Inability to automate responses to identified inefficiencies, reducing the effectiveness of energy management systems.
Problem 13: Energy wastage when non-smart windows cannot be remotely closed, leaving appliances like air conditioners to operate inefficiently. Problem 14: Lack of alternative energy-saving actions when smart automation systems are not available in the household. Problem 15: Residents' reliance on manual intervention for energy management, resulting in delayed responses to inefficiencies. Problem 16: Absence of integrated logic to balance actions between non-smart and smart systems for energy optimization.
Problem 17: Inefficient usage of new appliances due to lack of awareness about energy-saving best practices and tips. Problem 18: Difficulty in disseminating personalized and appliance-specific energy-saving recommendations to all household members. Problem 19: Reduced appliance performance due to incorrect usage or neglect of maintenance routines, such as not cleaning lint filters or leaving fridge doors open for too long. Problem 20: Lack of actionable guidance for maximizing the efficiency of new appliances, leading to higher energy bills.
Problem 21: Misaligned temperature settings due to varied resident preferences, leading to inefficient heating or cooling across the household. Problem 22: Energy wastage caused by maintaining uniform temperature settings without accounting for room usage or occupancy patterns. Problem 23: Difficulty in optimizing climate control based on resident schedules and preferences, resulting in discomfort or excess energy consumption. Problem 24: Lack of a system to balance individual temperature preferences for collective energy-efficient solutions.
Problem 25: Increased energy bills due to unawareness of peak and off-peak electricity rates and improper scheduling of high-energy appliances. Problem 26: Inability to shift non-time-sensitive appliance usage to off-peak hours, resulting in higher costs. Problem 27: Lack of actionable insights from electricity usage patterns, preventing residents from optimizing their energy consumption. Problem 28: Difficulty in automating time-of-use scheduling for devices to align with cost-saving opportunities.
Problem 29: Energy loss caused by lights being left on in rooms that are unoccupied due to residents' absence. Problem 30: Difficulty in predicting when residents will be away, leading to ineffective energy-saving actions. Problem 31: Lack of room-specific energy management to deactivate lights and appliances based on predicted resident absence. Problem 32: Delays in implementing energy-saving actions due to manual control requirements and absence of automated systems.
Problem 33: Energy inefficiency from unused lighting and appliances in rooms of absent residents based on scheduling data. Problem 34: Difficulty integrating calendar data with room-specific energy management systems for proactive deactivation of devices. Problem 35: Inability to predict future absences accurately and adjust lighting or appliance settings accordingly. Problem 36: Lack of coordination between real-time room monitoring and calendar-based predictions for optimal energy savings.
Problem 37: Energy loss due to delayed window insulation or weatherproofing services that are past their optimal maintenance schedule. Problem 38: Difficulty identifying local service providers and comparing costs for window insulation or weatherproofing services. Problem 39: Missed opportunities to schedule necessary services proactively, leading to higher energy expenses. Problem 40: Lack of actionable insights or automated assistance for maintaining insulation and weatherproofing quality over time.
Problem 41: Overpayment for electricity due to a lack of awareness of better pricing options from alternative providers. Problem 42: Difficulty in comparing electricity rates and terms between providers, leading to missed cost-saving opportunities. Problem 43: Manual effort required to obtain and evaluate electricity provider quotes, delaying potential transitions to more affordable plans. Problem 44: Inability to track post-switch billing improvements, reducing confidence in cost-saving decisions.
Problem 45: Unanticipated power outages causing operational disruptions and potential damage to sensitive electronics. Problem 46: Lack of predictive mechanisms for detecting impending outages based on regional and social media activity. Problem 47: Inability to automate backup power activation or surge protection measures during predicted outages. Problem 48: Limited communication of outage-related actions to residents, leaving them unprepared for power loss.

Problem 49: Energy inefficiency from outdated, non-LED light fixtures in frequently occupied rooms. Problem 50: Missed opportunities to optimize lighting conditions in high-usage areas while reducing energy in low-usage zones. Problem 51: Difficulty in identifying and simulating the benefits of proposed lighting replacements for household residents. Problem 52: Lack of actionable guidance on energy-efficient light replacements and their placement for maximum benefit.
Problem 53: Suboptimal energy usage from planned purchases of less efficient appliances compared to available alternatives. Problem 54: Difficulty in identifying more energy-efficient appliances that align with household needs and budget constraints. Problem 55: Lack of awareness about the long-term cost and energy-saving benefits of selecting energy-efficient appliances. Problem 56: Ineffective communication of alternative appliance options and their advantages to household residents.
Problem 57: Reduced HVAC efficiency due to furniture placement obstructing airflow or air conditioning outlets. Problem 58: Difficulty in identifying and recommending furniture rearrangements to improve airflow and energy efficiency. Problem 59: Lack of tools to simulate airflow and energy impacts of proposed furniture changes before implementation. Problem 60: Limited awareness of the benefits of furniture rearrangement in improving household energy efficiency.
Problem 61: Appliance activation caused by pets interacting with controls, leading to unintended energy usage or safety hazards. Problem 62: Inability to monitor and identify pet-triggered interactions with household devices. Problem 63: Lack of automated deactivation measures for appliances accidentally turned on by pets. Problem 64: Limited communication of detected pet interactions and their energy impact to residents.
Problem 65: Risk of pet injury from navigating dark household areas during nighttime hours. Problem 66: Difficulty in identifying frequently traveled nighttime paths and addressing insufficient lighting conditions. Problem 67: Missed opportunities to use motion-activated energy-efficient lights to improve safety and reduce energy usage. Problem 68: Limited awareness of specific lighting needs for pets and their nighttime habits.
Problem 69: Prolonged standby mode of devices resulting in unnecessary energy consumption. Problem 70: Difficulty distinguishing between devices that require immediate availability and those suitable for power-off mode. Problem 71: Missed opportunities to automatically switch devices from standby to power-off for energy savings. Problem 72: Lack of real-time feedback on the impact of standby mode reductions for continuous optimization.
Problem 73: Insufficient light exposure for light-requiring plants due to suboptimal placement in the household. Problem 74: Difficulty adapting plant placement to seasonal variations in sunlight availability. Problem 75: Lack of guidance on enhancing light exposure using reflective surfaces or artificial light sources. Problem 76: Inability to monitor and adjust plant health and growth conditions based on light availability.
Problem 77: Overexposure to light for shade-requiring plants, negatively impacting their health and growth. Problem 78: Difficulty identifying suitable low-light zones within the household for shade-sensitive plants. Problem 79: Lack of tools to adjust artificial and reflective light conditions for maintaining optimal shade environments. Problem 80: Inability to adapt plant placement and lighting adjustments to seasonal changes in natural light patterns.

Some embodiments may provide one, or some, or most, or even all, of the following advantages and/or benefits:
Benefit 1: Enables real-time detection of energy inefficiencies, ensuring immediate identification of wasteful behaviors or conditions in the household. Benefit 2: Correlates visual and textual data, providing a comprehensive understanding of household energy usage and opportunities for optimization. Benefit 3: Delivers actionable recommendations tailored to the household, helping residents implement targeted energy-saving measures. Benefit 4: Provides continuous monitoring and feedback, validating the effectiveness of implemented changes and encouraging sustained energy efficiency.
Benefit 5: Identifies concurrent open windows and operational air conditioning units, reducing energy loss through prompt corrective actions. Benefit 6: Enhances household energy efficiency by addressing conflicting conditions that result in unnecessary cooling or heating. Benefit 7: Automates detection and notification of energy inefficiencies, reducing reliance on manual monitoring. Benefit 8: Improves overall energy management by integrating room-specific analysis for precise action.
Benefit 9: Utilizes smart home automation to remotely close windows, eliminating energy inefficiencies quickly and effectively. Benefit 10: Reduces manual intervention by enabling automated corrective actions for open smart windows. Benefit 11: Ensures compatibility with smart home devices, streamlining the implementation of energy-saving measures. Benefit 12: Notifies residents of corrective actions taken, enhancing transparency and confidence in the system.
Benefit 13: Provides alternative energy-saving actions, such as turning off air conditioners, when non-smart windows are open. Benefit 14: Balances energy optimization for both smart and non-smart households, ensuring widespread applicability. Benefit 15: Reduces energy consumption in scenarios where remote smart controls are unavailable. Benefit 16: Ensures timely corrective actions, preventing prolonged energy waste in non-smart households.
Benefit 17: Educates residents on energy-efficient practices for newly purchased appliances, reducing energy waste. Benefit 18: Provides tailored, appliance-specific tips to optimize usage and extend appliance lifespan. Benefit 19: Reduces energy costs by promoting best practices like timely maintenance and proper operation. Benefit 20: Enhances household awareness of energy-saving opportunities, fostering long-term sustainable habits.
Benefit 21: Aligns household temperature settings with resident preferences, improving comfort while maintaining energy efficiency. Benefit 22: Optimizes heating and cooling schedules based on room occupancy and resident behavior, reducing unnecessary energy use. Benefit 23: Ensures equitable temperature management, satisfying preferences of most residents while conserving energy. Benefit 24: Provides actionable insights to automate climate control for consistent energy savings.
Benefit 25: Shifts energy-intensive appliance usage to off-peak hours, reducing electricity costs. Benefit 26: Leverages electricity rate differences to optimize household energy consumption and savings. Benefit 27: Automates scheduling of non-urgent appliance operations, minimizing manual effort for residents. Benefit 28: Enhances energy efficiency by reducing peak-time consumption, supporting grid stability and cost management.
Benefit 29: Automatically deactivates lights and appliances in unoccupied rooms, minimizing energy waste during resident absences. Benefit 30: Predicts future absences to proactively manage household energy consumption. Benefit 31: Improves energy efficiency with room-specific deactivation based on absence patterns. Benefit 32: Notifies residents of implemented actions, ensuring visibility and understanding of energy-saving measures.
Benefit 33: Integrates calendar data to accurately predict resident absences and adjust energy usage accordingly. Benefit 34: Automates room-specific energy management during predicted absences, reducing unnecessary consumption. Benefit 35: Enhances accuracy by combining real-time monitoring with calendar-based predictions. Benefit 36: Provides seamless coordination between personal schedules and energy-saving actions, reducing manual oversight.
Benefit 37: Proactively schedules insulation and weatherproofing services, maintaining household energy efficiency. Benefit 38: Identifies and contacts local service providers, simplifying the process of obtaining competitive quotes. Benefit 39: Ensures timely maintenance, preventing unnecessary energy loss from deteriorating insulation or weatherproofing. Benefit 40: Helps residents save on energy costs by maintaining optimal insulation and reducing heating or cooling needs.
Benefit 41: Identifies cost-effective electricity providers, enabling residents to save money by switching to plans with better rates and terms. Benefit 42: Simplifies comparison of electricity providers, reducing the complexity of evaluating multiple plans and services. Benefit 43: Automates the process of obtaining quotes, minimizing manual effort and ensuring timely access to competitive pricing. Benefit 44: Validates post-switch savings, increasing confidence in the provider transition and supporting informed decision-making.
Benefit 45: Predicts power outages, giving residents the ability to prepare and minimize disruption. Benefit 46: Automatically activates backup power systems, ensuring continuous functionality of critical appliances during outages. Benefit 47: Protects sensitive electronics by disabling vulnerable devices during outage-prone conditions, preventing damage from power surges. Benefit 48: Informs residents of impending outages, improving household readiness and reducing stress during utility failures.
Benefit 49: Promotes energy savings by replacing inefficient lighting fixtures with energy-efficient LED bulbs. Benefit 50: Optimizes lighting conditions based on room usage, ensuring sufficient illumination while minimizing energy consumption. Benefit 51: Provides clear replacement recommendations, simplifying the transition to more sustainable lighting solutions. Benefit 52: Tracks energy usage improvements post-replacement, reinforcing the benefits of adopting efficient lighting systems.
Benefit 53: Guides residents to purchase energy-efficient appliances, reducing long-term energy costs. Benefit 54: Provides actionable alternatives to planned purchases, ensuring better energy performance without exceeding budget constraints. Benefit 55: Enhances household sustainability by promoting appliances with superior energy efficiency. Benefit 56: Facilitates informed decision-making by comparing energy usage and cost-effectiveness of appliance options.
Benefit 57: Improves HVAC efficiency by recommending furniture rearrangements that enhance airflow and reduce energy usage. Benefit 58: Provides simulations of rearranged layouts, ensuring that recommendations are practical and effective. Benefit 59: Reduces energy costs by removing obstructions that hinder heating or cooling distribution. Benefit 60: Increases resident comfort by improving temperature consistency across household areas.
Benefit 61: Prevents unnecessary energy consumption caused by pets activating appliances unintentionally. Benefit 62: Enhances safety by deactivating appliances that could pose hazards when triggered by pets. Benefit 63: Alerts residents to pet-related interactions, improving awareness and reducing repeat occurrences. Benefit 64: Automates corrective actions, ensuring timely deactivation of affected appliances and conserving energy.
Benefit 65: Enhances pet safety by illuminating frequently traveled nighttime paths with energy-efficient lighting. Benefit 66: Reduces energy usage with motion-activated lights that operate only when needed. Benefit 67: Adapts lighting recommendations to specific pet behavior patterns, ensuring practical and effective solutions. Benefit 68: Improves household safety and convenience for pets, fostering a comfortable environment.
Benefit 69: Reduces standby energy consumption by identifying and switching off devices not in use. Benefit 70: Differentiates between devices requiring immediate access and those suitable for power-off, optimizing energy efficiency. Benefit 71: Automates energy-saving actions for idle devices, minimizing manual intervention by residents. Benefit 72: Validates savings post-action, enhancing system reliability and refining future recommendations.
Benefit 73: Ensures optimal light exposure for light-requiring plants, promoting healthy growth and vitality. Benefit 74: Adapts plant placement recommendations to seasonal changes, maintaining consistent lighting conditions year-round. Benefit 75: Enhances light exposure using reflective surfaces or supplemental lighting, optimizing energy usage. Benefit 76: Tracks plant health improvements after adjustments, ensuring long-term benefits and refining recommendations.
Benefit 77: Protects shade-requiring plants from overexposure to light, maintaining their health and growth. Benefit 78: Identifies optimal low-light zones for plant placement, ensuring suitable conditions within the household. Benefit 79: Recommends adjustments to reflective surfaces and lighting to reduce unnecessary light exposure for shade-sensitive plants. Benefit 80: Adapts plant care to seasonal changes, providing consistent and sustainable solutions for shade environments.

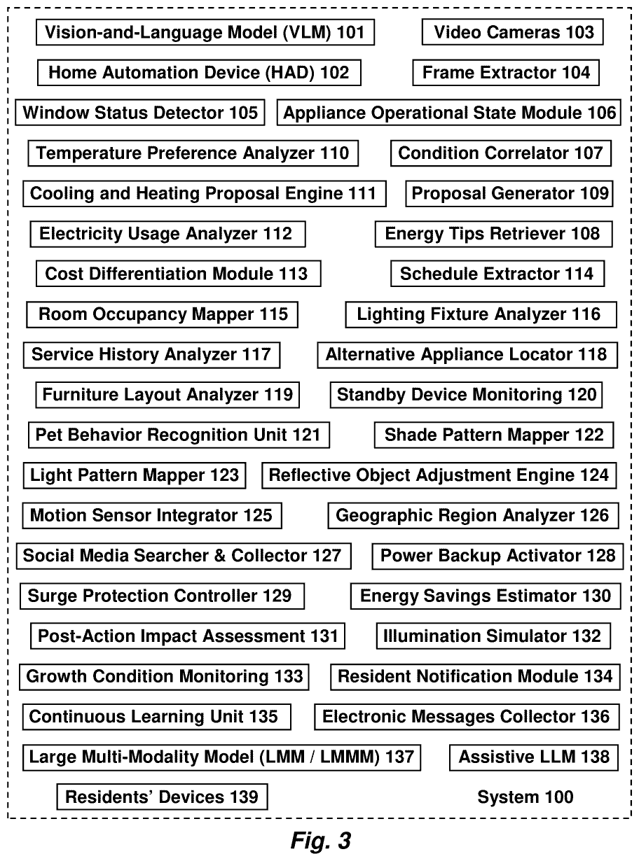

Reference is made to FIG. 3, which is a schematic block-diagram illustration of a system 300, in accordance with some demonstrative embodiments. System 100 may be configured to perform the functionalities that were described above and/or that are described herein, using suitable hardware components and/or software components.
Vision-and-Language Model (VLM) 101: A core analytical component trained to process visual and textual data, identify patterns, and generate actionable insights and recommendations for optimizing household energy efficiency and operational management.
Home Automation Device (HAD) 102: Interfaces with connected devices and appliances to execute commands, such as controlling smart windows, appliances, and lighting systems, based on the recommendations generated by the system.
Set of Video Cameras 103: Captures live video streams from multiple rooms within the household, providing continuous visual input for monitoring household conditions and activities.
Frame Extractor 104: Extracts individual frames from video streams for precise analysis, enabling the system to detect specific objects, behaviors, and environmental conditions.
Window Status Detector 105: Analyzes video inputs to determine whether household windows are open or closed, contributing to energy efficiency monitoring.
Appliance Operational State Module 106: Detects operational status of appliances based on visual cues, such as indicator lights, switch positions, or secondary effects like airflow.
Condition Correlator 107: Cross-references findings from different rooms to identify conflicting household conditions, such as open windows and active air conditioning units.
Energy Tips Retriever 108: Collects energy-saving tips for newly purchased appliances from external knowledge bases and online resources, tailoring them to household-specific scenarios.
Proposal Generator 109: Synthesizes data from various inputs to generate actionable recommendations for reducing energy consumption and improving operational efficiency.
Temperature Preference Analyzer 110: Extracts resident temperature preferences from textual communications and integrates them into climate control recommendations.
Cooling and Heating Proposal Engine 111: Generates schedules and settings for heating and cooling systems that align with resident preferences and occupancy patterns.
Electricity Usage Analyzer 112: Processes past electricity bills and usage patterns to identify inefficiencies and cost-saving opportunities.
Cost Differentiation Module 113: Analyzes electricity rate structures to recommend optimal time-of-use schedules for appliances and devices.
Schedule Extractor 114: Extracts planned absences and schedules from residents'calendar and messaging systems, predicting future household occupancy.
Room Occupancy Mapper 115: Identifies the primary usage patterns of specific rooms by analyzing real-time and historical data.
Lighting Fixture Analyzer 116: Identifies inefficient lighting fixtures and recommends replacements with energy-efficient alternatives based on room usage patterns.
Service History Analyzer 117: Analyzes past household maintenance records, such as weatherproofing or insulation services, to recommend future scheduling.
Alternative Appliance Locator 118: Suggests functionally equivalent, energy-efficient alternatives to planned appliance purchases, ensuring long-term cost and energy savings.
Furniture Layout Analyzer 119: Evaluates furniture placement for its impact on airflow and HVAC efficiency, proposing rearrangements to enhance energy usage.
Standby Device Monitoring Unit 120: Detects devices in standby mode and determines whether they can be safely powered off to conserve energy.
Pet Behavior Recognition Unit 121: Monitors household pets'interactions with appliances, identifying potential energy inefficiencies or safety hazards caused by accidental activations.
Shade Pattern Mapper 122: Analyzes light conditions in rooms to determine optimal placements for shade-requiring plants.
Light Pattern Mapper 123: Tracks sunlight and artificial light patterns to recommend placements for light-requiring plants.
Reflective Object Adjustment Engine 124: Identifies and adjusts reflective surfaces to optimize light exposure for plants or minimize overexposure.
Motion Sensor Integrator 125: Suggests motion-activated lighting solutions for frequently traveled paths, enhancing safety and energy efficiency.
Geographic Region Analyzer 126: Identifies local service providers and outage reports based on household location and external data sources.
Social Media Searcher & Collector 127: Monitors real-time social media activity to predict regional electricity outages and inform household preparations.
Power Backup Activator 128: Automatically triggers the household's backup power system in response to predicted outages.
Surge Protection Controller 129: Disables sensitive electronics during outage-prone conditions, protecting devices from power surges.
Energy Savings Estimator 130: Calculates potential savings from proposed changes, reinforcing the impact of energy-saving measures to residents.
Post-Action Impact Assessment Unit 131: Monitors the outcomes of implemented recommendations, validating improvements in energy efficiency and refining future actions.
Illumination Simulator 132: Simulates lighting conditions for proposed fixture replacements to ensure effective implementation.
Growth Condition Monitoring Unit 133: Tracks plant health indicators such as growth and color, evaluating the impact of placement and light exposure recommendations.
Resident Notification Module 134: Communicates recommendations, actions taken, and their expected benefits to household residents through clear, actionable updates.
Continuous Learning Unit 135: Integrates feedback from implemented recommendations to refine the system's algorithms and enhance future energy optimization proposals.
Electronic Messages Collector 136: Obtains or collects or gathers, from electronic devices/smartphones/tablets of residents of the household, copies of email/SMS/IM messages that were sent and/or received by each such resident; and sends them to a central repository to which the VLM or the LMMM has access.
Large Multi-Modality Model (LMM or LMMM) 137: such as ChatGPT 4o, can be configured to perform any of the operations that are discussed above or herein as the VLM.
Assistive LLM 138: such as ChatGPT 4, can be configured to efficiently perform text-processing tasks, to parse data, to collect data, to arrange or organize data in a format that is more useful for the VLM or the LMMM, and/or can be configured or programmed to automatically generate Prompts and to Feed them automatically into the VLM or LMMM; and/or such LLM can also receive output/s from the VLM or LMMM, and can convert or translate or transform such outputs into machine-readable signals or messages that the HAD can receive and act upon.
Residents' Devices 139: such as smartphones and tablets, that are optionally pre-registered in a central household registry and/or at the HAD (or a similar Smart Home hub unit or controller) as being associated with particular residents of the household; and also optionally pre-registered with a particular room or rooms (e.g., Smartphone 1 is associated with User Adam, whose bedroom is the north-east bedroom; Tablet 2 is associated with User Bob, whose bedroom is the south-west bedroom).

Some embodiments may provide a computerized method for optimizing household energy efficiency using a Vision-and-Language Model (VLM), the method comprising: (a) Automatically acquiring live video streams from video cameras positioned in multiple rooms of the household. (b) Extracting video frames from the acquired streams and transferring them to the VLM for processing. (c) Collecting textual data from emails and instant messages exchanged by household residents over a predefined period. (d) Feeding collected textual data into the VLM alongside extracted video frames. (e) Prompting the VLM to analyze the combined visual and textual data for energy inefficiencies. (f) Generating energy-saving recommendations based on the analysis performed by the VLM. (g) Communicating the recommendations to household residents via email or instant messaging systems. (h) Monitoring the household for subsequent changes and validating the impact of the implemented recommendations.

Some embodiments may provide a computerized method for detecting energy inefficiencies caused by incompatible household conditions using a Vision-and-Language Model (VLM), the method comprising: (a) Acquiring live video streams from cameras covering different rooms of the household. (b) Extracting video frames for detailed analysis of room-specific conditions. (c) Prompting the VLM to determine whether any windows in the household are open. (d) Prompting the VLM to check if air conditioning units are concurrently operational in other rooms. (e) Exemplifying to the VLM operational indicators such as control lights or air movement. (f) Identifying conflicting conditions, such as an open window and an active air conditioner, using VLM analysis. (g) Generating a closure message recommending corrective actions to address detected inefficiencies. (h) Delivering the closure message to household residents via a notification system.

Some embodiments may provide a computerized method for automating energy-saving actions involving smart windows using a Vision-and-Language Model (VLM), the method comprising: (a) Detecting an open window in the household using live video analysis processed by the VLM. (b) Querying a home automation device to verify if the detected window is remotely controllable. (c) Prompting the VLM to correlate detected inefficiencies, such as open windows and operational appliances. (d) Generating a closure message recommending closing the open smart window. (e) Transmitting the closure message to the home automation device for execution. (f) Automatically initiating the closure of the smart window based on the transmitted message. (g) Monitoring the status of the smart window to confirm successful closure. (h) Communicating the results of the action to household residents through digital notifications.

Some embodiments provide a computerized method for addressing energy inefficiencies in households without smart windows using a Vision-and-Language Model (VLM), the method comprising: Detecting an open non-smart window using live video streams analyzed by the VLM. Identifying operational air conditioning units in the same household using visual data processed by the VLM. Prompting the VLM to determine whether the open window and active air conditioner coexist. Generating a closure message recommending alternative actions, such as turning off the air conditioner. Sending the closure message to a home automation device for execution. Automatically deactivating the air conditioning unit upon receiving the closure message. Monitoring energy consumption to validate the effectiveness of the deactivation. Notifying residents of the actions taken and their impact on energy efficiency.

Some embodiments provide a computerized method for promoting energy-efficient use of new appliances using a Vision-and-Language Model (VLM), the method comprising: Detecting recent purchases of electrical appliances by analyzing household email messages. Retrieving energy-saving tips for the newly purchased appliances from online resources and VLM knowledge bases. Exemplifying efficient usage practices, such as cleaning filters or optimizing operational settings, to the VLM. Prompting the VLM to generate a tailored tips proposal for the household. Delivering the proposal to household residents via email or instant messaging. Encouraging residents to implement recommended energy-saving practices. Monitoring energy usage patterns to evaluate the impact of the tips. Refining future recommendations based on observed improvements and feedback.

Some embodiments provide a computerized method for optimizing climate control in households using a Vision-and-Language Model (VLM), the method comprising: Extracting temperature preferences from emails and messages exchanged by household residents. Feeding temperature preferences and live occupancy data into the VLM for analysis. Prompting the VLM to generate optimal cooling and heating schedules. Exemplifying preference compatibility calculations, such as identifying overlapping temperature ranges, to the VLM. Delivering personalized climate control proposals to household residents via email. Transmitting machine-readable commands to home automation devices for implementing recommendations. Monitoring room temperatures to validate alignment with proposed settings. Adjusting future recommendations based on resident feedback and energy savings.

Some embodiments provide a computerized method for optimizing electricity usage scheduling using a Vision-and-Language Model (VLM), the method comprising: Analyzing past electricity bills and usage patterns to identify cost-saving opportunities. Detecting time-sensitive and non-time-sensitive devices within the household. Prompting the VLM to generate optimized schedules for non-urgent operations. Exemplifying off-peak usage benefits, such as reduced electricity rates, to the VLM. Delivering scheduling recommendations to household residents via notifications. Sending machine-readable commands to smart devices for automated scheduling. Monitoring electricity usage to validate the impact of the recommendations. Refining scheduling strategies based on observed savings and resident preferences.

Some embodiments provide a computerized method for deactivating household devices during resident absences using a Vision-and-Language Model (VLM), the method comprising: Extracting resident schedules from calendar and messaging applications. Identifying rooms primarily associated with each resident using VLM analysis of video data. Detecting planned absences based on integrated scheduling and historical activity patterns. Prompting the VLM to generate device deactivation commands for unoccupied rooms. Sending deactivation commands to home automation systems for execution. Monitoring devices to ensure they are turned off during the absence period. Validating energy savings achieved through device deactivation. Communicating results to residents via notifications.

Some embodiments provide a computerized method for aligning energy management with resident schedules using a Vision-and-Language Model (VLM), the method comprising: Extracting scheduling data from calendar applications linked to household residents. Mapping room usage patterns for each resident based on historical data. Predicting future absences using VLM analysis of schedules and behaviors. Prompting the VLM to generate device deactivation plans for unoccupied rooms. Sending commands to deactivate lighting and appliances during predicted absences. Monitoring rooms to ensure devices remain off as scheduled. Tracking energy savings and refining future predictions based on outcomes. Delivering absence-based energy management updates to residents.

Some embodiments provide a computerized method for scheduling household maintenance services using a Vision-and-Language Model (VLM), the method comprising: Analyzing email messages to determine the last dates of insulation or weatherproofing services. Detecting overdue services using predefined time thresholds. Identifying local service providers based on household location. Prompting the VLM to generate service requests and price quote messages. Sending service requests to selected providers via email. Collecting and analyzing responses to compile a service proposal. Delivering the proposal to household residents for review. Monitoring post-service conditions to validate improvements in household energy efficiency.

Some embodiments provide a computerized method for optimizing electricity provider selection using a Vision-and-Language Model (VLM), the method comprising: Extracting past electricity bills and identifying the current provider and associated rates. Detecting alternate electricity providers in the household's geographic region using location-based queries. Prompting the VLM to analyze cost-benefit comparisons between current and alternative providers. Retrieving updated pricing and service terms from identified providers. Generating a detailed Provider Replacement Proposal highlighting potential savings. Sending the proposal to household residents for review and decision-making. Monitoring post-switch billing to confirm savings and validate recommendations. Refining provider evaluation strategies based on observed outcomes and resident feedback.

Some embodiments provide a computerized method for predicting and managing electricity outages using a Vision-and-Language Model (VLM), the method comprising: Identifying nearby towns within a predefined radius of the household location. Continuously monitoring social media for posts indicating local power outages. Feeding fresh outage-related posts into the VLM for real-time analysis. Predicting outage likelihood based on frequency and proximity of outage reports. Sending commands to initiate backup power systems if outage risk exceeds a predefined threshold. Automatically deactivating sensitive devices to prevent damage from surges. Notifying household residents of predicted outages and preparatory actions taken. Tracking system performance during outages to refine prediction and response mechanisms.

A computerized method for replacing inefficient lighting fixtures using a Vision-and-Language Model (VLM), the method comprising: Analyzing household lighting setups to identify non-LED fixtures. Mapping room usage patterns to prioritize high-usage areas for replacements. Prompting the VLM to generate replacement recommendations based on energy efficiency and lighting requirements. Simulating the impact of proposed replacements on room illumination and energy consumption. Delivering a Light-Fixture Replacement Proposal to household residents. Monitoring energy usage after replacements to validate savings. Adjusting future recommendations based on observed improvements in lighting and energy efficiency. Providing ongoing insights to encourage additional sustainable upgrades.

Some embodiments provide a computerized method for recommending energy-efficient appliances using a Vision-and-Language Model (VLM), the method comprising: Detecting planned appliance purchases by analyzing resident communications. Identifying functionally equivalent, more energy-efficient appliances available on the market. Comparing cost and energy efficiency of proposed alternatives with the planned purchase. Prompting the VLM to generate an Alternate Purchase Proposal highlighting benefits of the recommended appliance. Delivering the proposal to household residents with detailed comparisons and savings projections.

Encouraging residents to implement the recommended alternative. Tracking appliance usage and energy consumption to validate the proposal's benefits. Refining future recommendations based on feedback and observed outcomes.

Some embodiments provide a computerized method for improving household airflow using a Vision-and-Language Model (VLM), the method comprising: Mapping furniture placement and evaluating its impact on airflow and HVAC efficiency. Detecting obstructions, such as furniture blocking air vents or heating devices. Prompting the VLM to generate rearrangement recommendations for optimal airflow. Simulating the effects of proposed rearrangements on room temperature and energy efficiency. Delivering a Furniture Rearrangement Proposal to household residents with diagrams and instructions. Monitoring temperature consistency and energy usage post-rearrangement. Refining future recommendations based on the success of implemented changes. Enhancing resident comfort by improving airflow distribution and reducing energy consumption.

A computerized method for managing pet interactions with household devices using a Vision-and-Language Model (VLM), the method comprising: Monitoring pet behavior using live video streams analyzed by the VLM. Detecting interactions with appliances, such as pets pressing buttons or knobs. Prompting the VLM to identify potential risks or energy inefficiencies caused by these interactions. Generating a Pet Interaction Alert for household residents detailing the detected behavior. Sending commands to deactivate affected devices if the interaction poses safety or energy risks. Providing actionable guidance to prevent future interactions, such as securing device controls. Tracking and analyzing repeated pet behaviors to prioritize monitoring efforts. Refining detection algorithms based on observed patterns and feedback from residents.

Some embodiments provide a computerized method for improving nighttime safety for household pets using a Vision-and-Language Model (VLM), the method comprising: Identifying frequently traveled nighttime paths of pets using video analysis. Detecting inadequate lighting conditions along identified pathways. Prompting the VLM to generate a Pet Pathway Lighting Proposal recommending energy-efficient lighting installations. Suggesting motion-activated lights to enhance safety while conserving energy. Delivering the proposal to household residents with installation instructions. Monitoring pet behavior post-installation to validate improvements in safety. Adjusting lighting placement recommendations based on observed patterns and resident feedback. Encouraging adoption of energy-efficient solutions for other household safety needs.

A computerized method for reducing standby energy consumption using a Vision-and-Language Model (VLM), the method comprising: Identifying electronic devices in standby mode through visual indicators and usage patterns. Differentiating devices requiring immediate availability from those suitable for power-off. Prompting the VLM to generate Mode Switch messages for non-essential devices. Sending commands to deactivate devices in standby mode to conserve energy. Monitoring energy consumption post-deactivation to validate savings. Delivering notifications to residents detailing actions taken and their benefits. Refining recommendations based on observed outcomes and feedback. Encouraging continued use of automated energy-saving measures for long-term benefits.

Some embodiments provide a computerized method for optimizing light exposure for household plants using a Vision-and-Language Model (VLM), the method comprising: Identifying light-requiring plants and analyzing their current placement. Tracking sunlight patterns and detecting seasonal changes affecting light availability. Prompting the VLM to generate placement recommendations for optimal exposure. Suggesting supplemental lighting or reflective surfaces to enhance light levels. Delivering a Plant Placement Optimization Proposal to household residents. Monitoring plant health indicators to validate the effectiveness of recommendations. Adjusting future proposals based on plant growth and environmental changes. Encouraging sustainable practices by optimizing natural and artificial light usage.

Some embodiments provide a computerized method for managing light exposure for shade-requiring plants using a Vision-and-Language Model (VLM), the method comprising: Identifying shade-requiring plants and analyzing their current placement. Detecting overexposure to light due to placement or reflective surfaces. Prompting the VLM to generate recommendations for reducing light levels, such as repositioning plants or adjusting reflective objects. Suggesting low-intensity lighting solutions for rooms housing shade-sensitive plants. Delivering a Shade Optimization Proposal to household residents with actionable steps. Monitoring plant health post-implementation to validate improvements. Refining recommendations based on seasonal light changes and feedback. Promoting sustainable practices by optimizing low-light zones for shade-requiring plants.

Some embodiments include a non-transitory storage medium or storage article having stored thereon instructions that, when executed by a machine or a hardware processor, cause the machine or the hardware processor to perform a method as described.

Some embodiments include a system comprising: one or more hardware processors, that are configured to execute code, and that are operably associated with one or more memory units that are configured to store code; wherein the one or more hardware processors are configured to perform a method as described.

In some embodiments, in order to perform the computerized operations described above, the relevant system or devices may be equipped with suitable hardware components and/or software components; for example: a processor able to process data and/or execute code or machine-readable instructions (e.g., a central processing unit (CPU), a graphic processing unit (GPU), a digital signal processor (DSP), a processing core, an Integrated Circuit (IC), an Application-Specific IC (ASIC), one or more controllers, a logic unit, or the like); a memory unit able to store data for short term (e.g., Random Access Memory (RAM), volatile memory); a storage unit able to store data for long term (e.g., non-volatile memory, Flash memory, hard disk drive, solid state drive, optical drive); an input unit able to receive user's input (e.g., keyboard, keypad, mouse, touch-pad, touch-screen, trackball, microphone); an output unit able to generate or produce or provide output (e.g., screen, touch-screen, monitor, display unit, audio speakers); one or more transceivers or transmitters or receivers or communication units (e.g., Wi-Fi transceiver, cellular transceiver, Bluetooth transceiver, wireless communication transceiver, wired transceiver, Network Interface Card (NIC), modem); and other suitable components (e.g., a power source, an Operating System (OS), drivers, one or more applications or “apps” or software modules, or the like).

In accordance with embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, AJAX, XML, JSON, Lisp, Eiffel, Verilog, Hardware Description Language (HDL), BASIC, Visual BASIC, MATLAB, Pascal, HTML, HTML5, CSS, Perl, Python, PHP, Dart, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a wired or wireless network, a wireless area network, a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A computerized method for reducing energy consumption and increasing energy efficiency in a household,
the computerized method comprising:
(A1) automatically acquiring a plurality of live video streams from a respective plurality of video cameras that are located in a plurality of rooms in said household;
extracting video frames from said live video streams;
feeding the extracted video frames into a large Vision-and-Language Model (VLM);
(A2) automatically obtaining copies of textual messages that were exchanged, among electronic devices of residents of said household, via electronic mail and Instant Messaging;
feeding said copies of textual messages into said VLM;
(A3) automatically feeding into said VLM a prompt,
that commands the VLM to analyze visual content of said video frames in combination with textual content of said textual messages,
and that further commands the VLM to generate a proposal for one or more actions that are expected to reduce electric energy consumption in said household based on VLM analysis of visual content of said video frames in combination with textual content of said textual messages.

2. The computerized method of claim 1, further comprising:
(B1) automatically prompting said VLM to check whether VLM-based analysis of video frames from a first room in said household indicates that a window is said first room is open;
(B2) automatically prompting the VLM to check whether VLM-based analysis of video frames from a second, different, room in said household indicates that an air conditioner unit is concurrently operating in said second room;
(B3) exemplifying to the VLM that air conditioner units can be deduced to be operational (i) by visually inspecting control lights of air conditioner units, and (ii) by visually inspecting a mechanical position of mechanical switches of air conditioner units, and (iii) by visually detecting movements of plant leaves and papers and human hair due to air being blown out of an operational air conditioner unit;
(B4) automatically prompting the VLM to generate a closure message, that reflects a VLM-generated proposal to close the open window or to close the air conditioning unit, if the VLM deduced that the window in said first room is open and that the air conditioner unit in said second room is concurrently operational.

3. The computerized method of claim 2, further comprising:
(C1) sending to a Home Automation Device (HAD) a query asking whether said window in the first room is registered with the HAD as a smart window that can be remotely opened and closed via a remotely-controlled electric motor;
(C2) if the HAD responds to said query, that the window in the first room is indeed a smart window that can be remotely opened and closed, then:
(C3) automatically transferring the closure message, that was generated by the VLM, from the VLM to that HAD; wherein the HAD is pre-configured to remotely close said window upon reception of a VLM-generated closure message if said window is a smart window that can be remotely closed.

4. The computerized method of claim 3, further comprising:
(D1) if the HAD responds to said query, that the window in the first room is not a smart window, then:
(D2) automatically transferring the closure message, that was generated by the VLM, from the VLM to that HAD;
wherein the HAD is pre-configured to turn off the air conditioner unit upon reception of a VLM-generated closure message if said window is not a smart window.

5. The computerized method of claim 4, further comprising:
(E1) automatically prompting the VLM, (a) to analyze email messages that are incoming into email boxes of residents of said household, and (b) to detect an email message that was received in the past T days that indicates that a new electrical appliance was ordered, wherein T is a pre-defined value in a range of 3 to 14;
(E2) automatically prompting the VLM to obtain, from the Internet and from a general body-of-knowledge on which the VLM was trained, energy-saving tips for utilizing said new electrical appliance;
(E3) automatically prompting the VLM to generate a Tips Proposal Message that conveys to residents of said household how to implement said energy-saving tips when utilizing said new electrical appliance;
(E4) exemplifying to the VLM, (a) that utilization of a clothes dryer machine should be performed only after cleaning of a lint filter of the clothes dryer machine to increase efficiency and to reduce energy consumption, and (b) that an oven should be pre-heated only when cooking instruction require pre-heating, and (c) that fridge door and freezer door should be closed within 10seconds of their opening;
(E5) automatically sending to all residents of the household, via electronic mail or SMS or Instant Messaging, a new message that congratulates them on purchasing said new electrical appliance and that further conveys the VLM-generated Tips Proposal Message on how to implement energy-saving tips when utilizing said new electrical appliance.

6. The computerized method of claim 5, further comprising:
(F1) automatically prompting the VLM, (a) to analyze email messages and Instant Messages that were exchanged among residents of said household in the past 30 days, and (b) to extract information regarding personal preference of each resident regarding desired temperature;
(F2) automatically prompting the VLM to generate a Cooling and Heating Proposal for turning-on and turning-off cooling units and heating units in said household, and for operational settings of said cooling units and heating units at particular time-slots, to maximize a match to personal preferences of at least most of the residents of the household;
(F3) exemplifying to the VLM that if a first resident has expressed a preference that temperature in the household would be in a range of 70 to 75 degrees Fahrenheit, and a second resident has expressed a preference that temperature in the household would be in a range of 73 to 77 degrees Fahrenheit, and a third resident has expressed a preference that temperature in the household would be in a range of 75 to 79 degrees Fahrenheit, then an air conditioner unit should be set to a target temperature of 75 degrees as said target temperature satisfies all preferences of all residents;
(F4) transferring the VLM-generated Cooling and Heating Proposal, (a) via electronic mail to all residents of the household, and also (b) via a set of machine-readable commands to the HAD of the household which is pre-configured to control heating units and cooling units of the household based on VLM-generated Cooling and Heating Proposal.

7. The computerized method of claim 6, further comprising:
(G1) automatically prompting the VLM, (a) to analyze email messages that were received by one or more residents of said household in the past 365 days, and (b) to extract from them electricity bills and electricity usage statements that were sent via email to one or more residents of said household;
(G2) automatically prompting the VLM to generate a Usage Modification Proposal, for modifying a manner or a timing in which one or more electrical devices are operated in the household, based on VLM analysis of said electricity bills and electricity usage statements;
(G3) exemplifying to the VLM that if an electricity bill indicates a first monetary rate for consuming electricity in morning time and a second, lower, monetary rate for consuming electricity at night time, then electric devices that perform operations that are not time-sensitive should be operated at night time and not in morning time,
and further exemplifying to the LLM that a suitable type of such electric devices is a clothes dryer machine, a clothes washing machine, and a yard water sprinkler system;
(G4) automatically transferring the VLM-generated Usage Modification Proposal, (a) via electronic mail to all residents of the household, and also (b) via a set of machine-readable commands to the HAD of the household which is pre-configured to control electric devices of the household based on VLM-generated Usage Modification Proposals.

8. The computerized method of claim 7, further comprising:
(H1) automatically analyzing, by the VLM, copies of email messages and instant messages that were exchanged among residents of the household in the past 30 days; and detecting, by the VLM, a future time-slot in which a particular resident plans to be away from the household;
(H2) automatically analyzing, by the VLM, said live video streams and also previously-recorded video streams from rooms of the household; and matching between said particular resident and a particular room that said particular resident occupies by himself without other residents;
(H3) automatically generating, by the VLM, a Resident-Is-Away control message that instructs the HAD of the household, to turn off lights in said particular room of said particular resident, during said future time-slot in which the VLM deduced that said particular resident planned to be away;
(H4) transferring from the VLM to said HAD the Resident-Is-Away control message, wherein the HAD of the household is pre-configured to selectively turn off lights in one or rooms of the household in response to VLM-generated messages that indicate that the VLM deduced that a particular resident plans to be away.

9. The computerized method of claim 8, further comprising:
(I1) automatically extracting copies of all scheduling data, from scheduling applications and calendar applications that run on electronic devices of residents of said household;
(I2) automatically feeding into the VLM said copies of scheduling data, and prompting the VLM to estimate which resident of the household will be away from the household in a future time-slot that is within 7 days forward;
(I3) automatically generating by the VLM a prediction, based on said copies of scheduling data, indicating that a specific resident of the household will be away from the household in said future time-slot;
(I4) automatically analyzing, by the VLM, said live video streams and also previously-recorded video streams from rooms of the household; and matching between said particular resident and a particular room that said particular resident occupies by himself without other residents;
(I5) automatically generating, by the VLM, a Calendar-Based Resident-Is-Away control message that instructs the HAD of the household, to turn off lights in said particular room of said particular resident, during said future time-slot in which the VLM deduced that said particular resident planned to be away;
(I6) transferring from the VLM to said HAD the Calendar-Based Resident-Is-Away control message, wherein the HAD of the household is pre-configured to selectively turn off lights in one or rooms of the household in response to VLM-generated messages that indicate that the VLM deduced that a particular resident plans to be away.

10. The computerized method of claim 9, further comprising:
(J1) automatically analyzing, by the VLM, copies of email messages that were sent and received by residents of the household in the past 730 days; and detecting, by the VLM, that a most-recent window insulation service or a most-recent home weatherproofing service was conducted between 365 days ago and 730 days ago;
(J2) automatically generating by the VLM a Service Required Message, indicating to residents of the household that according to VLM-based analysis of information obtained from email inboxes, a window-insulation service or a home weatherproofing service is due to be performed and should be scheduled;
(J3) automatically sending from the VLM said Service Required Message, via electronic mail, to all residents of the household;
(J4) automatically obtaining by the VLM, from the Internet, contact details of service providers that are located within 25 miles of said household and that provide window-insulation services or home weatherproofing services;
(J5) automatically creating by the VLM a plurality of email messages,
each email message requesting a price quote from one of said service providers for providing a window-insulation service or a home weatherproofing service to said household;
(J6) automatically sending out said plurality of email messages to said service providers, with a digital carbon copy (CC) to all residents of the household, to obtain price quotes for window-insulation services or home weatherproofing services for said household from said service providers.

11. The computerized method of claim 10, further comprising:
(K1) automatically analyzing, by the VLM, copies of email messages that were sent and received by residents of the household in the past 12 months;
(K2) detecting by the VLM at least one email message that includes a copy of an electricity bill of said household;
(K3) feeding into the VLM, as context, (a) a five-digit zip code in which said household is located, and (b) a list of electricity providers that server each zip code in the United States;
(K4) analyzing by the VLM said electricity bill of said household; and determining by the VLM (a) which current electricity provider is currently serving the household, and (b) the electricity rates of that said current electricity provider applies to said household;
(K5) further determining by the VLM, which other electricity providers are candidates to replace said electricity provider;
(K6) automatically obtaining by the VLM, from the Internet, contact details of said candidate electricity providers;
(K7) automatically creating by the VLM a plurality of email messages,
each email message requesting an up-to-date price quote from one of said candidate electricity providers for providing electricity to said household;
(K8) automatically sending out said plurality of email messages to said candidate electricity providers, with a digital carbon copy (CC) to all residents of the household, to obtain price quotes from said candidate electricity providers for providing electricity to said household;
(K9) automatically analyzing by the VLM one or more responses that are received from the candidate electricity providers;
automatically comparing by the VLM proposed electricity rates quoted in said one or more responses;
detecting by the VLM a particular candidate electricity provider that quoted electricity rates that are lower than rates that are charged currently to said household;
generating a Provider Replacement Proposal Message that indicates to residents of the household an identity and contact details of said particular candidate electricity provider and a VLM-generated recommendation to switch electricity service for said household to said particular candidate electricity provider;
transmitting said Provider Replacement Proposal Message via electronic mail to email addresses of residents of said household.

12. The computerized method of claim 11, further comprising:
(L1) automatically feeding into the VLM a current zip code of said household; and commanding the VLM to generate a list of all towns that are located within D miles radios of said current zip code of said household, wherein D is in a range of 25 to 100;
(L2) every N minutes, wherein N is in a range of 5 to 10,
automatically performing a search of social media platforms, and obtaining copies of fresh posts that comply with the following cumulative search criteria: (a) each post mentions therein by name at least one of said towns that are located within D miles of said household, and also, (b) each post was posted no more than 10 minutes ago, and also, (c) each post mentions therein a pre-defined set of keywords that correspond to electricity power-out and electricity blackout;
(L3) continuously feeding into the VLM said copies of fresh posts,
and commanding the VLM, once per minute, to evaluate or re-evaluate a VLM-predicted chance that said household will experience an electricity power-out or electricity blackout within 30 minutes;
(L4) if the VLM-predicted that a chance that said household will experience an electricity power-out or electricity blackout within 30 minutes, is greater than 50 percent, then: (a) automatically sending a signal to the HAD of the household to trigger a warm-up session of a gas-based or fuel-based power generator of said household, and also, (b) automatically disconnecting power to smart power-outlets in said household that the VLM determines to be connected to a computing device that can suffer an electrical surge.

13. The computerized method of claim 12, further comprising:
(M1) automatically feeding into the VLM video frames extracted from video cameras that capture live video from rooms in the household;
(M2) automatically commanding the VLM to generate a Light-Fixture Replacement Proposal to replace a particular non-LED light bulb in a particular room with an energy-efficient LED-based light bulb, based on VLM analysis that analyzes in combination: (a) lighting conditions in various regions of each room, and (b) occupation or non-occupation of various regions of each room by one or more residents;
(M3) exemplifying to the VLM that (a) a corner region in a pantry room that is occupied by a human less than 5 minutes per day is not a good candidate for replacing non-LED light bulbs with energy-efficient LED-based light bulb, and that (b) a central region in a kitchen that has human presence for at least 120 minutes between noon and midnight is a good candidate for replacing non-LED light bulbs with energy-efficient LED-based light bulb;
(M4) automatically transferring the VLM-generated Light-Fixture Replacement Proposal to the residents of the household via electronic mail.

14. The computerized method of claim 13, further comprising:
(N1) automatically analyzing, by the VLM, copies of email messages and instant messages that were sent and received by residents of the household in the past 30 days;
(N2) automatically detecting, by the VLM, at least one message in which a resident of the household conveys a plan to purchase a particular electric appliance of a particular make-and-model;
(N3) obtaining by the VLM, from the Internet and from a general body-of-knowledge on which the VLM was trained, data about an Equivalent Appliance that is functionally equivalent to said particular electric appliance,
wherein the VLM is prompted to select said Equivalent Appliance that has an energy efficiency level that is greater than an energy efficiency level of said particular electric appliance,
and wherein the VLM is further prompted to select said Equivalent Appliance that has a price that is not more than 25 percent greater than a price of said particular electric appliance;
(N4) automatically generating by the VLM an Alternate Purchase Proposal in which the VLM proposes to purchase said Equivalent Appliance instead of purchasing the particular electric appliance that said resident of the household plans to purchase;
(N5) automatically transferring the VLM-generated Alternate Purchase Proposal via electronic mail to residents of said household.

15. The computerized method of claim 14, further comprising:
(P1) automatically feeding into the VLM video frames extracted from video cameras that capture live video from rooms in the household;
(P2) automatically commanding the VLM to analyze furniture locations and to generate a Furniture Rearrangement Proposal that the VLM predicts would increase energy efficiency in the household and improve airflow in the household;
(P3) exemplifying to the VLM that (a) a sofa that is located such that it partially blocks an outlet of an air conditioner unit is a good candidate for furniture rearrangement by proposing to move the sofa to another location in which the sofa would not block at all the outlet of the air conditioner unit, and that (b) a portable air heating device that generates hot air and that is facing towards a wall is a good candidate for furniture rearrangement by turning the portable air heating device to face away from the wall and to face towards an open region of a room;
(P4) automatically transferring the Furniture Rearrangement Proposal that was generated by the VLM to residents of the household via electronic mail.

16. The computerized method of claim 15, further comprising:
(Q1) automatically feeding into the VLM video frames extracted from video cameras that capture live video from rooms in the household;
(Q2) automatically commanding the VLM to analyze behavior of household pets that exhibit interactions with electric appliances;
(Q3) automatically commanding the VLM to generate a Pet Interaction Alert if the VLM detects, from analysis of said video frames, that a household pet pushes a button or turns a knob or touches a touch-button of an electric appliance in the household and thus causes said electric appliance to activate and operate when no human is present in a same room of said electric appliance;
(Q4) automatically transferring the Pet Interaction Alert from the VLM to residents of the household, via electronic mail or instant messaging, to alert residents of the household that the VLM detected that the household pet interacted with said electric appliance;
(Q5) if said electric appliance is a smart appliance that can be remotely deactivated by a HAD of the household, then: sending from the VLM to the HAD a message indicating to the HAD to remotely deactivate said electric appliance, upon detection by the VLM that the household pet interacted with said electric appliance;
wherein the step of commanding the VLM further comprises:
exemplifying to the VLM to specifically search, in said video frames, for jumps of a dog or a cat towards knobs of an oven; and exemplifying to the VLM to specifically search, in said video frames, for stepping by a dog or a cat on one or more mechanical buttons or keyboard keys of a computer and thus causing the computer to activate.

17. The computerized method of claim 16, further comprising:
(R1) automatically feeding into the VLM video segments or video frames from video cameras that capture live video from rooms in the household;
(R2) automatically commanding the VLM to analyze behavior of household pets that exhibit a pet repeatedly and frequently walking at night-time along a non-lit path in the household;
(R3) automatically commanding the VLM to generate a Pet Pathway Lighting Proposal, that proposes to place motion-activated energy-efficient LED lights along said non-lit path that the VLM detected as being walked by said pet repeatedly and frequently at nigh-time, to reduce risk of pet injury and to improve wellbeing of the pet;
(R4) further commanding the VLM to detect, from analysis of said video segments or video frames, a particular fixed time-slot at night-time in which said pet typically walks along said non-lit path in the household;
(R5) sending a lights activation message from said VLM, immediately prior to commencement of said particular fixed time-slot at night-time, to the HAD of the household,
wherein the lights activation message instructs the HAD to activate at least one remotely-controlled light fixture in the household that can illuminate at least part of said non-lit path in the household, to reduce risk of pet injury and to improve wellbeing of the pet.

18. The computerized method of claim 17, further comprising:
(S1) feeding into the VLM video segments or video frames from video cameras that capture live video from rooms in the household;
(S2) commanding the VLM to estimate, based on VLM analysis of LED status lights of electric devices, whether any electric device has been on standby mode for at least 30 minutes;
(S3) commanding the VLM to estimate, based on information that the VLM collects from the Internet and based on a body-of-knowledge on which the VLM was trained, whether a particular electric device that has been on standby mode for at least 30 minutes is typically required by users to have instant turn-on or in contrast is typically utilized by users only after a start-up period;
(S4) if the VLM estimates that a particular electric device, that has been on standby mode for at least 30 minutes, is typically not required by users to have instant turn-on but rather is typically utilized by users only after a start-up period, then:
sending a VLM-generated Mode Switch message from the VLM to the HAD of the household, to trigger the HAD to switch said electric device from stand-by mode to power-off mode in order to conserve electricity in the household without a negative impact to user experience.

19. The computerized method of claim 18, further comprising:
(T1) automatically feeding into the VLM video segments or video frames from video cameras that capture live video from rooms in the household;
(T2) automatically commanding the VLM to detect, based on computerized vision analysis and based on information from the Internet and based on a body-of-knowledge on which the VLM was trained, a particular plant in the household that is a Light-Requiring Plant;
(T3) automatically commanding the VLM to analyze natural sunlight patterns in a room where the Light-Requiring Plant is located, using live video streams; and commanding the VLM to generate a proposal to move the Light-Requiring Plant closer to a window or away from a window in order to increase sunlight exposure of said Light-Requiring Plant;
(T4) automatically commanding the VLM to estimate whether installation of an energy-efficient light fixture, in the room where the Light-Requiring Plant is located, is expected to contribute to growth and wellbeing of the Light-Requiring Plant or in contrast is expected to be redundant;
(T5) automatically commanding the VLM to propose a furniture article in said room where the Light-Requiring Plant is located, that the VLM estimates as a furniture article that can accommodate a light-reflecting surface and as a furniture article that is positioned at an orientation that enables said furniture article to reflect light towards said Light-Requiring Plant in order to amplify light available to said Light-Requiring Plant;
(T6) automatically commanding the VLM to detect seasonal shifts in sunlight angles based on analysis of video streams from said household, and to propose relocation of said Light-Requiring Plant to maximize exposure to natural light as seasons change;
(T7) automatically transferring one or more VLM-generated proposals, with regard to said Light-Requiring Plant or with regard to said furniture article, from the VLM to residents of the household via electronic mail.

20. The computerized method of claim 19, further comprising:
(U1) automatically feeding into the VLM video segments or video frames from video cameras that capture live video from rooms in the household;
(U2) automatically commanding the VLM to detect, based on computerized vision analysis and based on information from the Internet and based on a body-of-knowledge on which the VLM was trained, a particular shrub in the household that is a Shade-Requiring Shrub;
(U3) automatically commanding the VLM to analyze natural sunlight patterns in a room where the Shade-Requiring Shrub is located, using live video streams;
(U4) automatically commanding the VLM to generate a proposal to move the Shade-Requiring Shrub closer to a wall or away from a window in order to reduce sunlight exposure of said Shade-Requiring Shrub;
(U5) automatically commanding the VLM to estimate whether changing of light fixture, in the room where the Shade-Requiring Shrub is located, from a high-wattage light fixture that produces over 1,000 lumens, to a low-wattage light fixture that produces less than 500 lumens, is expected to contribute to growth and wellbeing of the Shade-Requiring Shrub or in contrast is expected to be redundant;
(U6) automatically commanding the VLM to detect mirrors and light-reflecting objects, in said room where the Shade-Requiring Shrub is located, that the VLM estimates as mirrors and light-reflecting objects that are positioned at orientations that enable said mirrors and light-reflecting objects to reflect light towards said Shade-Requiring Shrub;
and further commanding the VLM to generate a proposal to move or rotate said mirrors and light-reflecting objects in order to reduce their reflection of light towards the Shade-Requiring Shrub;
(U7) automatically commanding the VLM to detect seasonal shifts in sunlight angles based on analysis of video streams from said household, and to propose relocation of said Shade-Requiring Shrub to minimize exposure to natural light as seasons change;
(U8) automatically transferring one or more VLM-generated proposals, with regard to said Shade-Requiring Shrub or with regard to said mirrors and light-reflecting objects, from the VLM to residents of the household via electronic mail.
